(19) United States
(12) Patent Application Publication
(10) Pub. No.: US 2018/0372200 A1
(43) Pub. Date: Dec. 27, 2018

(54) CONTROL STRATEGIES FOR HYBRID ELECTRIC POWERTRAIN CONFIGURATIONS WITH A BALL VARIATOR USED AS A POWERSPLIT E-CVT

(71) Applicant: DANA LIMITED, Maumee, OH (US)

(72) Inventors: Krishna KUMAR, Holland, OH (US); Steven J. WESOLOWSKI, Waterville, OH (US)

(73) Assignee: Dana Limited, Maumee, OH (US)

(21) Appl. No.: 16/062,400

(22) PCT Filed: Dec. 15, 2016
(86) PCT No.: PCT/US2016/066766

§ 371 Date: Jun. 14, 2018

Related U.S. Application Data
(60) Provisional application No. 62/267,704, filed on Dec. 15, 2015.

(51) Int. Cl. F16H 37/08; F16H 15/28; B60K 6/36; B60K 6/442; B60K 6/445; B60K 6/52; B60W 20/11; B60W 10/08; B60W 30/182

(52) U.S. Cl. CPC F16H 37/086; F16H 15/28; B60K 6/36; B60K 6/442; B60K 6/445; B60W 2050/0005; B60W 20/11; B60W 10/08; B60W 30/182; F16H 2037/0866; B60K 6/52

(57) ABSTRACT

A computer-implemented system for a vehicle having an engine, a battery system, a first motor/generator, and a second motor/generator, each motor/generator operably coupled to a ball-planetary variator (CVP), the computer-implemented system comprising: a digital processing device comprising an operating system configured to perform executable instructions and a memory device; a computer program including instructions executable by the digital processing device, the computer program comprising a software module configured to manage a plurality of vehicle driving conditions; a hybrid supervisory controller; and a plurality of sensors configured to monitor vehicle parameters including at least one of CVP input speed, engine torque, accelerator pedal position, CVP speed ratio, and battery charge, wherein the software module includes a plurality of software sub-modules configured to optimize the CVP speed ratio based at least in part on one of the vehicle parameters monitored by the plurality of sensors. The hybrid supervisory controller can choose the torque split and path of highest efficiency from engine to wheel, optionally operate at the best potential overall efficiency point in any mode and also provide torque variability, thereby leading to the best combination of powertrain performance and fuel efficiency.

### RELATED APPLICATIONS

The present application claims priority to and the benefit from Provisional U.S. Patent Application Ser. No. 62/267,704 filed on Dec. 15, 2015. The convent of the above-noted patent application is hereby expressly incorporated by reference into the detailed description of the present application.

### BACKGROUND

Hybrid vehicles are enjoying increased popularity and acceptance due in large part to the cost of fuel for internal combustion engine vehicles. Such hybrid vehicles include both an internal combustion engine as well as an electric motor to propel the vehicle.

In current designs for both consuming as well as storing electrical energy, the rotary shaft from a combination electric motor/generator is coupled by a gear train or planetary gear set to the main shaft of an internal combustion engine. As such, the rotary shaft for the electric motor/generator unit rotates in unison with the internal combustion engine main shaft at the fixed gear ratio of the hybrid vehicle design. These hybrid vehicle designs, however, have encountered several disadvantages. One disadvantage is that, since the ratio between the electric motor/generator rotary shaft and the internal combustion engine main shaft is fixed, e.g. 3 to 1, the electric motor/generator is rotatably driven at high speeds during a high speed revolution of the internal combustion engine. For example, in the situations where the ratio between the electric motor/generator rotary shaft and the internal combustion engine main shaft is 3 to 1; if the internal combustion engine is driven at high revolutions per minute of, e.g. 5,000 rpm, the electric motor/generator unit is driven at a rotation three times that amount, or 15,000 rpm. Such high speed revolution of the electric motor/generator thus necessitates the use of expensive components, e.g., bearings and brushes, to be employed to prevent damage to the electric motor/generator during such high speed operation.

A still further disadvantage of these hybrid vehicles is that the electric motor/generator unit achieves its most efficient operation, both in the sense of generating electricity and also providing additional power to the main shaft of the internal combustion engine, only within a relatively narrow range of revolutions per minute of the motor/generator unit. However, since the previously known hybrid vehicles utilized a fixed ratio between the motor/generator unit and the internal combustion engine main shaft, the motor/generator unit oftentimes operates outside its optimal speed range. As such, the overall hybrid vehicle operates at less than optimal efficiency. Therefore, there is a need for powertrain configurations that will improve the efficiency of hybrid vehicles.

### SUMMARY

Provided herein is a computer-implemented system for a vehicle having an engine, a battery system, a first motor/generator, and a second motor/generator, each motor/generator operably coupled to a ball-planetary variator (CVP), the computer-implemented system including: a digital processing device including an operating system configured to perform executable instructions and a memory device; a computer program including instructions executable by the digital processing device to create an application including a software module configured to manage a plurality of vehicle driving conditions; a hybrid supervisory controller; a plurality of sensors configured to monitor vehicle parameters including at least one of: CVP input speed, engine torque, accelerator pedal position, CVP speed ratio, and battery charge; wherein the software module is configured to execute instructions provided by the hybrid supervisory controller, and wherein the hybrid supervisory controller includes a plurality of software modules configured to optimize the CVP speed ratio based at least in part on the vehicle parameters monitored by the plurality of sensors. In some embodiments, a power management control module is adapted to receive a plurality of signals indicative of a driver's command. In some embodiments, an engine IOL module is adapted to receive signals from the power management control module. In some embodiments, a maximum overall efficiency module adapted to receive signals from the power management control module. In some embodiments, a maximum overall performance control module adapted to receive signals from the power management control module. In some embodiments, a CVP ratio control module is provided. In some embodiments, a CVP control sub-module is adapted to communicate a commanded set point signal to a CVP actuator. In some embodiments, a generator control sub-module, a motor control sub-module, an engine control sub-module, an accessory control sub-module, and a clutch control sub-module are provided. In some embodiments, the engine IOL module is adapted to execute an optimization algorithm to determine the engine operating points corresponding to ideal operating lines. In some embodiments, the maximum overall efficiency module is adapted to execute a learning algorithm to determine operating points for the engine, the motor, and the CVP corresponding to optimum efficiency. In some embodiments, the maximum overall performance module is adapted to execute an optimization algorithm to determine operating points for the engine, the motor, and the CVP that are within maximum performance limits for each.

Provided herein is a vehicle including the computer-implemented system.

Provided herein is a method providing a computer-implemented system.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the preferred embodiments are set forth with particularity in the appended claims. A better understanding of the features and advantages of the present embodiments will be obtained by reference to the following detailed description that sets forth illustrative embodiments, in which the principles of the preferred embodiments are utilized, and the accompanying drawings of which:

FIG. 1 is a side sectional view of a ball-type variator.

FIG. 2 is a plan view of a carrier member that is optionally used in the variator of FIG. 1.

FIG. 3 is an illustrative view of different tilt positions of the ball-type variator of FIG. 1.

FIG. 4 is a schematic diagram of a hybrid powerpath having a planetary gear system.

FIG. 5 is another schematic diagram of a hybrid powerpath having a planetary gear system.

FIG. 6 is another schematic diagram of a hybrid powerpath having a planetary gear system.

FIG. 7 is a top level block diagram of the input/output interfaces to the hybrid supervisory controller.

FIG. 8 is a block diagram of a top-level mode arbitration state machine.

FIG. 9 is a block diagram of a hybrid supervisory overall control strategy.

FIG. 10 is a chart depicting CVP controlling the generator optimum set point.

FIG. 11 are charts depicting CVP controlling ideal operating points of motor during launch & Cruising.

FIG. 12 is a chart depicting ideal operating lines (IOL) of an exemplary engine.

FIG. 13 is a block diagram of a hybrid supervisory overall control module.

FIG. 14 is a flow chart depicting a control process implemented in the multi-mode arbitrator module of FIG. 13.

FIG. 15 is a flow chart depicting another control process implemented in the multi-mode arbitrator module of FIG. 13.

FIG. 16 is a schematic diagram of a vehicle having a hybrid powertrain.

FIG. 17 is a schematic diagram of a series parallel hybrid dual motor architecture having a ball planetary transmission, two motor/generators, and an engine.

FIG. 18 is another schematic diagram of a series parallel hybrid dual motor architecture having a ball planetary transmission, two motor/generators, and an engine.

FIG. 19 is another schematic diagram of a series parallel hybrid dual motor architecture having a ball planetary transmission, two motor/generators, and an engine.

FIG. 20 is another schematic diagram of a series parallel hybrid dual motor architecture having a ball planetary transmission, two motor/generators, and an engine.

FIG. 21 is a schematic diagram of a series parallel hybrid dual motor architecture having a ball planetary transmission, two motor/generators, an engine, a brake element, and a clutch element.

FIG. 22 is another schematic diagram of a series parallel hybrid dual motor architecture having a ball planetary transmission, two motor/generators, an engine, a brake element, and a clutch element.

FIG. 23 is a schematic diagram of a series parallel hybrid dual motor architecture having a ball planetary transmission, two motor/generators, an engine, a brake element, and two clutch elements.

FIG. 24 is a schematic diagram of a series parallel hybrid dual motor architecture having a ball planetary transmission, two motor/generators, an engine, a brake element, and two clutch elements.

FIG. 25 is another schematic diagram of a series parallel hybrid dual motor architecture having a ball planetary transmission, two motor/generators, an engine, a brake element, and three clutch elements.

FIG. 26 is another schematic diagram of a series parallel hybrid dual motor architecture having a ball planetary transmission, two motor/generators, an engine, a brake element, and two clutch elements.

FIG. 27 is a schematic diagram of a series parallel hybrid dual motor architecture having a ball planetary transmission, two motor/generators, an engine, and a ball-ramp actuator.

FIG. 28 is another schematic diagram of a series parallel hybrid dual motor architecture having a ball planetary transmission, two motor/generators, an engine, and a ball-ramp actuator.

FIG. 29 is another schematic diagram of a series parallel hybrid dual motor architecture having a ball planetary transmission, two motor/generators, an engine, and a ball-ramp actuator.

FIG. 30 is another schematic diagram of a series parallel hybrid architecture having a ball planetary transmission, two motor/generators, an engine, and a ball-ramp actuator.

FIG. 31 is a schematic diagram of a series parallel hybrid dual motor architecture having a ball planetary transmission, two motor/generators, an engine, a brake element, a clutch element, and a ball-ramp actuator.

FIG. 32 is another schematic diagram of a series parallel hybrid dual motor architecture having a ball planetary transmission, two motor/generators, an engine, a brake element, a clutch element, and a ball-ramp actuator.

FIG. 33 is a schematic diagram of a series parallel hybrid dual motor architecture having a ball planetary transmission, two motor/generators, an engine, a brake element, two clutch elements, and a ball-ramp actuator.

FIG. 34 is another schematic diagram of a series parallel hybrid dual motor architecture having a ball planetary transmission, two motor/generators, an engine, a brake element, two clutch elements, and a ball-ramp actuator.

FIG. 35 is a schematic diagram of a series parallel hybrid dual motor architecture having a ball planetary transmission, two motor/generators, an engine, a brake element, three clutch elements, and a ball-ramp actuator.

FIG. 36 is another schematic diagram of a series parallel hybrid dual motor architecture having a ball planetary transmission, two motor/generators, an engine, a brake element, two clutch elements, and a ball-ramp actuator.

FIG. 37 a schematic diagram of a series parallel hybrid dual motor architecture having a ball planetary transmission, two motor/generators, and an engine.

FIG. 38 is another schematic diagram of a series parallel hybrid dual motor architecture having a ball planetary transmission, two motor/generators, and an engine.

FIG. 39 is another schematic diagram of a series parallel hybrid dual motor architecture having a ball planetary transmission, two motor/generators, and an engine.

FIG. 40 is yet another schematic diagram of a series parallel hybrid dual motor architecture having a ball planetary transmission, two motor/generators, and an engine.

FIG. 41 is schematic diagram of a series parallel hybrid dual motor architecture having a ball planetary transmission, two motor/generators, an engine, a brake element, and a clutch element.

FIG. 42 is another schematic diagram of a series parallel hybrid dual motor architecture having a ball planetary transmission, two motor/generators, an engine, a brake element, and a clutch element.

FIG. 43 is a schematic diagram of a series parallel hybrid dual motor architecture having a ball planetary transmission, two motor/generators, an engine, a brake element, and two clutch elements.

FIG. 44 is a schematic diagram of a series parallel hybrid dual motor architecture having a ball planetary transmission, two motor/generators, an engine, a brake element, and two clutch elements.

FIG. 45 is another diagram of a series parallel hybrid dual motor architecture having a ball planetary transmission, two motor/generators, an engine, a brake element, and three clutch elements.

FIG. 46 is another schematic diagram of a series parallel hybrid dual motor architecture having a ball planetary transmission, two motor/generators, an engine, a brake element, and two clutch elements.

FIG. 47 is another schematic diagram of a series parallel hybrid dual motor, dual clutch architecture having a ball planetary transmission, two motor/generators, an engine, and two clutch elements.

FIG. 48 is yet another schematic diagram of a series parallel hybrid dual motor, dual clutch architecture having a ball planetary transmission, two motor/generators, an engine, and two clutch elements.

FIG. 49 is yet another schematic diagram of a series parallel hybrid dual motor, dual clutch architecture having a ball planetary transmission, two motor/generators, an engine, and two clutch elements.

FIG. 50 is yet another schematic diagram of a series parallel hybrid dual motor, dual clutch architecture having a ball planetary transmission, two motor/generators, an engine, and two clutch elements.

FIG. 51 is a schematic diagram of a series parallel hybrid dual motor architecture having a ball planetary transmission, two motor/generators, an engine, two clutch elements, and an ball-ramp actuator.

FIG. 52 is another schematic diagram of a series parallel hybrid dual motor architecture having a ball planetary transmission, two motor/generators, an engine, two clutch elements, and a ball-ramp actuator.

FIG. 53 is a schematic diagram of a hybrid architecture having a ball planetary transmission, two motor/generators, and an engine configured for a rear wheel drive vehicle.

FIG. 54 is another schematic diagram of a hybrid architecture having a ball planetary transmission, two motor/generators, and an engine configured for a rear wheel drive vehicle.

FIG. 55 is a schematic diagram of a pre-transmission mild hybrid single motor, 2 clutch parallel hybrid architecture having a ball planetary transmission, a motor/generator, and an engine.

FIG. 56 is another schematic diagram of a post-transmission mild hybrid single motor, 2 clutch parallel hybrid architecture having a ball planetary transmission, a motor/generator, and an engine.

FIG. 57 is a schematic diagram of a series parallel hybrid dual motor architecture having a ball planetary transmission, two motor/generators, and an engine.

FIG. 58 is a schematic diagram of a series parallel hybrid one clutch variant architecture having a ball planetary transmission, two motor/generators, an engine, and a clutch.

FIG. 59 is another schematic diagram of a series parallel hybrid two clutch variant dual motor architecture having a ball planetary transmission, two motor/generators, an engine, and a two clutches.

FIG. 60 is a schematic diagram of a series parallel hybrid, no clutches, dual motor architecture having a ball planetary transmission, two motor/generators, and an engine.

FIG. 61 is a schematic diagram of a series parallel hybrid one clutch variant, dual motor architecture having a ball planetary transmission, two motor/generators, an engine, and a clutch.

FIG. 62 is a schematic diagram of a series parallel hybrid two clutch variant, dual motor architecture having a ball planetary transmission, two motor/generators, an engine, and two clutches.

FIG. 63 is a schematic diagram of a series parallel hybrid one clutch, one brake variant, dual motor architecture having a ball planetary transmission, two motor/generators, an engine, a brake, and a clutch.

FIG. 64 is another schematic diagram of a series parallel hybrid one clutch, one brake variant, dual motor architecture having a ball planetary transmission, two motor/generators, an engine, a brake, and a clutch.

FIG. 65 is a schematic diagram of an all-wheel drive, dual motor series parallel hybrid.

FIG. 66 is a schematic diagram of another all-wheel drive, dual motor series parallel hybrid architecture having a ball planetary transmission, two motor/generators, and an engine.

FIG. 67 is another schematic diagram of an all-wheel drive series parallel hybrid, dual motor architecture having a ball planetary transmission, two motor/generators, an engine, a brake, and two clutches.

FIG. 68 is another schematic diagram of a series parallel hybrid, dual motor, two clutch architecture having a ball planetary transmission, two motor/generators, an engine, a brake, and two clutches.

FIG. 69 is a schematic diagram of a series parallel hybrid, dual motor, two clutch architecture having a ball planetary transmission, two motor/generators, an engine, a brake, and two clutches.

FIG. 70 is another schematic diagram of a series parallel hybrid, switchable dual motor architecture having a ball planetary transmission, two motor/generators, an engine, a brake, and two clutches.

FIG. 71 is a schematic diagram of a series parallel hybrid with a bypassable variator and switchable variator architecture having a ball planetary transmission, two motor/generators, an engine, a brake, and three clutches.

FIG. 72 is a schematic diagram of a series parallel hybrid eCVT and mechanical CVT dual motor architecture having a ball planetary transmission, two motor/generators, an engine, and a planetary gearbox.

FIG. 73 is another schematic diagram of a series parallel hybrid eCVT and mechanical CVT dual motor architecture having a ball planetary transmission, two motor/generators, an engine, and a planetary gearbox.

FIG. 74 is another schematic diagram of a series parallel hybrid eCVT and mechanical CVT dual motor (split) architecture having a ball planetary transmission, two motor/generators, an engine, and a planetary gearbox.

FIG. 75 a-d are schematic diagrams of series-parallel hybrid architecture during different operating conditions.

FIG. 76 is a schematic diagram of a hybrid architecture having a ball planetary transmission.

FIG. 77 is a schematic diagram of another hybrid architecture having a ball planetary transmission.

FIG. 78 is a schematic diagram of yet another hybrid architecture having a ball planetary transmission.

FIG. 79 is a schematic diagram of a vehicle having a hybrid architecture having a ball planetary transmission.

FIG. 80 is a schematic diagram of a hybrid powertrain having a ball planetary continuously variable transmission, two motor-generators, a clutch, and a brake.

FIG. 81 is another schematic diagram of a hybrid powertrain having a ball planetary continuously variable transmission, two motor-generators, a clutch, and a brake.

FIG. 82 is another schematic diagram of a hybrid powertrain having a ball planetary continuously variable transmission, two motor-generators, a clutch, and a brake.

FIG. 83 is another schematic diagram of a hybrid powertrain having a ball planetary continuously variable transmission, two motor-generators, a clutch, and a brake.

FIG. 84 is a schematic diagram of a hybrid powertrain having a ball planetary continuously variable transmission, two motor-generators, a brake, and a clutch.

FIG. 85 is another schematic diagram of a hybrid powertrain having a ball planetary continuously variable transmission, two motor-generators, and a one-way clutch.

FIG. 86 is another schematic diagram of a hybrid powertrain having a ball planetary continuously variable transmission, two motor-generators, a clutch, and a brake.

FIG. 87 is another schematic diagram of a hybrid powertrain having a ball planetary continuously variable transmission, two motor-generators, a clutch, and a brake.

FIG. 88 is another schematic diagram of a hybrid powertrain having a ball planetary continuously variable transmission, two motor-generators, and two brakes.

FIG. 89 is another schematic diagram of a hybrid powertrain having a ball planetary continuously variable transmission, two motor-generators, and a one-way clutch.

FIG. 90 is another schematic diagram of a hybrid powertrain having a ball planetary continuously variable transmission, two motor-generators, and a one-way clutch.

FIG. 91 is a schematic diagram of a hybrid powertrain having a ball planetary continuously variable transmission, two motor-generators.

FIG. 92 is another schematic diagram of a hybrid powertrain having a ball planetary continuously variable transmission, two motor-generators.

FIG. 93 is another schematic diagram of a hybrid powertrain having a ball planetary continuously variable transmission, two motor-generators.

FIG. 94 is another schematic diagram of a hybrid powertrain having a ball planetary continuously variable transmission, two motor-generators, two clutches, and a brake.

FIG. 95 is another schematic diagram of a hybrid powertrain having a ball planetary continuously variable transmission, two motor-generators, four clutches, and a brake.

FIG. 96 is another schematic diagram of a hybrid powertrain having a ball planetary continuously variable transmission, two motor-generators, a clutch, and a brake.

FIG. 97 is another schematic diagram of a hybrid powertrain having a ball planetary continuously variable transmission, two motor-generators, two clutches, and a brake.

FIG. 98 is another schematic diagram of a hybrid powertrain having a ball planetary continuously variable transmission, two motor-generators, two clutches, and a brake.

FIG. 99 is another schematic diagram of a hybrid powertrain having a ball planetary continuously variable transmission, two motor-generators, two clutches, and a brake.

FIG. 100 is another schematic diagram of a hybrid powertrain having a ball planetary continuously variable transmission, two motor-generators, two clutches, and a brake.

FIG. 101 is another schematic diagram of a hybrid powertrain having a ball planetary continuously variable transmission, two motor-generators, two clutches, and a brake.

FIG. 102 is a table depicting a hybrid powertrain configurations having a ball planetary continuously variable transmission and a fixed ratio planetary gear set.

FIG. 103 is a table depicting a number of hybrid powertrain configurations having a ball planetary continuously variable transmission and a fixed ratio planetary gear set.

FIG. 104 is another schematic diagram of a hybrid powertrain having a ball planetary continuously variable transmission and two motor-generators.

FIG. 105 is another schematic diagram of a hybrid powertrain having a ball planetary continuously variable transmission and two motor-generators.

FIG. 106 is another schematic diagram of a hybrid powertrain having a ball planetary continuously variable transmission, two motor-generators, two clutches, and a brake.

FIG. 107 is a schematic diagram of another hybrid powertrain having a ball planetary continuously variable transmission, two motor-generators, two clutches, and two planetary gear sets.

FIG. 108 is a lever diagram depicting the hybrid powertrain of FIG. 34.

FIG. 109 is a lever diagram depicting a hybrid powertrain having a ball planetary continuously variable transmission, two planetary gear sets, two motor-generators, and four clutches.

FIG. 110 is a lever diagram depicting an operating mode of the hybrid powertrain of FIG. 36.

FIG. 111 is a lever diagram depicting a hybrid powertrain having a ball planetary continuously variable transmission, two planetary gear sets, two motor-generators, and four clutches.

FIG. 112 is a lever diagram depicting an operating mode of the hybrid powertrain of FIG. 38.

FIG. 113 is a lever diagram depicting a hybrid powertrain having a ball planetary continuously variable transmission, two planetary gear sets, two motor-generators, and four clutches.

FIG. 114 is a lever diagram depicting an operating mode of the hybrid powertrain of FIG. 40.

FIG. 115 is a lever diagram depicting a hybrid powertrain having a ball planetary continuously variable transmission, two planetary gear sets, two motor-generators, and two clutches.

FIG. 116 is a lever diagram depicting another hybrid powertrain having a ball planetary continuously variable transmission, two planetary gear sets, two motor-generators, and two clutches.

FIG. 117 is a lever diagram depicting another hybrid powertrain having a ball planetary continuously variable transmission, two planetary gear sets, two motor-generators, and two clutches.

FIG. 118 is a lever diagram depicting yet another hybrid powertrain having a ball planetary continuously variable transmission, two planetary gear sets, two motor-generators, and two clutches.

FIG. 119 is a lever diagram depicting yet another hybrid powertrain having a ball planetary continuously variable transmission, two planetary gear sets, two motor-generators, and two clutches.

FIG. 120 is a lever diagram depicting a hybrid powertrain having a ball planetary continuously variable transmission, two planetary gear sets, two motor-generators, and three clutches.

FIG. 121 is a lever diagram depicting another hybrid powertrain having a ball planetary continuously variable transmission, two planetary gear sets, two motor-generators, and three clutches.

FIG. 122 is a lever diagram depicting another hybrid powertrain having a ball planetary continuously variable transmission, two planetary gear sets, and two motor-generators.

### DETAILED DESCRIPTION OF THE PREFERRED EMBODIMENTS

In current designs for both consuming as well as storing electrical energy, the rotary shaft from a combination electric motor/generator is coupled by a gear train or planetary gear set to the main shaft of an internal combustion engine. As such, the rotary shaft for the electric motor/generator unit rotates in unison with the internal combustion engine main shaft at the fixed gear ratio of the hybrid vehicle design. These hybrid vehicle designs, however, have encountered several disadvantages. One disadvantage is that, since the ratio between the electric motor/generator rotary shaft and the internal combustion engine main shaft is fixed, e.g. 3 to 1, the electric motor/generator is rotatably driven at high speeds during a high speed revolution of the internal combustion engine. For example, in the situations where the ratio between the electric motor/generator rotary shaft and the internal combustion engine main shaft is 3 to 1; if the internal combustion engine is driven at high revolutions per minute of, e.g. 5,000 rpm, the electric motor/generator unit is driven at a rotation three times that amount, or 15,000 rpm. Such high speed revolution of the electric motor/generator thus necessitates the use of expensive components, e.g., bearings and brushes, to be employed to prevent damage to the electric motor/generator during such high speed operation.

A still further disadvantage of these hybrid vehicles is that the electric motor/generator unit achieves its most efficient operation, both in the sense of generating electricity and also providing additional power to the main shaft of the internal combustion engine, only within a relatively narrow range of revolutions per minute of the motor/generator unit. However, since the previously known hybrid vehicles utilized a fixed ratio between the motor/generator unit and the internal combustion engine main shaft, the motor/generator unit oftentimes operates outside its optimal speed range. As such, the overall hybrid vehicle operates at less than optimal efficiency. Therefore, there is a need for powertrain configurations that will improve the efficiency of hybrid vehicles.

Therefore, these embodiments relate to powertrain configurations and architectures that are optionally used in hybrid vehicles. The powertrain and/or drivetrain configurations used a ball planetary style continuously variable transmission, such as the VariGlide®, in order to couple power sources used in a hybrid vehicle, for example, combustion engines (internal or external), motors, generators, batteries, and gearing.

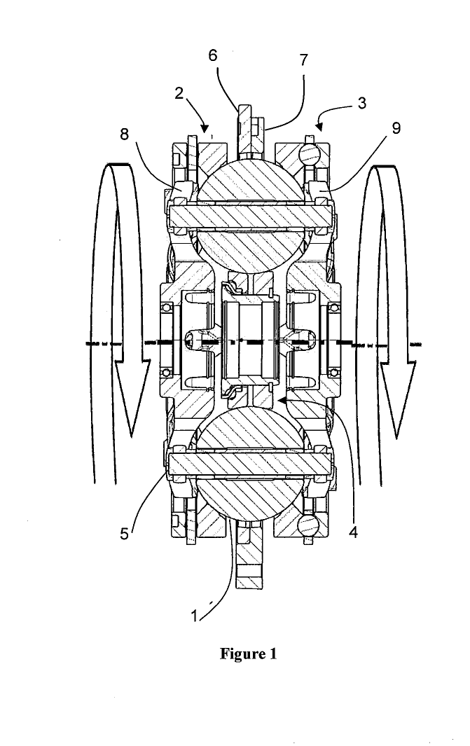

A typical ball planetary variator CVT design, such as that described in United States Patent Publication No. 2008/0121487 and in U.S. Pat. No. 8,469,856, both incorporated herein by reference, represents a rolling traction drive system, transmitting forces between the input and output rolling surfaces through shearing of a thin fluid film. The technology is called Continuously Variable Planetary (CVP) due to its analogous operation to a planetary gear system. The system consists of an input disc (ring) driven by the power source, an output disc (ring) driving the CVP output, a set of balls fitted between these two discs and a central sun, as illustrated in FIG. 1. The balls are able to rotate around their own respective axle by the rotation of two carrier disks at each end of the set of ball axles. The system is also referred to as the Ball-Type Variator.

The preferred embodiments will now be described with reference to the accompanying figures, wherein like numerals refer to like elements throughout. The terminology used in the descriptions below is not to be interpreted in any limited or restrictive manner simply because it is used in conjunction with detailed descriptions of certain specific embodiments. Furthermore, embodiments optionally include several novel features, no single one of which is solely responsible for its desirable attributes or which is essential to practicing the preferred embodiments described.

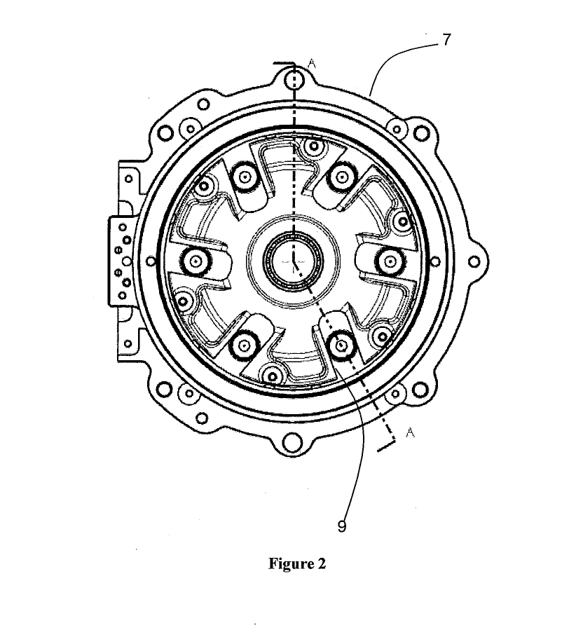

Provided herein are configurations of CVTs based on a ball type variators, also known as CVP, for continuously variable planetary. Basic concepts of a ball type Continuously Variable Transmissions are described in U.S. Pat. Nos. 8,469,856 and 8,870,711 incorporated herein by reference in their entirety. Such a CVT, adapted herein as described throughout this specification, includes a number of balls (planets, spheres) 1, depending on the application, two ring (disc) assemblies with a conical surface contact with the balls, as first traction ring 2 and second traction ring 3, and an idler (sun) assembly 4 as shown on FIG. 1. Sometimes, the first traction ring 2 is referred to in illustrations and referred to in text by the label “R1”. The second traction ring 3 is referred to in illustrations and referred to in text by the label “R2”. The idler (sun) assembly is referred to in illustrations and referred to in text by the label “S”. The balls are mounted on tiltable axles 5, themselves held in a carrier (stator, cage) assembly having a first carrier member 6 operably coupled to a second carrier member 7 (FIG. 2). Sometimes, the carrier assembly is denoted in illustrations and referred to in text by the label “C”. These labels are collectively referred to as nodes (“R1”, “R2”, “S”, “C”). The first carrier member 6 optionally rotates with respect to the second carrier member 7, and vice versa. In some embodiments, the first carrier member 6 is optionally substantially fixed from rotation while the second carrier member 7 is configured to rotate with respect to the first carrier member, and vice versa. In one embodiment, the first carrier member 6 is optionally provided with a number of radial guide slots 8. The second carrier member 7 is optionally provided with a number of radially offset guide slots 9 (FIG. 2). The radial guide slots 8 and the radially offset guide slots 9 are adapted to guide the tiltable axles 5. The axles 5 is optionally adjusted to achieve a desired ratio of input speed to output speed during operation of the CVT. In some embodiments, adjustment of the axles 5 involves control of the position of the first and second carrier members to impart a tilting of the axles 5 and thereby adjusts the speed ratio of the variator. Other types of ball CVTs also exist, like the one produced by Milner, but are slightly different.

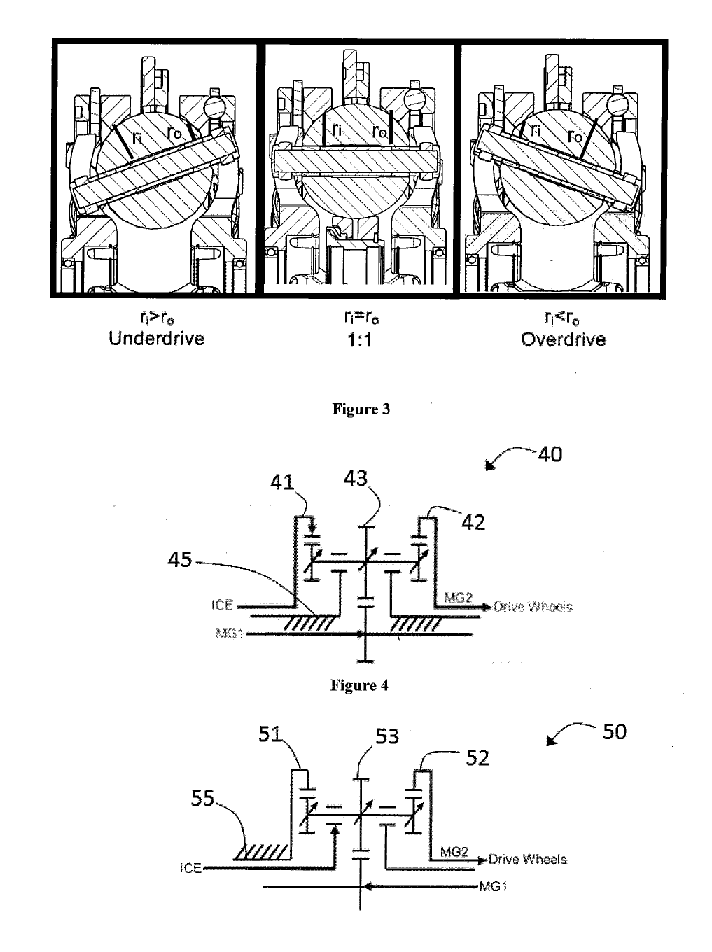

The working principle of such a CVP of FIG. 1 is shown on FIG. 3. The CVP itself works with a traction fluid. The lubricant between the ball and the conical rings acts as a solid at high pressure, transferring the power from the input ring, through the balls, to the output ring. By tilting the balls' axes, the ratio is changed between input and output. When the axis is horizontal the ratio is one, illustrated in FIG. 3, when the axis is tilted the distance between the axis and the contact point change, modifying the overall ratio. All the balls' axes are tilted at the same time with a mechanism included in the carrier and/or idler. Embodiments disclosed here are related to the control of a variator and/or a CVT using generally spherical planets each having a tiltable axis of rotation that is adjusted to achieve a desired ratio of input speed to output speed during operation. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In one embodiment, a control system coordinates the use of a skew angle to generate forces between certain contacting components in the variator that will tilt the planet axis of rotation. The tilting of the planet axis of rotation adjusts the speed ratio of the variator.

As used here, the terms “operationally connected”, “operationally coupled”, “operationally linked”, “operably connected”, “operably coupled”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe inventive embodiments, specific structures or mechanisms that link or couple the elements are typically described. However, unless otherwise specifically stated, when one of said terms is used, the term indicates that the actual linkage or coupling optionally take a variety of forms, which in certain instances will be readily apparent to a person of ordinary skill in the relevant technology.

For description purposes, the term “radial” is used here to indicate a direction or position that is perpendicular relative to a longitudinal axis of a transmission or variator. The term “axial” as used here refers to a direction or position along an axis that is parallel to a main or longitudinal axis of a transmission or variator. For clarity and conciseness, at times similar components labeled similarly (for example, a control piston 123A and a control piston 123B) will be referred to collectively by a single label (for example, control pistons 123).

It should be noted that reference herein to “traction” does not exclude applications where the dominant or exclusive mode of power transfer is through “friction.” Without attempting to establish a categorical difference between traction and friction drives here, generally these are optionally understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (p) represents the maximum available traction force which would be available at the interfaces of the contacting components and is the ratio of the maximum available drive torque per contact force. Typically, friction drives generally relate to transferring power between two elements by frictional forces between the elements. For the purposes of this disclosure, it should be understood that the CVTs described herein optionally operate in both tractive and frictional applications. For example, in the embodiment where a CVT is used for a bicycle application, the CVT optionally operates at times as a friction drive and at other times as a traction drive, depending on the torque and speed conditions present during operation.

Referring now to FIG. 4, in some embodiments using a continuously variable CVP 100 as described previously in FIGS. 1-3, a hybrid powertrain architecture is shown with a fixed ratio planetary powertrain 40, including a first ring (R1) 41, a second ring (R2) 42, a sun (S) 43, and a carrier (C) 45, wherein an internal combustion engine (ICE) is coupled to a fixed carrier 45 planetary. A first motor/generator MG1 is configured to control speed/power. The first motor/generator MG1 in the embodiment of FIG. 4 is inside the CVP 100 cam drivers, sometimes referred to as axial force generators operably coupled to the first traction ring 41 and the second traction ring 43. In some embodiments, the first motor/generator MG1 operates at speeds as high as 30,000 rpm to 40,000 rpm. One of skill in the art will recognize that the first motor/generator, MG1, is optionally configured to be small in size for its relative power. A second motor/generator, MG2, is configured to control torque. The second motor/generator MG2 drive layout of FIG. 4 may not take advantage of the CVP 100 multiplication in some embodiments, although in some embodiments it may optionally do so.

Passing to FIG. 5, in some embodiments using a CVP 100 as described previously, a hybrid vehicle is shown with a fixed ratio planetary powertrain 50, including a first ring (R1) 51, a second ring (R2) 52, a sun (S) 53, and a carrier (C) 55, having an ICE arranged on a high inertia powerpath. The embodiment of FIG. 5 includes a fixed carrier. In some embodiments, an infinitely variable transmission having a rotatable carrier is coupled to the ICE to enable reverse operation and vehicle launch. The first motor/generator, MG1, is configured to control speed/power. The second motor/generator, MG2, is configured to control torque. The ICE is configured to operate in a high inertia powerpath. The ICE is arranged to react inertias of the first motor/generator MG1 and the second motor/generator MG2 under driving conditions of the vehicle. In some embodiments, the ICE operates at high speeds similar to those speeds typical of a gas turbine. In some embodiments, a step up gear is coupled to the ICE to provide a high speed input to the system.

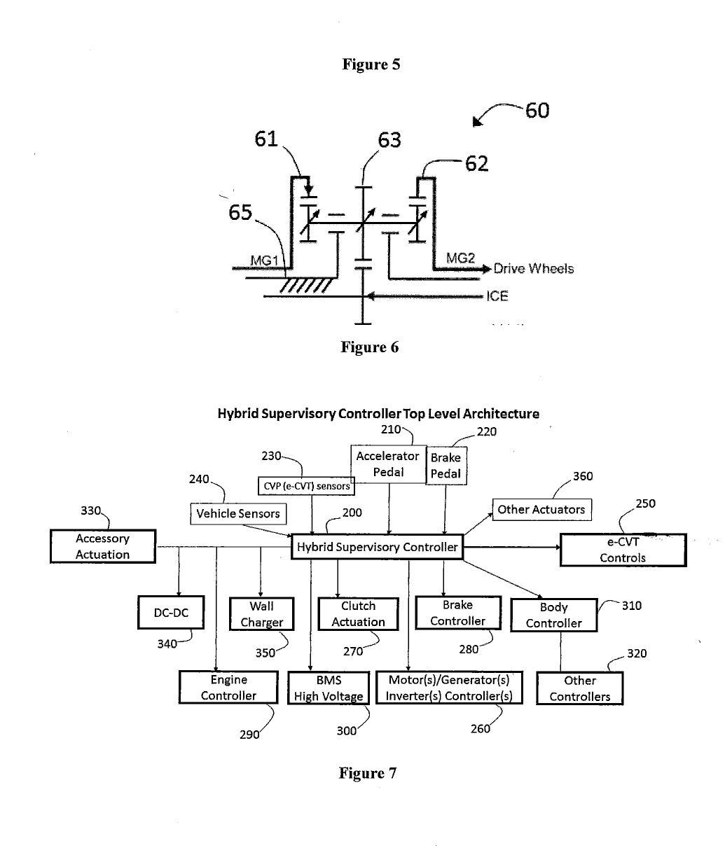

Turning now to FIG. 6, in some embodiments using a CVP, a hybrid vehicle is shown with a fixed ratio planetary powertrain 60, including a first ring (R1) 61, a second ring (R2) 62, a sun (S) 63, and a carrier (C) 65, having an ICE arranged on a high speed powerpath and configured to react with the first motor/generator, MG1, and the second motor/generator, MG2, during operation. The embodiment of FIG. 6 includes a fixed carrier. The ICE is configured to operate in a high speed powerpath. The ICE is arranged to react the first motor/generator MG1 and the second motor/generator MG2 during driving conditions. The ICE can optionally be a very high speed input, such as a gas turbine, or the ICE is optionally coupled to a step up gear.

Embodiments disclosed herein are directed to control systems for a hybrid vehicle powertrain architectures and/or configurations that incorporate a CVP as a power split system in place of a regular planetary leading to a continuously variable power split system where series, parallel or series-parallel, hybrid electric vehicle (HEV) or electric vehicle (EV) modes are optionally obtained. For purposes of description and not limitation, examples of hybrid vehicle powertrains that incorporate a CVP are described in reference to FIGS. 13-88. The core element for controlling the power transmitted through the powertrain is the CVP, which functions in a first mode as a continuously variable planetary gear split differential with all four of its nodes (R1, R2, C, and S) being variable, and functions in a second mode as a mechanical continuously variable transmission, where at least one of the CVP nodes is a grounded member. During operation, distribution of a rotational input power, sometimes referred to herein as “power split”, “torque split”, or “load split”, can be controlled through adjustment of the CVP speed ratio. For example, when the CVP speed ratio is 1:1, the machine connected to R2 will receive a specific fraction of input torque. In overdrive (speed ratio >1) or underdrive (speed ratio <1) the machine connected to R2 will receive a different fraction of input torque. In some applications, the amount of input torque delivered to R2 is greater than 100% and the system will be regenerative. It should be noted that hydro-mechanical components such as hydromotors, pumps, accumulators, among others, are optionally used in place of the electric machines indicated in the figures and accompanying textual description. Furthermore, it should be noted that embodiments of hybrid supervisory controllers that choose the path of highest efficiency from engine to wheel, lead to the creation of hybrid powertrains that will operate at the best potential overall efficiency point in any mode and also provide torque variability, thereby leading to the optimal combination of powertrain performance and fuel efficiency. It should be understood that hybrid vehicles incorporating embodiments of the hybrid architectures disclosed herein optionally include a number of other powertrain components, such as, but not limited to, high-voltage battery pack with a battery management system or ultracapacitor, on-board charger, DC-DC converters, a variety of sensors, actuators, and controllers, among others.

For description purposes, the terms “prime mover”, “engine”, and like terms, are used herein to indicate a power source. Said power source is optionally fueled by energy sources including hydrocarbon, electrical, biomass, nuclear, solar, geothermal, hydraulic, pneumatic, and/or wind to name but a few. Although typically described in a vehicle or automotive application, one skilled in the art will recognize the broader applications for this technology and the use of alternative power sources for driving a transmission including this technology. For description purposes, the terms “electronic control unit”, “ECU”, “Driving Control Manager System” or “DCMS” are used interchangeably herein to indicate a vehicle's electronic system that controls subsystems monitoring or commanding a series of actuators on an internal combustion engine to ensure optimal engine performance. It does this by reading values from a multitude of sensors within the engine bay, interpreting the data using multidimensional performance maps (called lookup tables), and adjusting the engine actuators accordingly. Before ECUs, air-fuel mixture, ignition timing, and idle speed were mechanically set and dynamically controlled by mechanical and pneumatic means.

Those of skill will recognize that the various illustrative logical blocks, modules, circuits, strategies, schemes, and algorithm steps described in connection with the embodiments disclosed herein, including with reference to the transmission control system described herein, for example, is optionally implemented as electronic hardware, software stored on a computer readable medium and executable by a processor, or combinations of both. To clearly illustrate this interchangeability of hardware and software, various illustrative components, blocks, modules, circuits, strategies, schemes, and steps have been described above generally in terms of their functionality. Whether such functionality is implemented as hardware or software depends upon the particular application and design constraints imposed on the overall system. Skilled artisans could implement the described functionality in varying ways for each particular application, but such implementation decisions should not be interpreted as causing a departure from the scope of the present embodiments. For example, various illustrative logical blocks, modules, strategies, schemes, and circuits described in connection with the embodiments disclosed herein is optionally implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor is optionally a microprocessor, but in the alternative, the processor is optionally any conventional processor, controller, microcontroller, or state machine. A processor is also optionally implemented as a combination of computing devices, e.g., a combination of a DSP and a microprocessor, a plurality of microprocessors, one or more microprocessors in conjunction with a DSP core, or any other such configuration. Software associated with such modules optionally resides in RAM memory, flash memory, ROM memory, EPROM memory, EEPROM memory, registers, a hard disk, a removable disk, a CD-ROM, or any other suitable form of storage medium known in the art. An exemplary storage medium is coupled to the processor such that the processor is capable of reading information from, and writing information to, the storage medium. In the alternative, the storage medium is optionally integral to the processor. The processor and the storage medium optionally reside in an ASIC. For example, in one embodiment, a controller for use of control of the IVT includes a processor (not shown).

### Certain Definitions

Unless otherwise defined, all technical terms used herein have the same meaning as commonly understood by one of ordinary skill in the art to which these embodiments belongs. As used in this specification and the appended claims, the singular forms “a,” “an”, and “the” include plural references unless the context clearly dictates otherwise. Any reference to “or” herein is intended to encompass “and/or” unless otherwise stated.

### Digital Processing Device

In some embodiments, the Control System for a Vehicle equipped with an infinitely variable transmission described herein includes a digital processing device, or use of the same. In further embodiments, the digital processing device includes one or more hardware central processing units (CPU) that carry out the device's functions. In still further embodiments, the digital processing device further includes an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony® PS4®, Microsoft® Xbox 360®, Microsoft Xbox One, Nintendo® Wii®, Nintendo® Wii U®, and Ouya®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory includes flash memory. In some embodiments, the non-volatile memory includes dynamic random-access memory (DRAM). In some embodiments, the non-volatile memory includes ferroelectric random access memory (FRAM). In some embodiments, the non-volatile memory includes phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

### Non-Transitory Computer Readable Storage Medium

In some embodiments the Control System for a Vehicle equipped with an infinitely variable transmission disclosed herein includes one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the Control System for a Vehicle equipped with an infinitely variable transmission disclosed herein includes at least one computer program, or use of the same. A computer program includes a sequence of instructions, executable in the digital processing device's CPU, written to perform a specified task. Computer readable instructions are optionally implemented as program modules, such as functions, objects, Application Programming Interfaces (APIs), data structures, and the like, that perform particular tasks or implement particular abstract data types. In light of the disclosure provided herein, those of skill in the art will recognize that a computer program is optionally written in various versions of various languages.

The functionality of the computer readable instructions are optionally combined or distributed as desired in various environments. In some embodiments, a computer program includes one sequence of instructions. In some embodiments, a computer program includes a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

In reference to FIGS. 7-12, embodiments of supervisory controllers for hybrid powertrains incorporating a CVP, for illustrative example refer to FIGS. 1-6 and FIGS. 13-88, includes a plurality of estimators. Estimators generally are control strategy computations configured to be state observers that calculate additional estimations to determine the state of the hybrid-electric vehicle (HEV) and other components based on information from sensors & CAN (controller area network). In one embodiment, the supervisory controller includes a top-level mode arbitrator for charge sustain and charge deplete based on the high voltage pack state of charge (SOC), state of health (temperature etc.), engine, CVP and brake operation in addition to driver demand monitoring in the form of accelerator & brake pedal positions. In one embodiment, the electric vehicle (EV) & HEV mode arbitrations that include series, parallel & series-parallel modes are based on current powertrain configuration (for example clutch actuation, ratio change etc.). The mode arbitrator implements feedback mechanically (for example, pressure, position, among others) or electrically (current, voltage, among others) to control clutch actuation for hybrid powertrain architecture embodiments including a clutch. In one embodiment, electric machine controls in the form of torque, speed or other form of electrical controls depending on the EV/HEV mode are provided by the hybrid supervisory controller. The hybrid supervisory controller optionally provides torque split for the machines based on driver demand, machine limits, accessory load, NVH (noise-vibration-harshness) requirements, efficiency optimization, and other vehicle requirements as described in Figures below. In one embodiment, regenerative braking controls based on brake light switch information from the brake controller, and use of an optimum CVP ratio that is capable of regenerating at optimum overall efficiencies and other vehicle requirements (machine limit, high voltage pack limit, deceleration requirements etc.) are performed by the hybrid supervisory controller.

In some embodiments, the hybrid supervisory controller is optionally configured to interface with an engine controller (ECU) in the form of throttle controls and fueling control for gasoline engines. Other engine types include some form of torque management control for the engine. Clutch controls for smooth engagement & disengagement of clutches is optionally configured in the hybrid supervisory controller. Additionally, the hybrid supervisory controller is optionally configured to include key on/ignition on power on & off controls, faults & diagnostics checks, gear shifter or PRNDL interface, high voltage wake up sequence controls, high voltage on checks, machine direction controls based on PRNDL position, DC-DC turn on, accessory and cooling system controls. Charger controls for plug-in hybrid electric vehicle (PHEV) type vehicles are optionally configured as part of the hybrid supervisory controller. Cooling system for electric machines and battery pack control are optionally configured in the hybrid supervisory controller.

In some embodiment, the hybrid supervisory controller includes a state machine for mode transition and verification that desired mode is achieved. In some embodiments, HEV powertrain mode hysteresis protection and CVP ratio variation along with hysteresis protection are optionally included in the hybrid supervisory controller. Fault detection & recovery strategy specifically for HEV powertrain (including CVP related faults) is optionally included in the hybrid supervisory controller. Filtering capabilities for noise elimination in sensing systems specific to the HEV/PHEV drivetrain is optionally implemented in the hybrid supervisory controller.

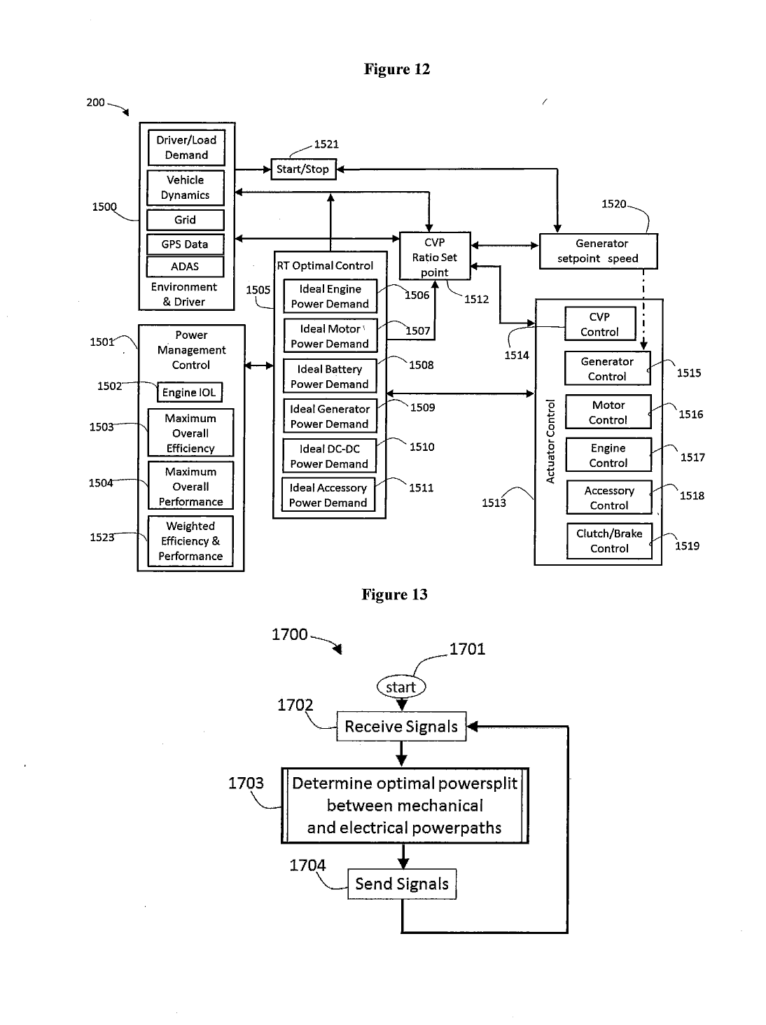

During operation of a vehicle implementing the hybrid supervisory controller, a control strategy for maximum overall efficiency is implemented using a cost function, a calibrateable map readable from memory, or a physics-based estimation forming the basis for maximum overall HEV drivetrain efficiency since engine, machine & pack efficiency data is typically known or estimated. It should be appreciated, that a downsized engine is operated along the ideal operating line (IOL), discussed in more detail in reference to FIGS. 9 and 12, for lowest brake specific fuel consumption (BSFC) in charge sustain mode normally, since the engine is the component that provides the maximum efficiency improvement (CVP efficiency is also accounted). However, the hybrid supervisory controller described herein is optionally configured to select the torque split of the hybrid powertrain based on driver demand and overall efficiency. Stated differently, the hybrid supervisory controller selects the CVP ratio that provides the maximum overall efficiency. Feedback controls (for example, speed feedback) are optionally configured to confirm the actual CVP ratio. A combination of feedback and feedforward controls are applied so as to provide look ahead functionality in addition to closed loop controls. The feedforward gain term is optionally adjusted based on torque split within the CVP to obtain the desired response of the powertrain to satisfy noise-vehicle-harshness (NVH) or drivetrain harmonic requirements. Learning/Adaptive controls are optionally implemented so that the CVP system performs at it optimal level.

In some embodiments, the hybrid supervisory controller is optionally configured for use in series-parallel hybrid vehicles where the engine is operated on IOL of lowest BSFC when possible. The primary traction motor provides additional torque to the wheels, the generator provides charge sustain for the battery system, the CVP is configured to operate at the desired ratio for achieving the highest overall efficiency in the event of no fault in the system or derate of power is requested. The charge and discharge loss estimation for the high voltage paths are accounted for in the form of estimators, for example, accessory loss estimation. Adaptive controls are implemented in the hybrid supervisory controller to learn from an undesirable ratio change that did not provide the higher overall efficiency expected. Adaptive controls are optionally configured to run in conjunction with other prognostics/diagnostics code. Closed loop/feedback controls are implemented to ensure that the hybrid powertrain is operating at the desired torque split ratio and/or speed ratio.

Referring now to FIG. 7, in one embodiment a hybrid supervisory controller 200 is adapted to receive a plurality of input signals obtained from sensors equipped on the vehicle, and deliver a plurality of output signals to actuators and controllers provided on the vehicle. For example, the hybrid supervisory controller 200 is configured to receive signals from an accelerator pedal position sensor 210, a brake pedal position sensor 220, and a number of CVP sensors 230. The CVP sensors 230 optionally include input speed sensors, actuator position sensor, temperature sensors, and torque sensors, among others. The hybrid supervisory controller 200 receives a number of input signals from vehicle sensors 240. For example, the vehicle sensors 240 include, but are not limited to, battery state of charge (SOC), motor speed sensor, generator speed sensor, engine speed sensor, engine torque sensor, and a number of temperature sensors, among others. The hybrid supervisory controller 200 performs a number of calculations based at least in part on the input signals to thereby generate the output signals. The output signals are received by a number of control modules equipped on the vehicle. For example, the hybrid supervisory controller 200 is configured to communicate with a CVT control module 250, a motor/generator/inverter control module 260, a clutch actuator module 270, a brake control module 280, an engine control module 290, a battery management system (BMS) high voltage control module 300, a body control module 310, among other control modules 320 equipped on the vehicle. It should be appreciated that the motor/generator/inverter control module 260 is optionally configured with a number of submodules to perform control functions for those components. The hybrid supervisory controller 200 is adapted to be in communication with an accessory actuator module 330. In some embodiments, the hybrid supervisory controller 200 is optionally configured to communicate a DC-DC inverter module 340 and a wall charger module 350, among other actuator control modules 360. It should be appreciated that the hybrid supervisory controller 200 is adapted to communicate with a number of vehicle controllers via CAN interface or direct electric connection. In some embodiments, the hybrid supervisory controller 200 is adapted to interface with a typical electric grid configured to supply electrical energy from a source to a consumer.

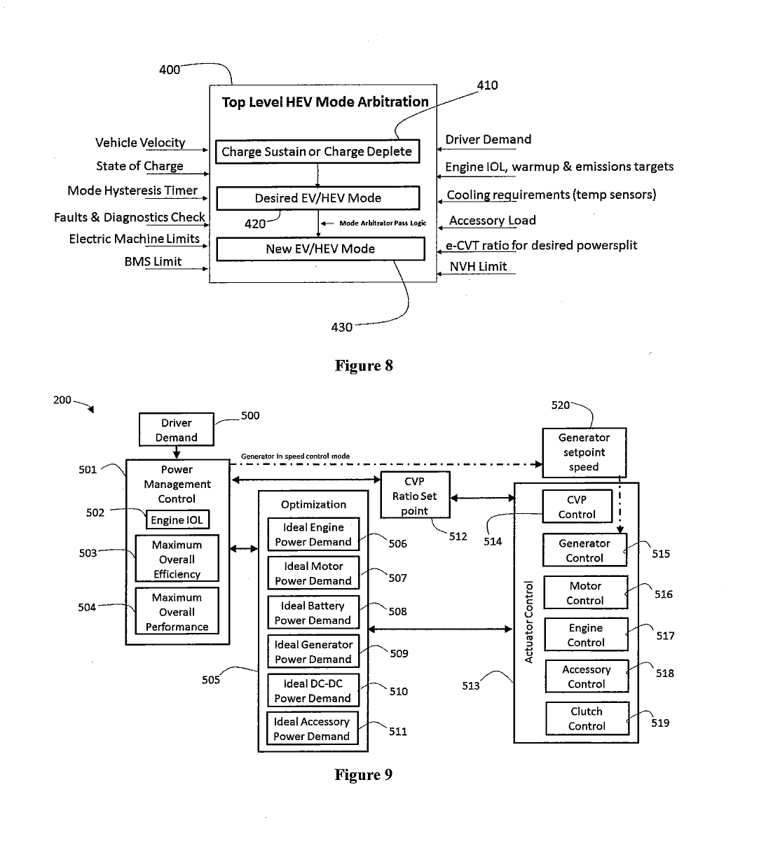

Turning now to FIG. 8, a top level mode transition state machine 400 is depicted. The state machine 400 is configured to receive a number of signals. For example, input signals optionally include vehicle velocity, battery state of charge, mode hysteresis timer, faults and diagnostic checks, electric machine limits, BMS limits, driver demand, engine IOL, warmup and emissions targets, cooling requirements, accessory loads, CVP ratio for desired powersplit, noise vehicle harshness (NVH) limits, among others. It should be appreciated that input signals to the hybrid supervisory controller 200 are information from sensors and CAN information. In one embodiment, the top level mode transition state machine 400 is optionally configured to receive input signals from sensors, CAN information, or estimators. In one embodiment, estimators are observers or virtual sensors implemented in the hybrid supervisory controller 200. The state machine 400 includes a charge sustain/deplete mode 410, a desired mode 420, and a new mode 430.

During operation of a vehicle that implements the hybrid supervisory controller 200, adjusting the CVP ratio to obtain the highest overall efficiency of the drivetrain is described. The e-CVT architecture has the CVP functioning as a planetary differential with no nodes kinematically constrained. The torque splits in the system are dependent on the CVP ratio, but the speeds of the engine & electric machines are capable of floating. Optimizing for highest overall efficiencies of the engine & electric machines is thereby possible because the speeds are capable of floating and also because the speed ratio of the CVP are capable of being adjusted for optimal efficiency.

Referring now to FIG. 9, in one embodiment, the hybrid supervisory controller 200 includes a driver demand module 500. The driver demand module 500 is configured to receive a number of signals from vehicles sensors, for example the vehicle sensors 240, the accelerator pedal position sensor 210, and the brake pedal position sensor 220, among others. The driver demand module 500 is configured to execute software instructions to assess the desired vehicle performance requested by the operator of the vehicle. The driver demand module 500 is in communication with the power management control module 501. The power management control module 501 includes an engine IOL module 502, a maximum overall efficiency module 503, and a maximum overall performance module 504. The power management control module 501 is in communication with an optimization module 505. The optimization module 505 is configured to include a number of sub-modules adapted to execute software algorithms such as optimizers, estimators, and observers, among others, which perform dynamic estimations in real time to compute optimal powertrain state that then acts as a driving input to a powertrain state machine, for example the top level mode transition state machine 400, among others not shown. In one embodiment, the optimization module 505 includes an ideal engine power demand sub-module 506. The ideal engine power demand sub-module 506 is configured to determine ideal operating conditions for the engine. The optimization module 505 includes an ideal motor power demand sub-module 507. The ideal motor power demand sub-module 507 is adapted to determine the ideal operating conditions for the motor or motors equipped on the vehicle. The optimization module 505 includes an ideal battery demand sub-module 508. The ideal battery demand sub-module 508 is configured to be in communication with a battery management system (BMS), for example BMS high voltage control module 300, and provides feedback to the power management control module 501 for CVP ratio control based on continuous power requirements and cooling load of the battery system equipped in the vehicle. The optimization module 505 includes an ideal generator power demand sub-module 509 configured to estimate the generator power required for a charge sustain operation. The ideal generator power demand sub-module 509 is optionally configured to estimate ideal operating conditions for the generator. The optimization module 505 includes a DC-DC power demand sub-module 510. In one embodiment, the DC-DC power demand sub-module 510 provides feedback to the power management control module 501 on the operation of a DC-DC converter equipped on the vehicle. In one embodiment, the DC-DC converter is a well-known buck boost converter (step-up/step down transformer) between the high voltage and the low voltage bus. There is a conversion efficiency associated with the step-up/step-down transformation. If the accessories are driven indirectly off the high voltage pack as opposed to the low voltage system, then battery efficiency and DC-DC conversion efficiency factors in for delivering a certain amount of continuous power. In one embodiment, an algorithm is implemented in the DC-DC power demand sub-module 510 to use this accessory load optimally. The optimization module 505 includes an ideal accessory power demand sub-module 511 configured to monitor and adjust a number of vehicle accessories. The ideal engine power demand sub-module 506, the ideal motor power demand sub-module 507, the ideal battery demand sub-module 508, the ideal generator power demand sub-module 509, the DC-DC & charger power demand sub-module 510, and the ideal accessory power demand sub-module 511 are configured to execute software algorithms including observers, estimators, and optimization routines aimed at optimizing the complete HEV powertrain.

Referring still to FIG. 9, in one embodiment the power management control module 501 is in communication with a CVP ratio control module 512. The CVP ratio control module 512 is adapted to execute a number of software calculations governing to operation of the CVP. The CVP ratio control module 512 and the optimization module 505 are adapted to communicate with an actuator control module 513. The actuator control module 513 generally coordinates the execution of command signals to actuator hardware equipped in the powertrain. In one embodiment, the actuator control module 513 includes a CVP control sub-module 514, a generator control sub-module 515, a moto control sub-module 516, an engine control sub-module 517, an accessory control sub-module 518, and a clutch control sub-module 519. In one embodiment, the power management control module 501 is in communication with a generator speed control module 520 configured to determine command signals to provide to the generator control sub-module 515 based on certain driver demand conditions.

### Optimal BSFC & Emissions Control Strategy

In one embodiment, the engine IOL module 502 implements a computer executable control strategy to operate the engine in conditions corresponding to ideal operating lines (IOL), for example, engine operating points lying on the minimum brake specific fuel consumption line (maximum thermal efficiency). The ideal operating line (IOL) is a line of most efficient operating conditions formed on a speed versus torque plot. For example, FIG. 12 depicts a speed versus torque plot for a representative engine. Lines of constant power are shown as well as ideal operating lines for fuel consumption, carbon monoxide (CO) emissions, hydrocarbon (HC) emissions, and oxides of nitrogen emissions (NOx), refer to the legend. For illustrative purposes, an operating line for low temperature combustion (LTC line) is depicted. Due to more and more stringent emissions requirements, an additional IOL constraint for least emissions and highest efficiency combined is used to satisfy the global emissions & fuel consumption targets. A cost function, weighting method or any optimization algorithm to obtain the ideal engine operating point that satisfies emissions requirements at the lowest BSFC possible for any driver power demand is implemented in the engine IOL module 502. In some embodiments, a backward facing optimization routine is optionally implemented over a number of drive, cycles. In such routines, optimal set point ratio between electric machines and prime movers are selected through optimization over different drive cycles and determining CVP ratio at which a driver demand can be met most efficiently. For example, a drive cycle c velocity versus time is converter to power versus time data in the control system by multiplying drive cycle velocity with the combined total road load and inertial force. The efficiency map (torque loss map) of the variator can be estimated or known from real world testing. The plantetary gear efficiencies can be computed and therefore the total drivetrain efficiency (minus the electric machine efficiency) can be estimated for any CVP ratio and planetary configuration. The CVP ratio at which the driver power demand can be met most efficiently can therefore be calculated. For the same power demand a forward recursion is then done to estimate the ratio at which motor and drivetrain combined efficiency can be the highest. These calculations can be performed offline and the learnings can be used to generate a CVP ratio map. This map also needs to account for drivability and other vehicle performance requirements. The optimal ratio map is then used as a calibration table within the controller. This methodology is optionally implemented for parallel hybrid architectures. The backward facing optimization routine is used to identify optimum ratios of the CVT over the drive cycle.

### Optimal Overall Efficiency Control Strategy

In one embodiment, the maximum overall efficiency module 503 implements a computer executable control strategy for optimizing overall efficiency estimation. In one embodiment, the maximum overall efficiency module 503 implements an adaptive learning algorithm to enable the hybrid supervisory controller 200 to refine operating points using fuel consumption and power consumption feedback estimators as described in the preceding sections above. Feedforward controls with gain adjustment are also optionally used to anticipate a future power demand based on past learning (adaptive controls).

### Highest Performance Control Strategy

In one embodiment, the maximum overall performance module 504 implements a computer executable control strategy for governing high performance demands by the driver of the vehicle. Maximum power from machines is available as long as machine limits are not violated. The maximum overall performance module 504 implements a number of algorithms to determine operating conditions of the engine, motors, generators, and CVP based at least upon driver demand, state of charge (SOC) of the battery pack, engine reserve power, fuel consumption, emissions/after-treatment limitations, launch or traction control limits, and electronic braking controller limits, among others. In one embodiment, the engine is configured to optionally add torque after launching with the electric machines. If state of charge (SOC) is low & other constraints limit the system, then the driver needs to be warned of the non-availability of the “high performance mode”. It should be appreciated that the hybrid supervisory controller 200 includes a limp-home mode of operation and associated fail-safe limitations of the battery pack that includes appropriate strategies for maintaining a reserve battery charge.

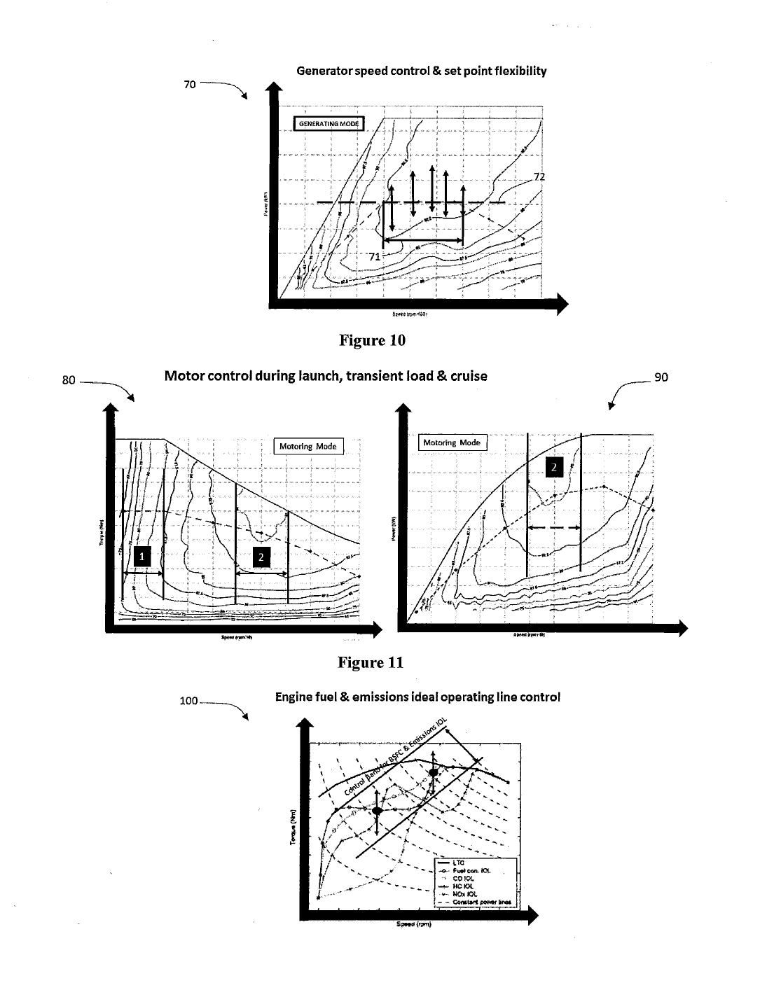

Referring not to FIG. 10, a chart 700 depicts an illustrative generator efficiency map as a function of speed (x-axis) and power (y-axis). The arrows marked on the chart 70 demonstrates how the hybrid supervisory controller 200 coordinates the ratio of the CVP and the associated benefit it offers in terms of expanding the torque and speed range of the electric machine operating as a generator. The primary generator speed set point is capable of being optimized when it is running in the speed control mode such that the power demand to charge sustain the battery pack is met by adjusting the CVP ratio appropriately at the highest possible generator efficiency at each speed set point.

Referring now to FIG. 11, a chart 701 depicts an illustrative motor efficiency as a function of speed (x-axis) and torque (y-axis). A chart 702 depicts an illustrative motor efficiency as a function of speed (x-axis) and power (y-axis). The regions marked as “1” and “2” illustrate how the hybrid supervisory controller 200 is capable of varying the ratio of the CVP to enable the electric machine to run in an ideal operating zone during launch, electric boosting and highway cruising.

Referring now to FIG. 12, a chart 703 depicts ideal operating lines (IOL) of an illustrative engine as a function of speed (x-axis) and torque (y-axis). The control band marked on the chart in heavy lines shows how the hybrid supervisory controller 200 is capable of interfacing with the engine controller to coordinate the control of the CVP ratio and enable the engine to operate on the ideal fuel and/or emissions operating lines. The hybrid supervisory controller 200 is optionally configured to interface with the engine running in the torque control/fueling mode.

Referring now to FIG. 13, in some embodiments, the hybrid supervisory controller 200 includes a driver demand module 1500. The driver demand module 1500 is configured to receive a number of signals from vehicles sensors, for example the vehicle sensors 240, the accelerator pedal position sensor 210, and the brake pedal position sensor 220, among others. The driver demand module 1500 is configured to execute software instructions to assess the desired vehicle performance requested by the operator of the vehicle. The driver demand module 1500 is in communication with the power management control module 1501. The power management control module 1501 includes an engine IOL module 1502, a maximum overall efficiency module 1503, a maximum overall performance module 1504, and a weighted efficiency and performance module 1523. The power management control module 1501 is in communication with a real time optimization module 1505. The real time optimization module 1505 is configured to include a number of sub-modules adapted to execute software algorithms such as optimizers, estimators, and observers, among others, which perform dynamic estimations in real time to compute optimal powertrain state that then acts as a driving input to a powertrain state machine, for example the top level mode transition state machine 400, among others not shown. In some embodiments, the optimization module 1505 includes an ideal engine power demand sub-module 1506. The ideal engine power demand sub-module 1506 is configured to determine ideal operating conditions for the engine. The real time optimization module 1505 includes an ideal motor power demand sub-module 1507. The ideal motor power demand sub-module 1507 is adapted to determine the ideal operating conditions for the motor or motors equipped on the vehicle. The real time optimization module 1505 includes an ideal battery demand sub-module 1508. The ideal battery demand sub-module 1508 is configured to be in communication with a battery management system (BMS), for example BMS high voltage control module 1300, and provides feedback to the power management control module 1501 for CVP ratio control based on continuous power requirements and cooling load of the battery system equipped in the vehicle. The real time optimization module 1505 includes an ideal generator power demand sub-module 1509 configured to estimate the generator power required for a charge sustain operation. The ideal generator power demand sub-module 1509 is optionally configured to estimate ideal operating conditions for the generator. The real time optimization module 1505 includes a DC-DC power demand sub-module 1510. In some embodiments, the DC-DC power demand sub-module 1510 provides feedback to the power management control module 1501 on the operation of a DC-DC converter equipped on the vehicle. In some embodiments, the DC-DC converter is a well-known buck boost converter (step-up/step down transformer) between the high voltage and the low voltage bus. There is a conversion efficiency associated with the step-up/step-down transformation. If the accessories are driven indirectly off the high voltage pack as opposed to the low voltage system, then battery efficiency and DC-DC conversion efficiency factors in for delivering a certain amount of continuous power. In some embodiments, an algorithm is implemented in the DC-DC power demand sub-module 1510 to use this accessory load optimally. The real time optimization module 1505 includes an ideal accessory power demand sub-module 1511 configured to monitor and adjust a number of vehicle accessories. The ideal engine power demand sub-module 1506, the ideal motor power demand sub-module 1507, the ideal battery demand sub-module 1508, the ideal generator power demand sub-module 1509, the DC-DC & charger power demand sub-module 1510, and the ideal accessory power demand sub-module 1511 are configured to execute software algorithms including observers, estimators, and optimization routines aimed at optimizing the complete HEV powertrain.

Referring still to FIG. 13, in some embodiment the real time optimization module 1505 is in communication with a CVP ratio control module 1512. The CVP ratio control module 1512 is adapted to execute a number of software calculations governing the operation of the CVP. The CVP ratio control module 1512 and the real optimization module 1505 are adapted to communicate with an actuator control module 1513. The actuator control module 1513 generally coordinates the execution of command signals to actuator hardware equipped in the powertrain. In some embodiments, the actuator control module 1513 includes a CVP control sub-module 514, a generator control sub-module 1515, a moto control sub-module 1516, an engine control sub-module 1517, an accessory control sub-module 1518, and a clutch control sub-module 1519. In some embodiments, the power management control module 1501 is in communication with a generator speed control module 1520 configured to determine command signals to provide to the generator control sub-module 1515 based on certain driver demand conditions.

In some embodiments, the CVP ratio control module 1512 is adapted to provide a variable distribution between electric machines and power sources such as an internal combustion engine.

Referring still to FIG. 13, in some embodiments, the hybrid supervisory controller 200 includes a start/stop module 1521 in communication with the driver demand module 1500. The start/stop module 1521 is configured to execute a number of software algorithms and instructions governing the start/stop functionality of the IC engine. In some embodiments, the start/stop module 1521 is configured to communicate with the generator speed control module 1520. The start/stop module 1521 is adapted to send command signals to selectively crank the engine.

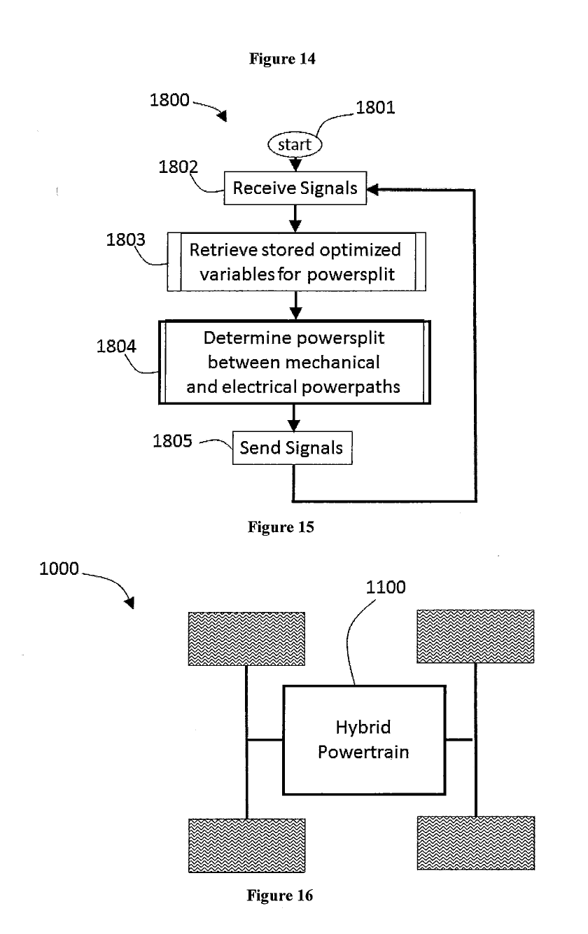

Turning now to FIG. 14, in some embodiments, the hybrid supervisory control system 200 is adapted to implement a control process 1700. In some embodiments, the control process 1700 is included in the CVP ratio control module 1512, for example. The control process 1700 begins at a start state 1701 and proceeds to a block 1702 where a number of operating condition signals are received. The control process 1700 proceeds to a block 1703 where an optimal powersplit between the mechanical powerpath and the electrical powerpath is determined based at least in part on the signals received in the block 1702. In some embodiments, the block 1703 implements cost function control schemes in real time to determine the optimal powersplit. Cost function control schemes are well-known mathematical optimization techniques. For example, the block 1703 optionally executes an equivalent consumption minimization strategy (ECMS) that computationally provides solutions for an optimal powersplit between the engine and the electric machines based at least in part on the fuel consumption rate of the engine and the equivalent power stored for the electric machines. Other real time computational optimization techniques are optionally implemented in the block 1703 to provide instantaneous optimization in real time operation. The control process 1700 proceeds to a block 1704 where a number of command or output signals are sent to other modules in the hybrid supervisory control system 200.

Referring now to FIG. 15, in some embodiments, the hybrid supervisory control system 200 is adapted to implement a control process 1800. In some embodiments, the control process 1800 is included in the CVP ratio control module 1512, for example. The control process 1800 begins at a start state 1801 and proceeds to a block 1802 where a number of operating condition signals are received. The control process 1800 proceeds to a block 1803 where a number of stored optimized variables for the powersplit between the mechanical powerpath and the electrical powerpath are retrieved from memory. In some embodiments, the stored optimized variables for powersplit are determined by dynamic programming methods. Dynamic programming is a control methodology for determining an optimal solution in a multiple variable system. In some embodiments, it is used in a deterministic or a stochastic environment, for a discrete time or a continuous time system, and over a finite time horizon, or an infinite time horizon. Control methodologies of this type are often referred to as horizon optimization. For example, the stored optimized variables are determined by collecting data from a number of vehicle signals during operation of the vehicle. In some embodiments, standard drive cycle conditions used for federal emissions testing are used to operate the vehicle. Dynamic programing computational techniques are used to analyze the collected data and find optimal powersplit solutions to provide desired system efficiency. The solutions are typically further analyzed through computational simulation or other means to provide a comprehensive rule-based model of the powertrain system. The rule-based model, along with any other solutions formulated from dynamic programming techniques, are stored as optimized variables and made available to the control process 1800 in the block 1803. It should be appreciated, that a number of other optimization techniques are optionally implemented to populate the block 1803 with stored optimized variables. For example, convex optimization, Pontryagins Minimum Principle (PMP), stochastic dynamic programming, and power weighted efficiency analysis (PEARS), among others, are options. In some embodiments, the control process 1800 proceeds to a block 1804 where algorithms and software instructions are executed to determine the powersplit between the mechanical powerpath and the electrical powerpath based at least in part on the signals received in the block 1802 or retrieved from memory in the block 1803. The control process 1800 proceeds to a block 1805 where command or output signals are sent to other modules in the hybrid supervisory control system 200.

Referring now to FIG. 16, in one embodiment, the hybrid supervisory controller 200 is implemented in a vehicle 1000 having a hybrid powertrain 1100. The hybrid powertrain 1100 is optionally adapted with a number of mechanical and electrical powertrain components. In some embodiments, the CVP ratio control module 1512 is adapted to provide a variable distribution of power between electric machines and power sources such as an internal combustion engine. For example, typical series-parallel hybrid powertrains having fixed ratio couplings between electric motors and the engine are adapted to operate in two modes. A first mode of operation is characterized as a series mode of operation where the engine is supplying power to an electric machine and the electric machine is thereby providing power to the driven wheels. A second mode of operation is characterized as a parallel mode of operation where the engine is supplying all of the power to the driven wheels at a point referred to as the mechanical point. In other words, the mechanical point for a hybrid powertrain is characterized by a non-zero vehicle speed, or non-zero transmission output speed, and a near zero electric machine speed. For example, series-parallel hybrid powertrains are often designed to provide a mechanical point near a typical highway cruising speed of the vehicle to provide the most efficient operation of the engine. The CVP ratio control module 1512 utilizes the variable speed ratio of the CVP, such as the one disclosed in FIGS. 1-3, to provide a variable mechanical point. Configurations of such hybrid powertrains will be described.

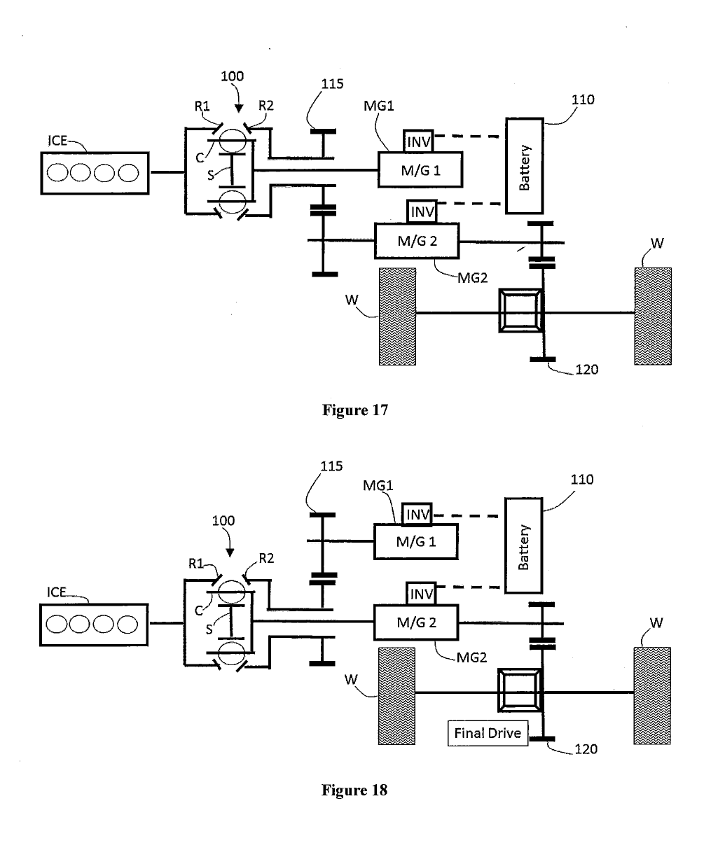

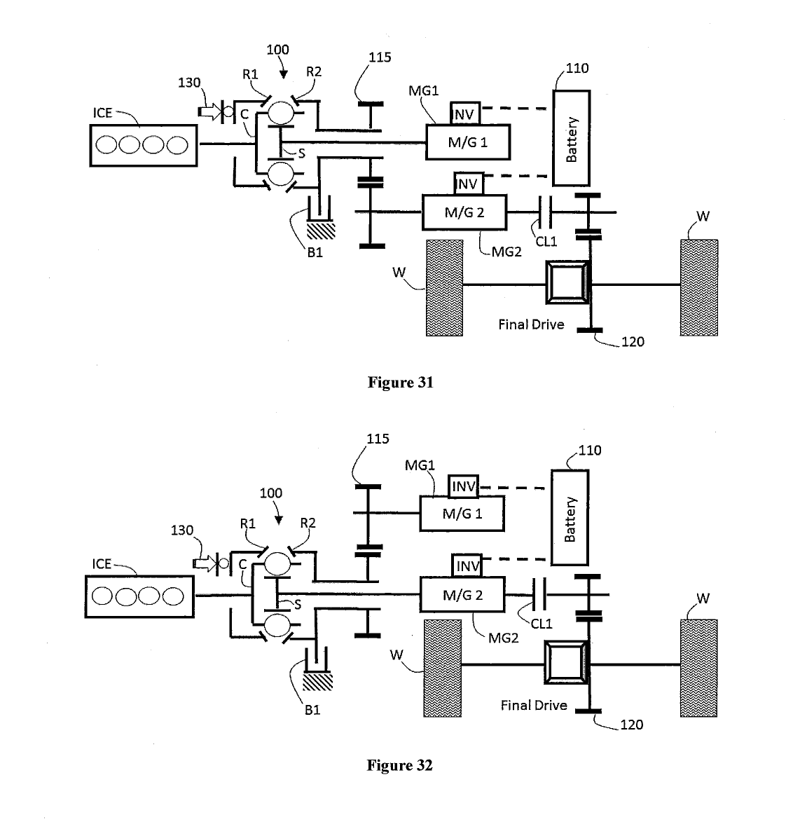

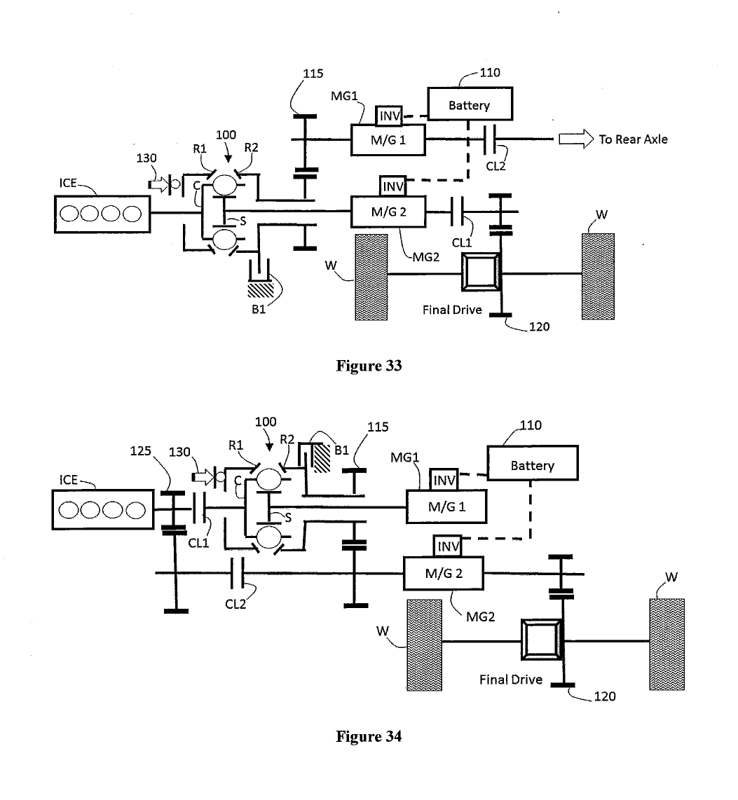

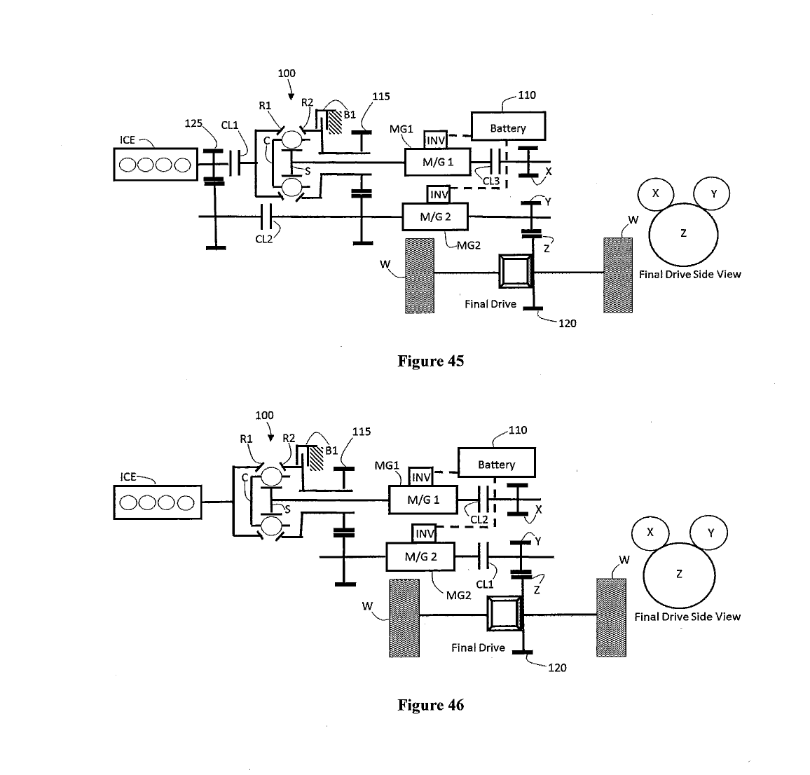

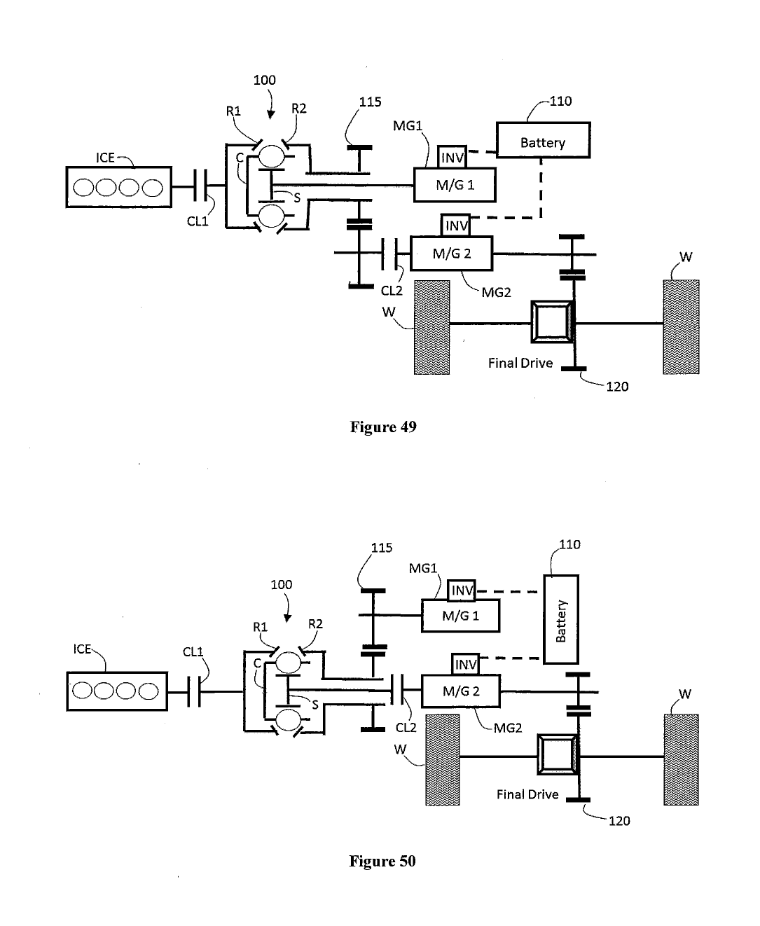

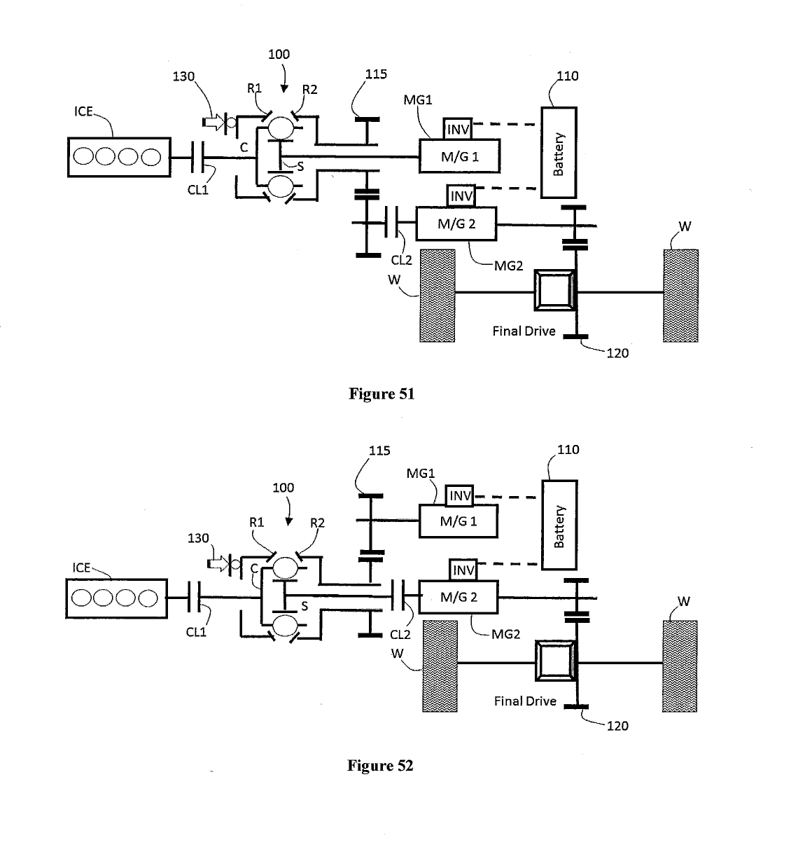

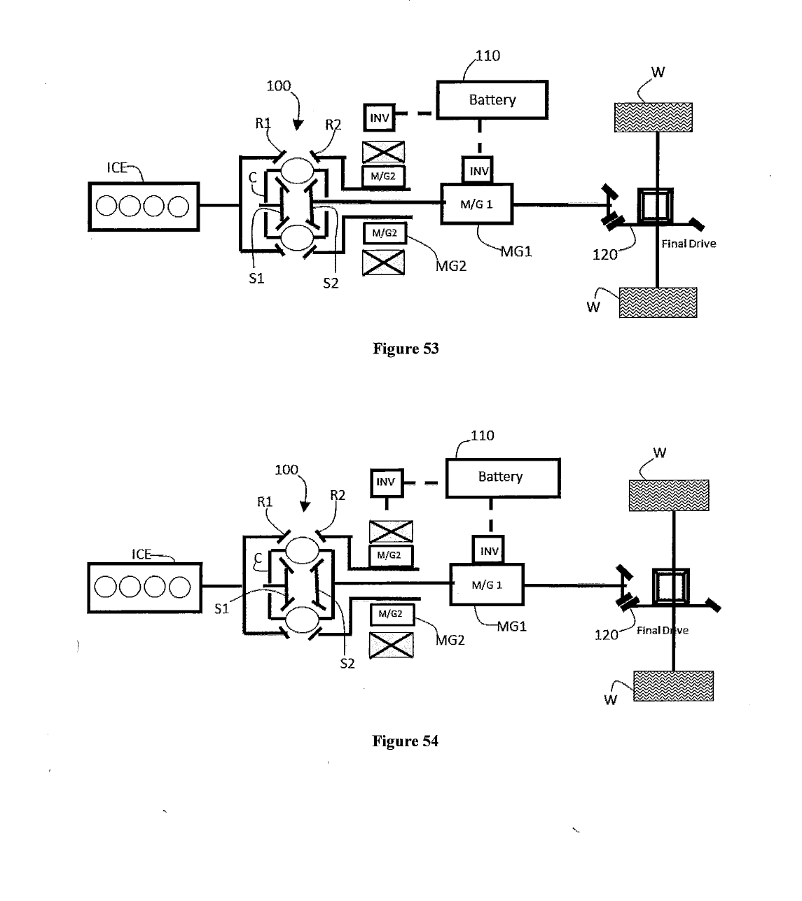

Passing now to FIGS. 17-54, in some embodiments, the hybrid powertrain 1100 is of the type disclosed in U.S. Patent Application 62/220,016 filed Sep. 17, 2015, which is hereby incorporated by reference, are described as optional configurations for the hybrid powertrain 1100.

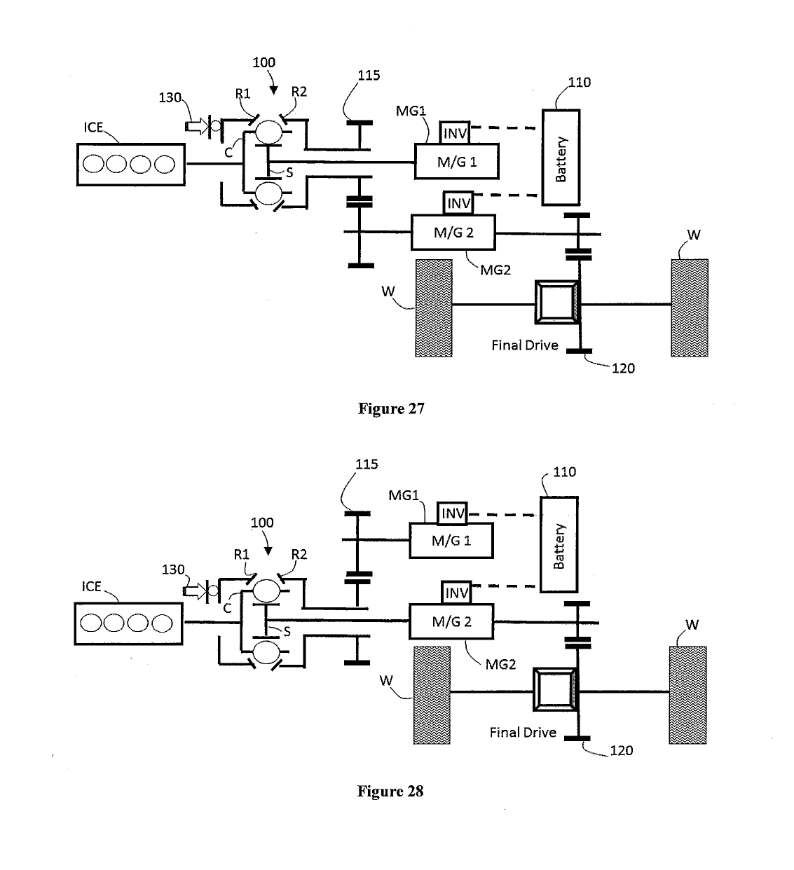

The resulting hybrid powertrain will therefore allow the engine and the electric machines to function in a more efficient operating island leading to the possibility of operating the powertrain in an optimized overall high efficiency mode and at the same time provides the functionality of an electrically variable transmission (EVT/e-CVT) by providing torque variability and a higher overall torque ratio band (ratio band of control system that controls the mode of operation of the HEV powertrain based on a state charge (SOC) of the high voltage battery pack 110. FIGS. 17-26 depict embodiments that are configured to use a variator node (C) as an input to a motor/generator (“MG1 or MG2”) with the sun (S) as a floating element serving as a blended node. FIGS. 27-36 depict embodiments configured to use the sun (S) node as an input to MG1 or MG2 with the first traction ring node (R1) floating as a blended node. The hybrid powertrains described herein include a variator or CVP 100 that is optionally configured as depicted in FIGS. 1-3. In some embodiments, a first transfer gear set 115 is provided to operably couple components of the hybrid powertrains disclosed herein. It should be noted that the first transfer gear set 115 is optionally configured as meshing gears, sprocket and chain couplings, belt and pulley couplings, or any typical mechanical coupling configured to transmit rotational power. Likewise, a second transfer gear set 125 is optionally configured to couple components of the powertrains disclosed herein. It should be appreciated that the first transfer gear 115 and the second transfer gear 125 are shown schematically as meshing gears having a fixed ratio, though one skilled in the art is capable of configuring any number of devices to operably couple the components of the hybrid powertrains disclosed herein. Powertrain configuration provided herein include a final drive gear set 120, sometimes referred to herein as “final drive gearing” or “final drive gear”. It should be appreciated that the final drive gear set 120 is configured to couple to wheels W of a vehicle equipped with the hybrid powertrains disclosed herein. In some embodiments, the final drive gear set 120 includes two or more meshing gears. In some embodiments, the final drive gear set 120 includes a first gear X, a second gear Y, and a third gear Z, each configured to operably couple to components of the powertrain.

Referring now to FIGS. 17, 27, and 37, in some embodiments, hybrid powertrain architectures are configured with a second motor/generator (“MG2” or “M/G 2”) as the primary traction motor and MG1 is the generator. The architecture can sometimes be referred to as series-parallel hybrid powertrain architecture. In some embodiments, the first transfer gear 115 is provided to operably couple the second traction ring R2 to the second motor/generator MG2. The second motor/generator MG2 is operably coupled to the final drive gear set 120.

Turning now to FIGS. 18, 28, and 38, in some embodiments, hybrid powertrain architectures are configured to operably couple the second motor/generator, MG2, to the carrier node (C) or to the sun (S) node, and the first motor/generator, MG1, is coupled to R2 via a step ratio such as the first transfer gear 115. It should be appreciated that a step ratio is depicted schematically herein as meshing gears having a fixed ratio, and is optionally configured with any typical form of mechanical coupling providing a step ratio between rotating components. In some embodiments, the second motor/generator MG2 is operably coupled to the final drive gear set 120.

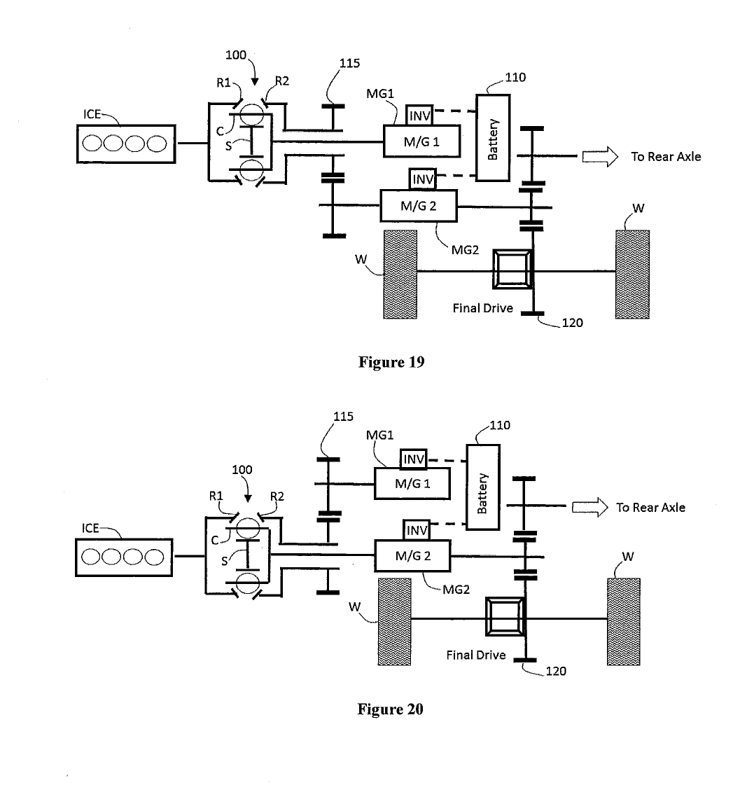

Referring now to FIGS. 19, 20, 29, 30, 39, and 40, in some embodiments, hybrid powertrain architectures can include a gear element configured to provide a four-wheel drive series parallel hybrid. For example, the final drive gear 120 includes meshing gears adapted to transmit rotational power to a front wheel axle and a rear wheel axle. In some embodiments, the first transfer gear set 115 is operably coupled to the second traction ring R2 and the second motor/generator MG2. In some embodiments, the second motor/generator MG2 is operably coupled to the final drive gear 120. In some embodiments, the first transfer gear set 115 is operably coupled to the second traction ring R2 and the first motor/generator MG1.

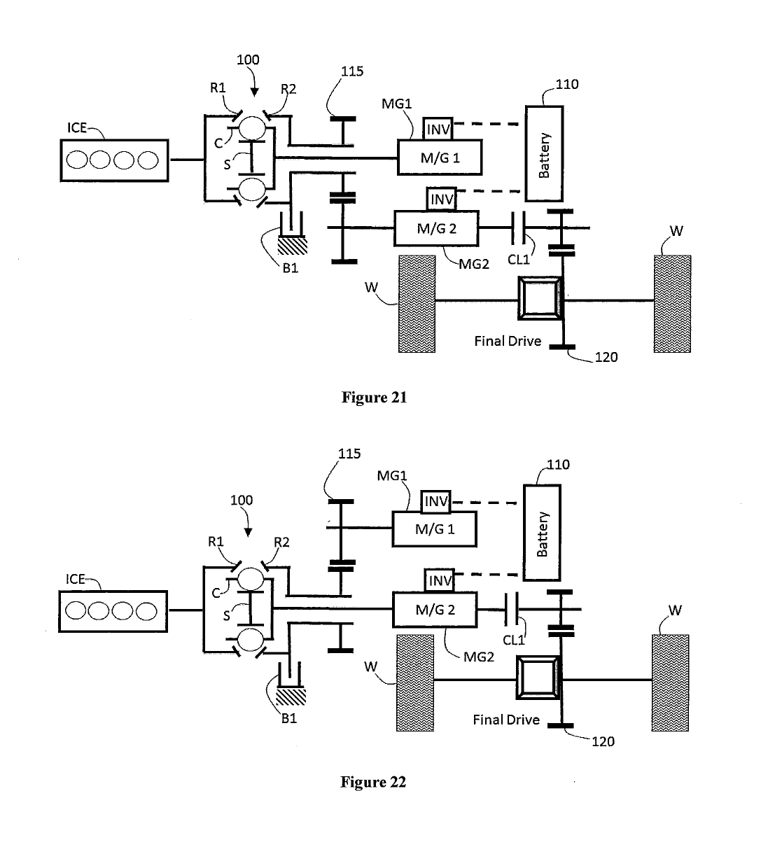

Passing now to FIGS. 21-26, 31-36, and 41-46, in some embodiments, hybrid powertrain architectures include at least one clutch element (referred to in figures with the label “CL1”, “CL2” or “CL3”) arranged before the final drive gear set 120 and adapted to disconnect the HEV powertrain to thereby provide a neutral and a brake condition. These architectures allow the first motor/generator MG1 or the second motor/generator MG2 to be used as an ICE starter motor. In some embodiments, the engine ICE is operably coupled to the first traction ring R1. The second traction ring R2 is operably coupled to the second motor/generator MG2. In some embodiments, the second traction ring R2 is operably coupled to the first motor/generator MG1. In some embodiments, the first transfer gear set 115 is configured to operably couple the second traction ring R2 to one of the first motor/generator MG1 or the second motor/generator MG2. In some embodiments, the first clutch CL1 is operably coupled to the final drive gear set 120 and configured to selectively couple to components of the hybrid powertrain. For example, the first clutch CL1 is operably coupled to the second motor/generator MG2 and the final drive gear set 120.

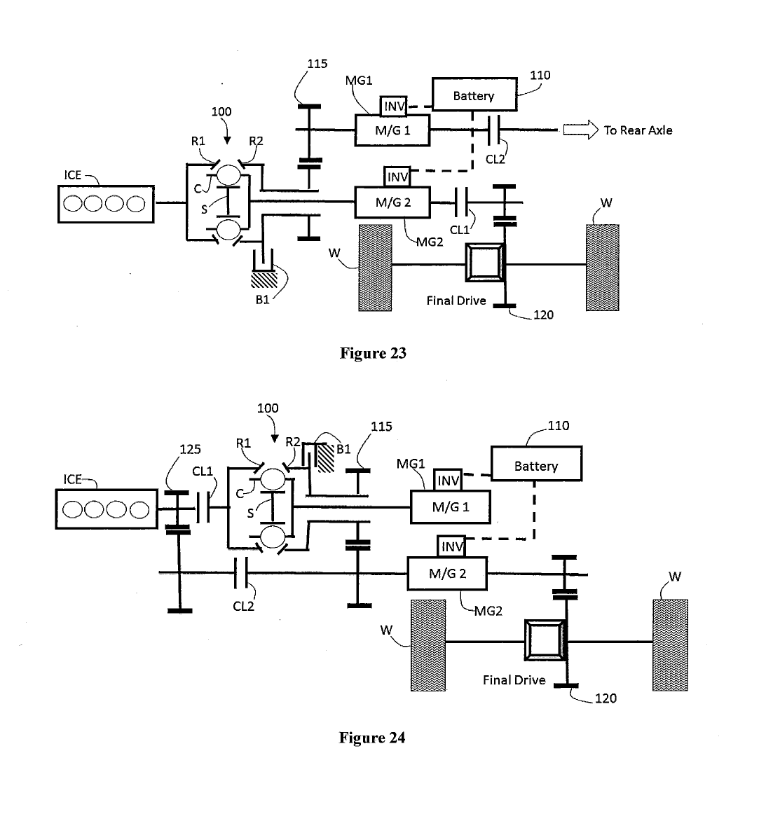

Referring now to FIGS. 23, 33, and 43, in some embodiments, hybrid powertrain architectures are configured with two clutches, the first clutch CL1 and the second clutch CL2, which, when engaged or disengaged gives rise to HEV modes beyond the series-parallel mode. For example, the modes are as follows:
a. The first clutch CL1 and the second clutch CL2 engaged corresponds to a parallel HEV mode with power flow paths via CVP 100 and both motor/generators.
b. The first clutch CL1 disengaged and the second clutch CL2 engaged corresponds to a pure series HEV mode.

Furthermore, having 2 clutches opens up the possibility of an all-wheel drive (“AWD”) configuration and neutral mode. In some embodiments, a brake B1 is operably coupled to the second traction ring R2. The second motor/generator MG2 is operably coupled to the carrier C. In some embodiments, the first transfer gear set 115 is operably coupled to the second traction ring R2 and the first motor/generator MG1.

Turning now to FIGS. 24, 34, and 44, in some embodiments, hybrid powertrain architectures are configured with a parallel torque path around the CVP 100 with a second clutch (labeled in the figures as “CL2”). In some embodiments, the brake B1 is operably coupled to the second traction ring R2. The first motor/generator MG1 is operably coupled to the carrier C. In some embodiments, the first transfer gear set 115 is operably coupled to the second traction ring R2 and the second motor/generator MG2. The second transfer gear set 125 is operably coupled to the engine ICE and the second clutch CL2. In some embodiments, the second motor/generator MG2 is operably coupled to the second clutch CL2.

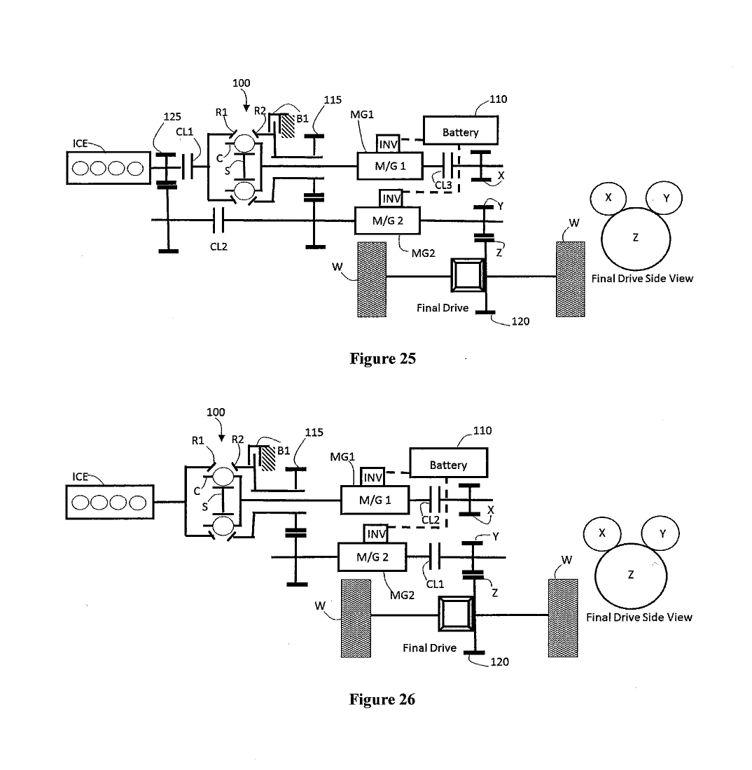

Referring now to FIGS. 25, 35, and 45, in some embodiments, hybrid powertrain architectures can include three clutches, the first clutch CL1, the second clutch CL2, and a third clutch CL3. In some embodiments, the second clutch CL2 is operably coupled to the second motor/generator MG2 and the engine ICE through the second transfer gear set 125. In some embodiments, the first clutch CL1 is arranged to selectively couple the engine ICE to the first traction ring R1. In some embodiments, the first transfer gear set 115 is operably coupled to the second traction ring R2 and the second motor/generator MG2. The hybrid powertrains depicted in FIGS. 14, 24, and 34 provide a flexible powertrain architecture with the following HEV/EV modes possible:
a. Parallel hybrid mode with one motor when state of charge (“SOC”) of battery system is high corresponds to the second clutch CL2 closed, the first clutch CL1 open, and the third clutch CL3 open.
b. Parallel hybrid mode with two motors when SOC is high corresponds to the second clutch CL2 closed, the first clutch CL1 open, and the third clutch CL3 closed.
c. Series-parallel hybrid mode corresponds to the third clutch CL3 open, the first clutch CL1 and the second clutch CL2 closed.
d. Single motor EV mode corresponds to the first clutch CL1, the second clutch CL2, and the third clutch CL3 open and the second motor/generator MG2 operating as a primary traction motor with no ICE operation.
e. Dual motor EV mode corresponds to the first clutch CL1 and the second clutch CL2 open, the third clutch CL3 closed, and the first motor/generator MG1 and the second motor/generator MG2 operating as traction motors with no ICE operation.
f. Series hybrid mode corresponds to the first clutch CL1 closed, the second clutch CL2 open, the third clutch CL3 open, the first motor/generator MG1 operating as a generator, and the second motor/generator MG2 operating as a traction motor.

Additionally, in FIGS. 14, 24 and 34, there is the option of bypassing the CVP 100 to reduce power losses by opening the first clutch CL1 and the third clutch CL3, while closing the second clutch CL2 to get parallel HEV mode after bypassing the CVP 100. In turn, a neutral mode for the vehicle could be achieved. The directional integrity from engine to wheel for forward motion is maintained by having the gear elements connected to the motor outputs also connected to the final drive element as shown in the figures. Reverse is pure electric vehicle (“EV”) mode with the first clutch CL1 and the second CL2 open and the third clutch CL3 closed.

Referring now to FIGS. 26, 36, and 46, in some embodiments, hybrid powertrain architectures are optionally configured that permit switching the motor that is connected to the final drive gear set 120. The directional integrity from engine to wheel for forward motion is maintained by having the gear elements connected to the motor outputs also connected to the final drive element as shown in the figures. In some embodiments, the first motor/generator MG1 is coupled to the carrier C. The second clutch CL2 is configured to selectively couple the first motor/generator MG1 to the first gear X of the final drive gear set 120. The second motor/generator MG2 is operably coupled to the second traction ring R2, for example, with the first transfer gear set 115. In some embodiments, the second clutch CL2 is configured to selectively couple the second motor/generator MG2 to the second gear Y of the final drive gear set 120.

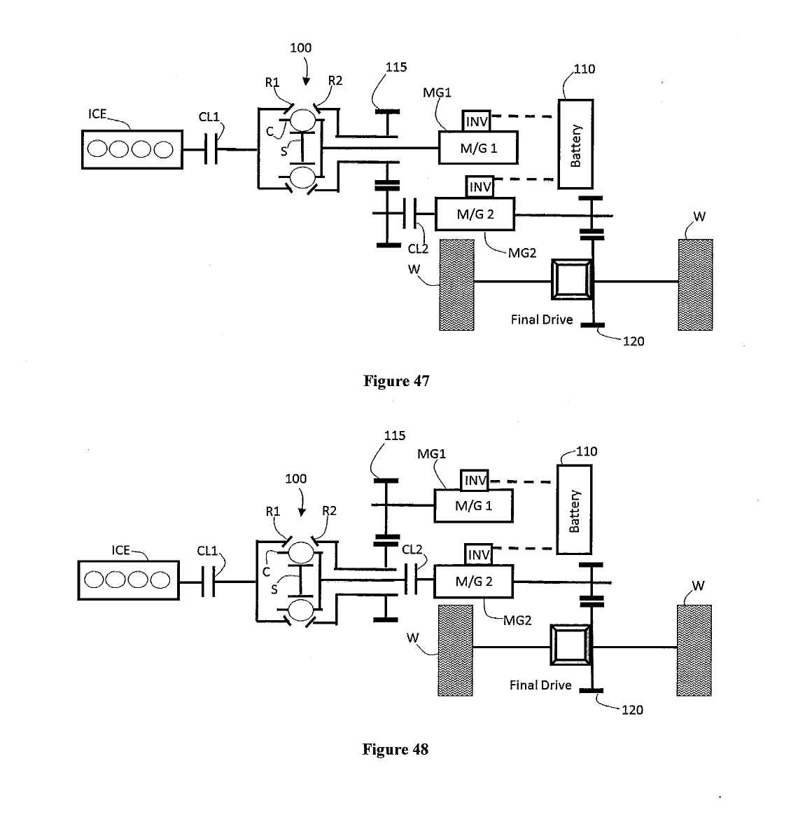

Referring now to FIGS. 47-52, in some embodiments, hybrid powertrain architectures are optionally configured with two clutches where disengaging the second clutch CL2 and engaging the first clutch CL1 provides starter motor capabilities without a braking element. The hybrid modes possible with this system are Single Motor EV, Dual Motor EV, Series HEV, Parallel HEV, and Series Parallel HEV.

As previously discussed, the CVP 100 is used as a splitting differential by connecting three of the four nodes to the ICE, the first motor/generator MG1, the second motor/generator MG2 nodes without grounding the fourth node. Because the first traction ring R1 and the second traction ring R2 are “mirror” functions of each other (for example R1 at overdrive behaves like R2 at underdrive), there are only six (not eight) configurations for a splitting differential that is not regenerative. Each powertrain configuration or architecture has its own specific torque split range for the first motor/generator MG1 versus the second motor/generator MG2, and the efficiency of the CVP 100 used as a splitting differential is different from one configuration to another. For example, the following configurations and torque ranges are configured:
a. The first traction ring R1 is connected to the engine ICE, the second traction ring R2 is connected to the first motor/generator MG1, the carrier C is connected to the second motor/generator MG2. In some embodiments, the first transfer gear set 115 coupled the first motor/generator MG1 to the second traction ring R2. In some embodiments, the torque on the first motor/generator MG1 is variable from 50% to 100% of engine torque.
b. The first traction ring R1 is connected to the ICE, the second traction ring R2 is connected to the second motor/generator MG2, the carrier C is connected to the first motor/generator MG1. In some embodiments, the first transfer gear set 115 coupled the second motor/generator MG2 to the second traction ring R2. In some embodiments, the torque on the first motor/generator MG1 is variable from 0% to 50% of the engine torque.
c. The first traction ring R1 is connected to the ICE, the second traction ring R2 is connected to the second motor/generator MG2, the sun S is connected to the first motor/generator MG1. In some embodiments, the first transfer gear set 115 coupled the second motor/generator MG2 to the second traction ring R2. In some embodiments, the torque on the first motor/generator MG1 is variable from about 67% to about 81% of the engine torque.
d. The first traction ring R1 is connected to the ICE, the second traction ring R2 is connected to the first motor/generator MG1, the sun S is connected to the second motor/generator MG2. In some embodiments, the first transfer gear set 115 coupled the first motor/generator MG1 to the second traction ring R2. In some embodiments, the torque on the first motor/generator MG1 is variable from 19% to 33% of the engine torque.
e. The carrier C is connected to the ICE, the second traction ring R2 is connected to the first motor/generator MG1, the sun S is connected to the second motor/generator MG2. In some embodiments, the first transfer gear set 115 coupled the first motor/generator MG1 to the second traction ring R2. In some embodiments, the torque on the first motor/generator MG1 is variable from 81% to 100% of the engine torque.
f. The carrier C is connected to the ICE, the second traction ring R2 is connected to the first motor/generator MG1, the sun S is connected to the first motor/generator MG1. In some embodiments, the first transfer gear set 115 coupled the first motor/generator MG1 to the second traction ring R2. In some embodiments, the torque on the first motor/generator MG1 is variable from 0%-19% of the engine torque.

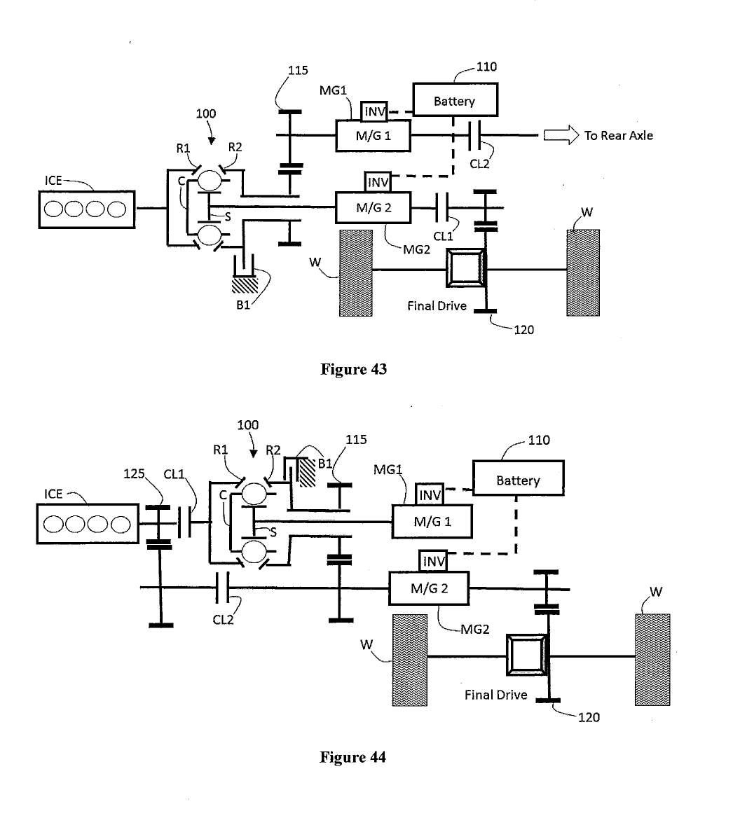

Referring now to FIGS. 53 and 54, in some embodiments, hybrid powertrain architectures are optionally configured to have a coaxial arrangement suitable for rear wheel drive vehicles. For example, the ICE is coaxial with the variator and the motor/generators. Referring to FIG. 53, the engine ICE is operably coupled to the first traction ring R1, the second motor/generator MG2 is operably coupled to the second traction ring R2, and the first motor/generator MG1 is operably coupled to the sun S (sometimes referred to as “node S” or “S”). In some embodiments, the sun assembly includes two sun elements depicted in FIGS. 42 and 43 as “S1” and “S2”. It should be appreciated that “S1” and “S2” are collectively referred to as the sun node “S”. Referring to FIG. 54, the ICE is operably coupled to the first traction ring R1, the second motor/generator MG2 is operably coupled to the second traction R2, and the first motor/generator MG1 is operably coupled to the carrier assembly C (sometimes referred to as “node C” or “C”). The first motor/generator MG1 is operably coupled to the drive wheels of a vehicle through the final drive gear set 120.

For some embodiments having the ICE connected to the carrier C, a ball-ramp actuator 130 load is depicted. For CVP designs that use two ball-ramp clamping force generators, one of which is loaded, the load is transmitted to the other via the CVP ball. In some of the embodiments described herein, the ball-ramp actuator 130 is not necessary. The ball-ramp actuator 130 covers the case when there is a single ball-ramp clamping force generator or if there is insufficient load on the second ball-ramp.

Provided herein is a powertrain having one motor/generator MG1; a source of rotational power ICE; a continuously variable planetary transmission (CVP) 100 having a plurality of balls, each ball provided with a tiltable axis of rotation, each ball in contact with a first traction ring R1 and a second traction ring R2, each ball in contact with a sun S, the sun S located radially inward of each ball, and each ball operably coupled to a carrier C, the carrier C operably coupled to a shift actuator; wherein the source of rotational power ICE is operably coupled to the first traction ring R1; wherein the sun S is adapted to rotate freely; and wherein the first motor/generator MG1 is operably coupled to the second traction ring R2. In some embodiments of the powertrain, the carrier C is operably coupled to a second motor/generator MG2. In some embodiments of the powertrain, a brake B1 is operably coupled to the second traction ring R2. In some embodiments of the powertrain, a first clutch CL1 is operably coupled to the second motor/generator MG2. In some embodiments of the powertrain, a first clutch CL1 is operably coupled to the second motor/generator MG2, and a second clutch CL2 is operably coupled to the first motor/generator MG1. In some embodiments of the powertrain, a first clutch CL1 is operably coupled to the first traction ring R2, a second clutch CL2 is operably coupled to the second motor/generator MG2, and a third clutch CL3 is operably coupled to the first motor/generator MG1. In some embodiments of the powertrain, a ball-ramp actuator 130 is operably coupled to the first traction ring R1. In some embodiments of the powertrain, a powertrain supervisory controller is provided, said controller capable of supplying control signals to all components of the powertrain such that the said controller is capable of dynamically affecting a plurality of operating modes.

Provided herein is a powertrain including: a first motor/generator MG1; a second motor/generator MG2; a source of rotational power ICE; a continuously variable planetary transmission (CVP) 100 having a plurality of balls, each ball provided with a tiltable axis of rotation, each ball in contact with a first traction ring R1 and a second traction ring R2, each ball in contact with a sun S, the sun S located radially inward of each ball, and each balls operably coupled to a carrier C, the carrier C operably coupled to a shift actuator; wherein the source of rotational power ICE is operably coupled to the carrier C; wherein the first traction ring R1 is adapted to rotate freely; and wherein the first motor/generator MG1 is operably coupled to the second traction ring R2. In some embodiments of the powertrain, the sun S is operably coupled to the second motor/generator MG2. In some embodiments of the powertrain, a brake B1 is operably coupled to the second traction ring R2. In some embodiments of the powertrain, a first clutch CL1 is operably coupled to the second motor/generator MG2. In some embodiments of the powertrain, a first clutch CL1 is operably coupled to the second motor/generator MG2, and a second clutch CL2 operably coupled to the first motor/generator MG1. In some embodiments of the powertrain, a first clutch CL1 is operably coupled to the first traction ring R1, a second clutch CL2 is operably coupled to the second motor/generator MG2, and a third clutch CL3 operably coupled to the first motor/generator MG1. In some embodiments of the powertrain, a ball-ramp actuator 130 is operably coupled to the first traction ring R1. In some embodiments of the powertrain, a first clutch CL1 is operably coupled to the first traction ring R1, a second clutch CL2 is operably coupled to the second motor/generator MG1, and a third clutch CL3 is operably coupled to the first motor/generator MG1. In some embodiments of the powertrain, a ball-ramp actuator 130 is operably coupled to the first traction ring R1. In some embodiments of the powertrain, a powertrain supervisory controller is provided, said controller capable of supplying control signals to all components of the powertrain such that the said controller is capable of dynamically affecting a plurality of operating modes.

Provided herein is a powertrain including: a first motor/generator MG1; a second motor/generator MG2; a source of rotational power ICE; a continuously variable planetary transmission (CVP) 100 having a plurality of balls, each ball provided with a tiltable axis of rotations, each ball in contact with a first traction ring R1 and a second traction ring R2, each ball in contact with a sun S, the sun S located radially inward of each ball, and each balls operably coupled to a carrier C, the carrier C is operably coupled to a shift actuator; wherein the source of rotational power ICE is operably coupled to the first traction ring R1; wherein the carrier C is adapted to rotate freely; and wherein the first motor/generator MG1 is operably coupled to the sun S. In some embodiments of the powertrain, the second traction ring R2 is operably coupled to the second motor/generator MG2. In some embodiments of the powertrain, a brake B1 operably is coupled to the second traction ring R2. In some embodiments of the powertrain, a first clutch CL1 is operably coupled to the second motor/generator MG2. In some embodiments of the powertrain, a first clutch CL1 is operably coupled to the second motor/generator MG2, and a second clutch CL2 operably coupled to the first motor/generator MG1. In some embodiments of the powertrain, a first clutch CL1 is operably coupled to the first traction ring R1, a second clutch CL2 operably coupled to the second motor/generator MG2, and a third clutch CL3 operably coupled to the first motor/generator MG1. In some embodiments of the powertrain, a ball-ramp actuator 130 is operably coupled to the first traction ring R1. In some embodiments of the powertrain, a powertrain supervisory controller is provided, said controller capable of supplying control signals to all components of the powertrain such that the said controller is capable of dynamically affecting a plurality of operating modes.

Provided herein is a powertrain including: at least one hydro-mechanical component; a source of rotational power ICE; a continuously variable planetary transmission (CVP) 100 having a plurality of balls, each ball provided with a tiltable axis of rotation, each ball in contact with a first traction ring R1 and a second traction ring R2, each ball in contact with a sun S, the sun S located radially inward of each ball, and each ball operably coupled to a carrier C, the carrier C is operably coupled to a shift actuator; wherein the source of rotational power ICE is operably coupled to the first traction ring R1; wherein the sun S is adapted to rotate freely; and wherein the hydro-mechanical component is operably coupled to the second traction ring R2. In some embodiments of the powertrain, the carrier C is operably coupled to a second hydro-mechanical component. In some embodiments of the powertrain, a brake B1 is operably coupled to the second traction ring R2. In some embodiments of the powertrain, a first clutch CL1 is operably coupled to the second hydro-mechanical component. In some embodiments of the powertrain, a first clutch CL1 is operably coupled to the second hydro-mechanical component, and a second clutch CL2 operably coupled to the hydro-mechanical component. In some embodiments of the powertrain, a first clutch CL1 operably is coupled to the first traction ring R1, a second clutch CL2 is operably coupled to the second hydro-mechanical component, and a third clutch CL3 operably coupled to the first hydro-mechanical component. In some embodiments of the powertrain, a ball-ramp actuator 130 is operably coupled to the first traction ring R1. In some embodiments of the powertrain, a powertrain supervisory controller is provided, said controller capable of supplying control signals to all components of the powertrain such that the said controller is capable of dynamically affecting a plurality of operating modes.

Provided herein is a powertrain including: a first motor/generator MG1; a second motor/generator MG2; a source of rotational power ICE; a continuously variable planetary transmission (CVP) 100 having a plurality of balls, each ball provided with a tiltable axis of rotation, each ball in contact with a first traction ring R1 and a second traction ring R2, each ball in contact with a sun S, the sun S located radially inward of each ball, and each ball operably coupled to a carrier C, the carrier C operably coupled to a shift actuator; wherein the source of rotational power ICE is operably coupled to the first traction ring R1; wherein the carrier C is adapted to rotate freely; wherein the first motor/generator MG1 is operably coupled to the sun S; and wherein the second motor/generator MG2 is operably coupled to the second traction ring R2; and wherein the CVP 100, the first motor/generator MG1, the second motor/generator MG2, and the source of rotational power ICE are coaxial.

Provided herein is a powertrain including: a first motor/generator MG1; a second motor/generator MG2; a source of rotational power ICE; a continuously variable planetary transmission (CVP) 100 having a plurality of balls, each ball provided with a tiltable axis of rotation, each ball in contact with a first traction ring R1 and a second traction ring R2, each ball in contact with a sun S, the sun S located radially inward of each ball, and each ball operably coupled to a carrier C, the carrier C is operably coupled to a shift actuator; wherein the source of rotational power ICE is operably coupled to the first traction ring R1; wherein the carrier C is adapted to rotate; wherein the first motor/generator MG1 is operably coupled to the carrier C; and wherein the second motor/generator MG2 is operably coupled to the second traction ring R2; and wherein the CVP 100, the first motor/generator MG1, the second motor/generator MG2, and the source of rotational power ICE are coaxial.

It should be noted that where an ICE is described, the ICE is an internal combustion engine (diesel, gasoline, hydrogen) or any powerplant such as a fuel cell system, or any hydraulic/pneumatic powerplant like an air-hybrid system. Along the same lines, the battery 110 is not just a high voltage pack such as lithium ion or lead-acid batteries, but also ultracapacitors or other pneumatic/hydraulic systems such as accumulators, or other forms of energy storage systems. MG1 and MG2 can represent hydromotors actuated by variable displacement pumps, electric machines, or any other form of rotary power such as pneumatic motors driven by pneumatic pumps. The eCVT architectures depicted in the figures and described in text is extended to create a hydro-mechanical CVT architectures as well for hydraulic hybrid systems. It should be appreciated that the hybrid architectures disclosed herein could also include additional clutches, brakes, and couplings to three nodes of the CVP 100.

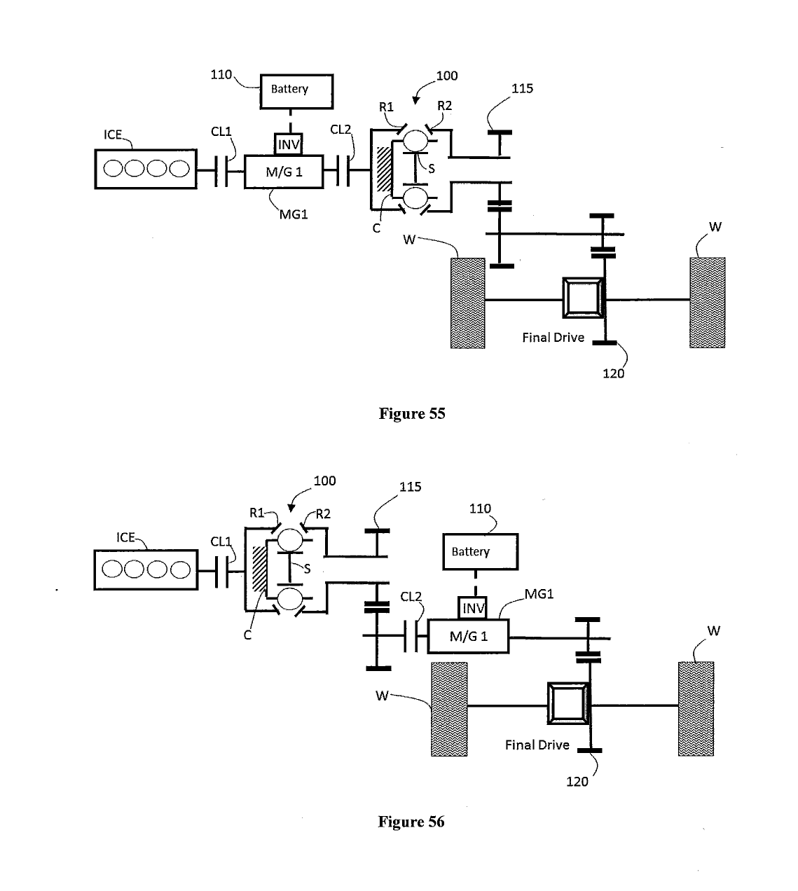

Passing now to FIGS. 55-79, embodiments of hybrid powertrains disclosed in U.S. Patent Application No. 62/220,019 filed Sep. 17, 2015 and U.S. Patent Application No. 62/247,670 filed Oct. 28, 2015 are described as optional configurations for the hybrid powertrain 1100.

Embodiments disclosed herein are directed to hybrid vehicle architectures and/or configurations that incorporate a CVP in place of a regular fixed ratio planetary leading to a continuously variable parallel hybrid. It should be appreciated that the embodiments disclosed herein are adapted to provide hybrid modes of operation that include, but are not limited to series, parallel, series-parallel, or EV (electric vehicle) modes. The core element of the power flow is a CVP, such as the continuously variable transmission described in FIGS. 1-3, which functions as a continuously variable transmission having four of nodes (R1, R2, C, and S), wherein the carrier (C) is grounded, the rings (R1 and R2) are available for output power, and the sun or sun gear (S) providing a variable ratio, and, in some embodiments, an auxiliary drive system. The CVP enables the engine (ICE) and electric machines (motor/generators, among others) to run at an optimized overall efficiency. It should be noted that hydro-mechanical components such as hydromotors, pumps, accumulators, among others, are capable of being used in place of the electric machines indicated in the figures and accompanying textual description. Furthermore, it should be noted that embodiments of hybrid architectures disclosed herein incorporate a hybrid supervisory controller that chooses the path of highest efficiency from engine to wheel. Embodiments disclosed herein enable hybrid powertrains that are capable of operating at the best potential overall efficiency point in any mode and also provide torque variability, thereby leading to the optimal combination of powertrain performance and fuel efficiency. It should be understood that hybrid vehicles incorporating embodiments of the hybrid architectures disclosed herein are capable of including a number of other powertrain components, such as, but not limited to, high-voltage battery pack with a battery management system or ultracapacitor, on-board charger, DC-DC converters, or DC-AC inverters, a variety of sensors, actuators, and controllers, among others. For description purposes, a battery 110 referred to herein and depicted or implied in FIGS. 4-31, is an illustrative example of a battery storage device.

FIGS. 55 and 56 depict embodiments of hybrid vehicle architectures that include an internal combustion engine (referred to in text and labeled in figures as “ICE”) coupled by a first clutch (referred to in text and labeled in figures as “CL1”) to a first motor/generator (referred to in text and labeled in figures as “MG1” or “M/G 1”). The first motor/generator MG1 is coupled by a second clutch (referred to in text and labeled in figures as “CL2”) to a variator 100 (sometimes referred to in text and labeled in figures as “CVP 100”). The CVP 100 is optionally configured as depicted and described in reference to FIGS. 1-3. The architectures depicted in FIGS. 55 and 56 are sometimes referred to as parallel hybrid systems. An Inverter (INV), an apparatus that converts direct current into alternating current; is operationally coupled to and a component of each motor/generator. Referring specifically to FIG. 55, the second clutch, CL2, is configured to selectively couple to the first traction ring, R1, of the CVP 100. The carrier node, C, of the CVP 100 is a grounded member. Power is transmitted out of the CVP 100 on the second traction ring, R2. In some embodiments, a first transfer gear set 115 is provided to operably couple the second traction ring R2 to a final drive gear set 120. It should be appreciated that the final drive gear set 120 is configured to couple to wheels W of a vehicle equipped with the hybrid powertrains disclosed herein. It should be noted that the first transfer gear set 115 is optionally configured as meshing gears, sprocket and chain couplings, belt and pulley couplings, or any typical mechanical coupling configured to transmit rotational power.

Referring specifically to FIG. 56, the first clutch, CL1, is arranged to selectively couple the ICE to the first traction ring R1 of the CVP 100. The carrier node C of the CVP 100 is a grounded member. Power is transmitted out the CVP 100 on the second traction ring R2. The second clutch CL2 is arranged to selectively couple the first motor/generator MG1 to receive a power input. In some embodiments, the first transfer gear set 115 is configured to couple the second traction ring R2 to a second clutch CL2. The first motor generator MG1 is coupled to the final drive gear set 120.

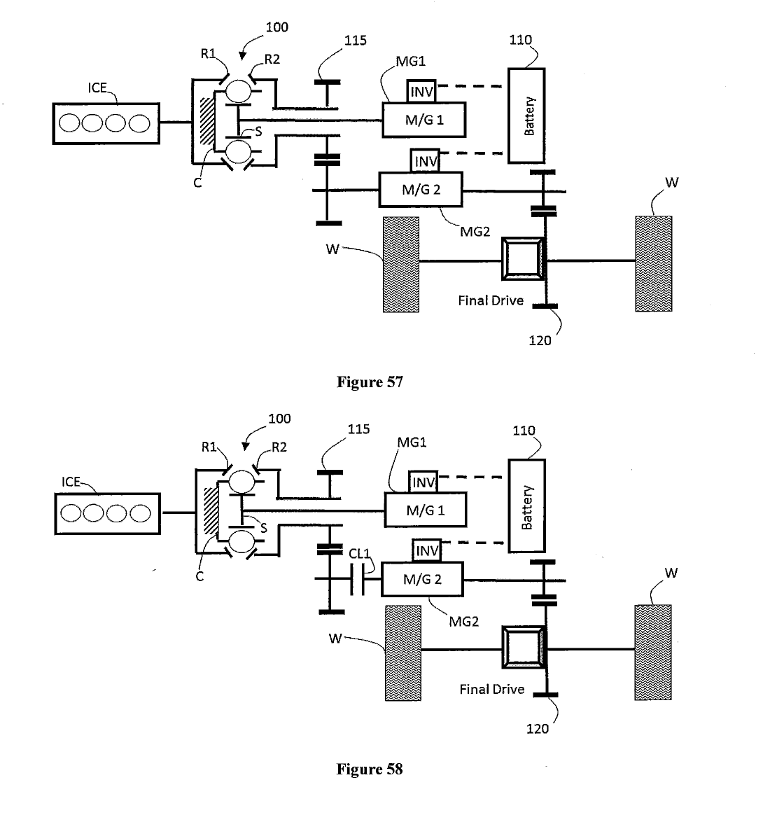

Turning to FIGS. 57-71, some hybrid vehicle architectures embodiments are configured with the first motor generator MG1 and a second motor/generator MG2, (referred to in text and labeled in figures as “MG2” or “M/G 2”) arranged in systems sometimes referred to as series parallel hybrid systems. These systems are capable of running charge-sustain modes and generally offer more capabilities than the parallel hybrid systems.

Referring again to FIG. 57, the ICE is operably coupled to first traction ring R1. The carrier node C is a grounding member. The first motor/generator MG1 is operably coupled to sun S. The second motor/generator MG2 is operably coupled to the second traction ring R2 with the first transfer gear set 115. The second motor/generator MG2 is operably coupled to the final drive gear set 120.

Referring now to FIG. 58, in some embodiments, the ICE is operably coupled to the first traction ring R1. The carrier node C is a grounded member. The first motor/generator MG1 is operably coupled to the sun S. The first clutch CL1 is arranged to selectively couple the second motor/generator MG2 to the second traction ring R2 with the first transfer gear set 115. In some embodiments, the second motor/generator MG2 is operably coupled to the final drive gear set 120.

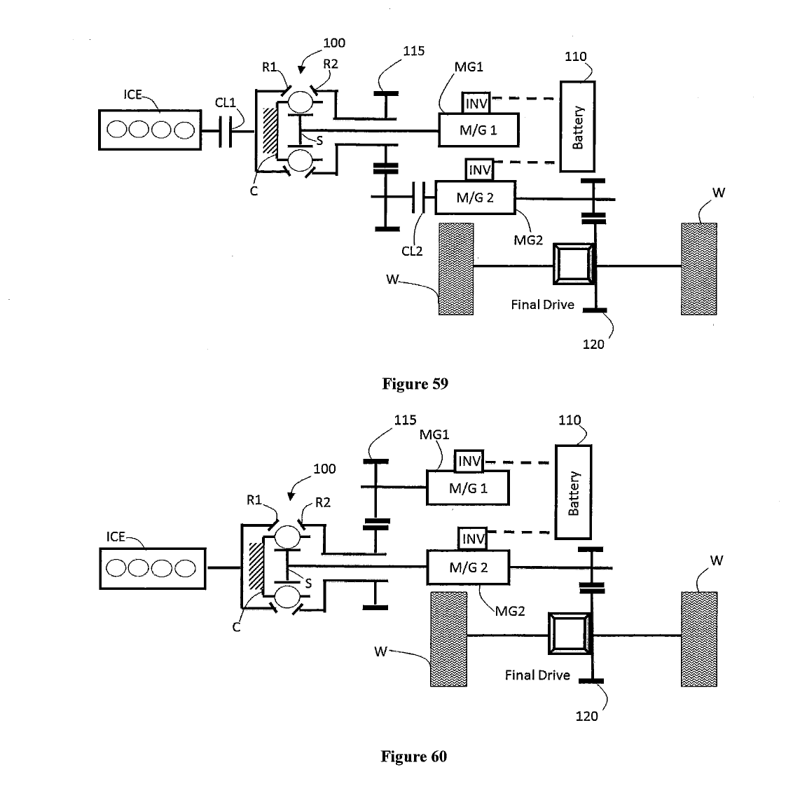

Referring now to FIG. 59, in some embodiments the first clutch CL1 is arranged to selectively couple the ICE to the first traction ring R1. The carrier node C is a grounded member. The first motor/generator MG1 is operably coupled to the sun S. The second clutch CL2 is arranged to selectively couple the second motor/generator MG2 to the second traction ring R2. In some embodiments, the first transfer gear set 115 operably coupled the second traction ring R2 to the second clutch CL2. In some embodiments, the second motor/generator MG2 is operably coupled to the final drive gear set 120.

Referring now to FIG. 60, in some embodiments the ICE is operably coupled to the first traction ring R1. The carrier node C is a grounded member. The first motor/generator MG1 is operably coupled to the second traction ring R2. The second motor/generator MG2 is operably coupled to the sun S. In some embodiments, the first transfer gear set 115 operably couples the second traction ring R2 to the first motor/generator MG1. In some embodiments, the second motor/generator MG2 is operably coupled to the final drive gear set 120.

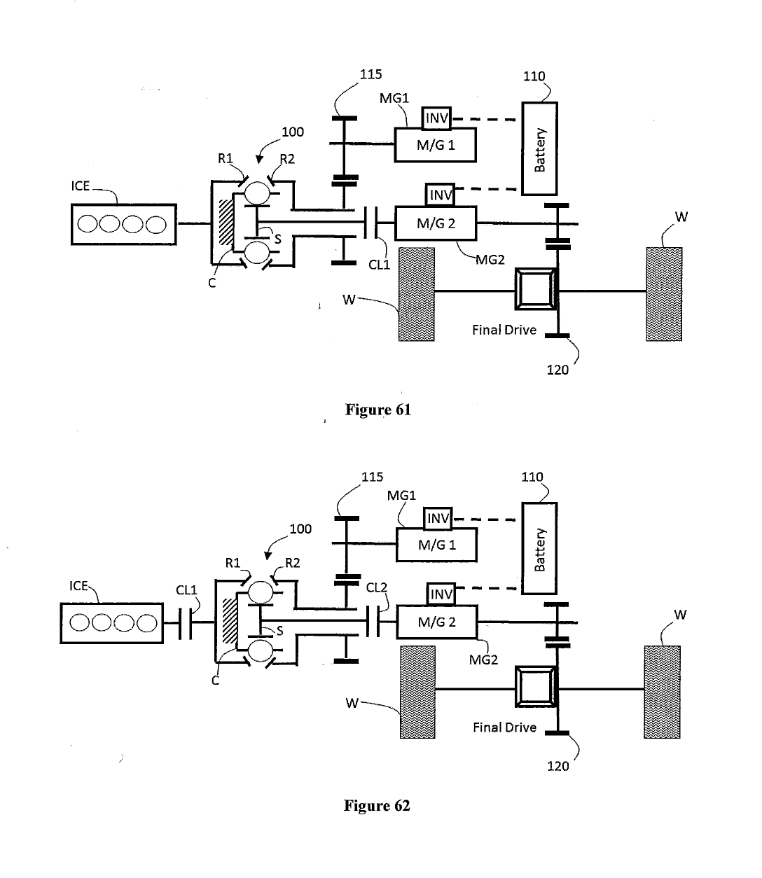

Referring now to FIG. 61, in some embodiments the ICE is operably coupled to first traction ring R1. The carrier node C is a grounded member. The first clutch CL1 is arranged to selectively couple the second motor/generator MG2 to the sun S. The first motor/generator MG1 is operably coupled to the second traction ring R2. In some embodiments, the first transfer gear set 115 is operably coupled to the second traction ring R2 and the first motor/generator MG1. In some embodiments, the second motor/generator MG2 is operably coupled to the final drive gear set 120.

Referring now to FIG. 62, in some embodiments the first clutch CL1 is arranged to selectively couple the ICE to the first traction ring R1. The carrier node C is a grounded member. The second clutch CL2 is arranged to selectively couple the second motor/generator MG2 to the sun S. The first motor/generator MG1 is operably coupled to the second traction ring R2. In some embodiments, the first transfer gear set 115 is operably coupled to the second traction ring R2 and the first motor/generator MG1. In some embodiments, the second motor/generator MG2 is operably coupled to the final drive gear set 120.

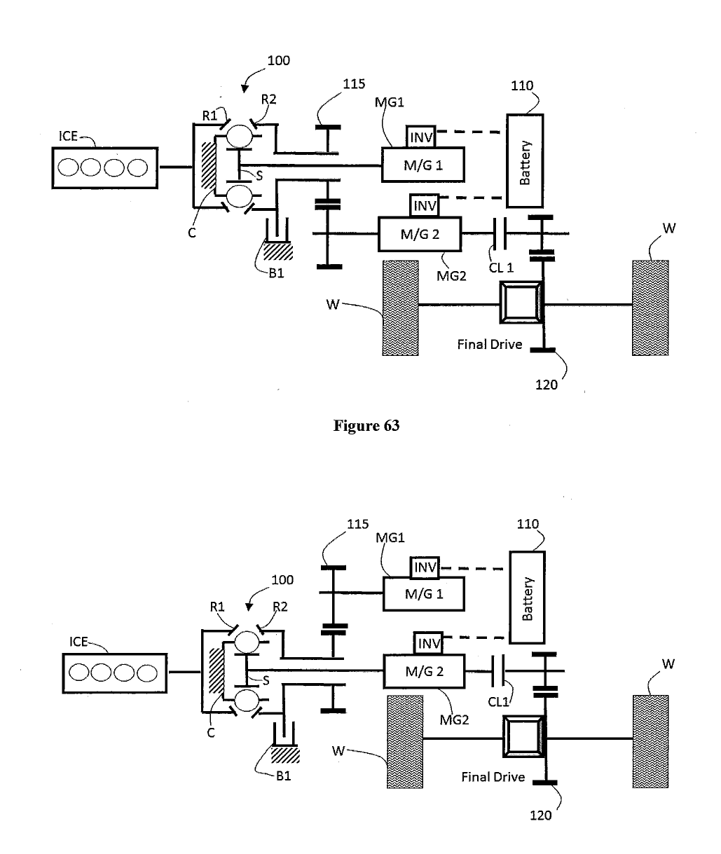

Referring now to FIG. 63, in some embodiments, the ICE is operably coupled to the first traction ring R1. The carrier node C is a grounded member. A brake (referred to in text and labeled in figures as “B1”) is operably coupled to the second traction ring R2. The second motor/generator MG2 is operably coupled to the second traction ring R2. In some embodiments, the first transfer gear set 115 is operably coupled to the second traction ring R2 and the first motor/generator MG1. The first motor/generator MG1 is operably coupled to the sun S. The first clutch CL1 are capable of being arranged to selectively couple the second motor/generator MG2 to the final drive gear set 120.

Referring now to FIG. 64, in some embodiments, the ICE is operably coupled to the first traction ring R1. The brake B1 is operably coupled to the second traction ring R2. The first motor/generator MG1 is operably coupled to the second traction ring R2. The second motor/generator MG2 is operably coupled to the sun S. The first clutch CL1 is arranged to selectively couple to the second motor/generator MG2 to the final drive. In some embodiments, the first transfer gear set 115 is operably coupled to the second traction ring R2 and the first motor/generator MG1. In some embodiments, the second motor/generator MG2 is operably coupled by the first clutch CL1 to the final drive gear set 120.

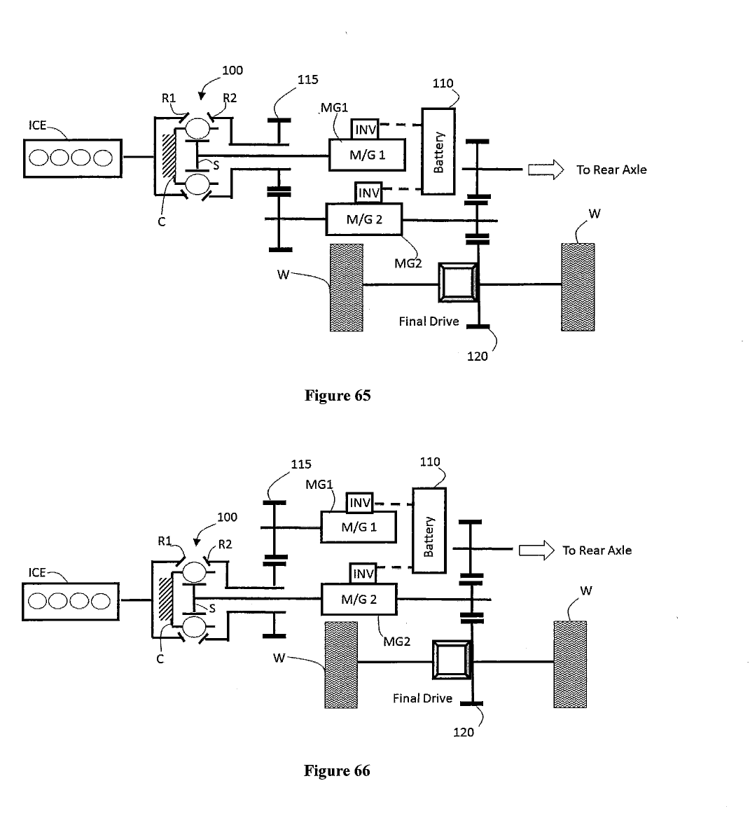

Referring now to FIG. 65, in some embodiments ICE is operably coupled to the first traction R1. The carrier node C is grounded. The first motor/generator MG1 is operably coupled to the sun S. The second motor/generator MG2 is coupled to the second traction ring R2. In some embodiments, the first transfer gear set 115 is operably coupled to the second traction ring R2 and the second motor/generator MG2. In some embodiments, the second motor/generator MG2 is operably coupled to the final drive gear set 120.

Referring now to FIG. 66, in some embodiments, the ICE is operably coupled to first traction R1. The carrier node C is a grounded member. The second motor/generator MG2 is operably coupled to the sun S. The first motor/generator MG1 is operably coupled to the second traction ring R2. The second motor/generator MG2 is operably coupled to a rear axle drive and a front axle drive. For example, the final drive gear 120 includes meshing gears adapted to transmit rotational power to a front wheel axle and a rear wheel axle. In some embodiments, the first transfer gear set 115 is operably coupled to the second traction ring R2 and the first motor/generator MG1. In some embodiments, the second motor/generator MG2 is operably coupled by the first clutch CL1 to the final drive gear set 120.

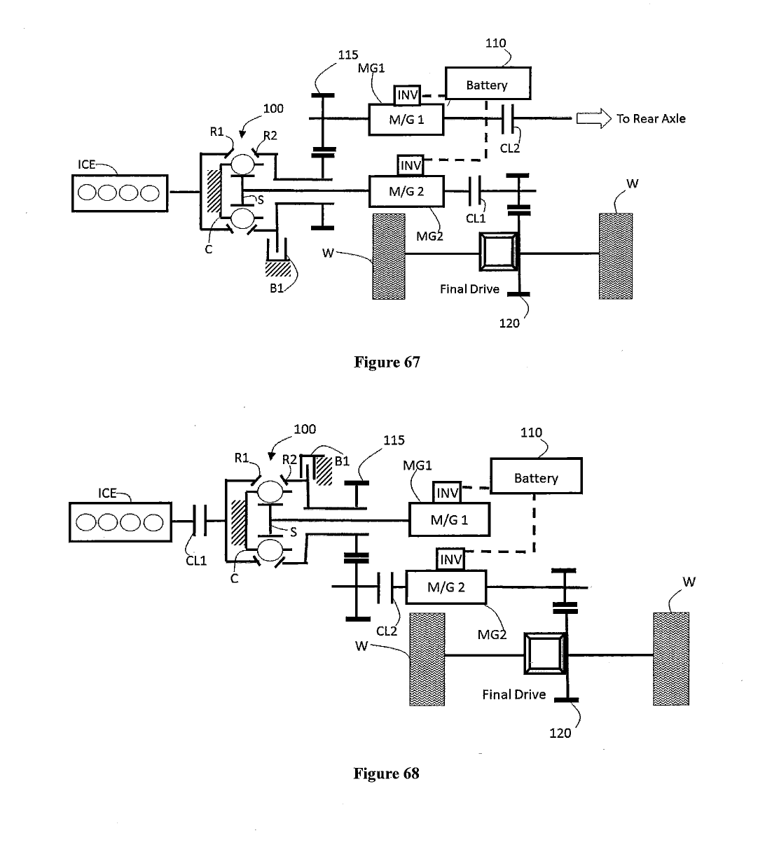

Referring now to FIG. 67, in some embodiments, the ICE is operably coupled to the first traction ring R1. The carrier node C is a grounded member. The brake B1 is operably coupled to the second traction ring R2. The first motor/generator MG1 is operably coupled to the first traction ring R1. The second motor/generator MG2 is operably coupled to the sun S. The first clutch CL1 is arranged to selectively couple the second motor/generator MG2 to the final drive gear set 120, for example, the front wheel drive. The second clutch CL2 is arranged to selectively couple the first motor/generator MG1 to the rear drive. In some embodiments, the first transfer gear set 115 operably coupled the second traction ring R2 to the first motor/generator MG1.

Referring now FIG. 68, in some embodiments, the ICE is selectively coupled using the first clutch CL1 to the first traction ring R1. The carrier node C is a grounded member. The brake B1 is operably coupled to the second traction ring R2. The first motor/generator MG1 is operably coupled to the sun S. The second clutch CL2 is arranged to selectively couple the second motor/generator MG2 to the second traction ring R2. In some embodiments, the first transfer gear set 115 is operably coupled to the second traction ring R2 and the second clutch CL2. The second motor/generator MG2 is operably coupled to the final drive gear set 120.

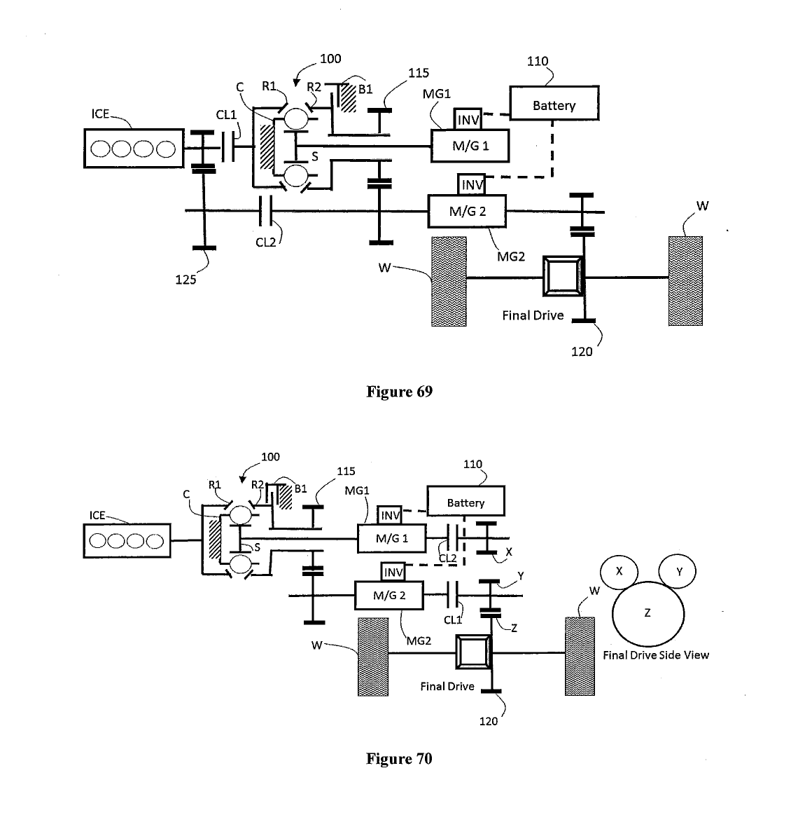

Referring now to FIG. 69, in some embodiments, the ICE is selectively coupled using the first clutch CL1 to the first traction ring R1. The ICE is selectively coupled using the second clutch CL2 to the second motor/generator MG2. The first motor/generator MG1 is operably coupled to the sun S. The brake B1 is operably coupled to the second traction ring R2. The second motor/generator MG2 is operably coupled to the second traction ring R2. The carrier node C is a grounded member. In some embodiments, the first transfer gear set 115 is operably coupled to the second traction ring R2 and the second motor/generator MG2. In some embodiments, the second motor/generator MG2 is operably coupled to the final drive gear set 120. In some embodiments, a second transfer gear set 125 is operably coupled to the engine ICE and the second clutch CL2.

Referring now to FIG. 70, in some embodiments, the ICE is operably coupled to the first traction ring R1. The carrier node C is a grounded member. The brake B1 is operably coupled to the second traction ring R2. The second motor/generator MG2 is operably coupled to the second traction ring R2. The first motor/generator MG1 is operably coupled to the sun S. The first clutch CL1 is capable of being arranged to selectively couple the second motor/generator MG2 to the final drive gear set. In some embodiments, the final drive gear set 120 includes a first gear (referred to in text and labeled in figures as “Y”), a second gear (referred to in text and labeled in figures as “X”), and a third gear ((referred to in text and labeled in figures as “Z”). The third gear Z is capable of being operably coupled to the wheels W. The second clutch CL2 is capable of being arranged to selectively couple the first motor/generator MG1 to a second gear The second gear X is capable of being operably coupled to the final drive.

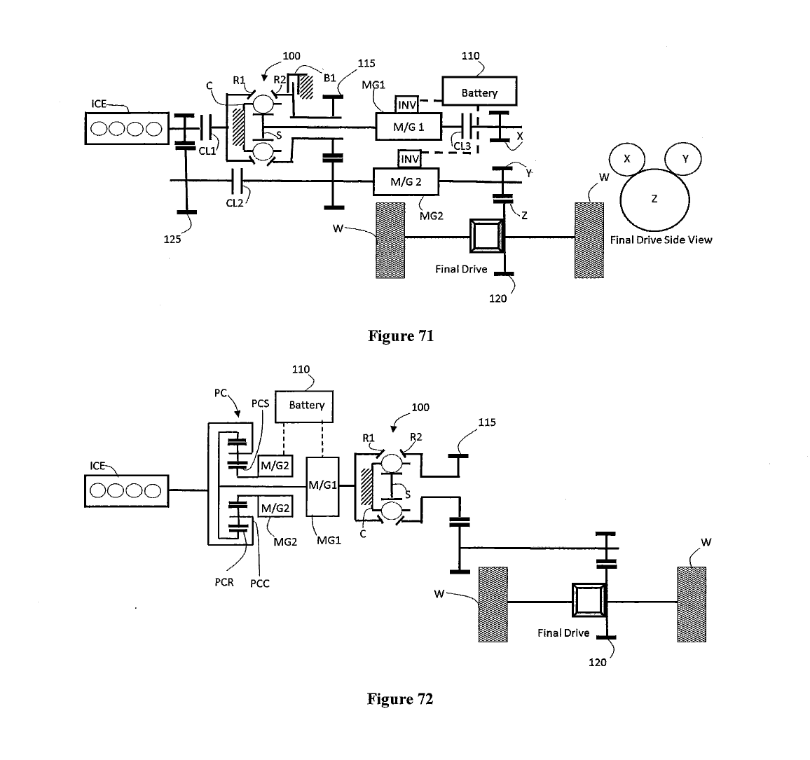

Referring now to FIG. 71, in some embodiments, the ICE is capable of being selectively coupled using the first clutch CL1 to the first traction ring R1. The ICE is capable of being selectively coupled using the second clutch CL2 to the second motor/generator MG2. The carrier node C is a grounded member. The brake B1 is operably coupled to the second traction ring R2. The second motor/generator MG2 is operably coupled to the second traction ring R2. In some embodiments, the first transfer gear set 115 is operably coupled to the second traction ring R2 and the second motor/generator MG2. The first motor/generator MG1 is operably coupled to the sun S. A third clutch (referred to in text and labeled in figures as “CL3”) is arranged to selectively couple the first motor/generator MG1 to the second gear X. The second motor/generator MG2 is operably coupled to the first gear Y. In some embodiments, the second transfer gear set 125 is operably coupled to the engine ICE and the second clutch CL2.

Referring now to FIGS. 72-74, in some embodiments, hybrid architectures include a simple planetary gear as a differential in combination with the CVP 100, wherein the CVP 100 has a ground carrier node C. The architecture enables a variable ratio compound split system, as opposed to a fixed ratio commonly available in compound split eCVT systems.

Referring now to FIG. 72, in some embodiments, the ICE is operably coupled to a simple planetary gearbox (referred to in text and labeled in figures as “PC”). In some embodiments, the planetary gearbox PC includes a ring gear PCR, a planet carrier PCC, and a sun gear PCS. The second motor/generator MG2 and the first motor/generator MG1 are operably coupled to PC. In some embodiments, the first motor/generator MG1 is coupled to the ring gear PCR, and the second motor/generator MG2 is coupled to the sun gear PCS. The first motor/generator MG1 is operably coupled to the first ring R1. The carrier node C is a grounded member. The second traction ring R2 is operably coupled to a final drive. In some embodiments, the first transfer gear 115 is coupled to the second traction ring R2 and the final drive gear set 120.

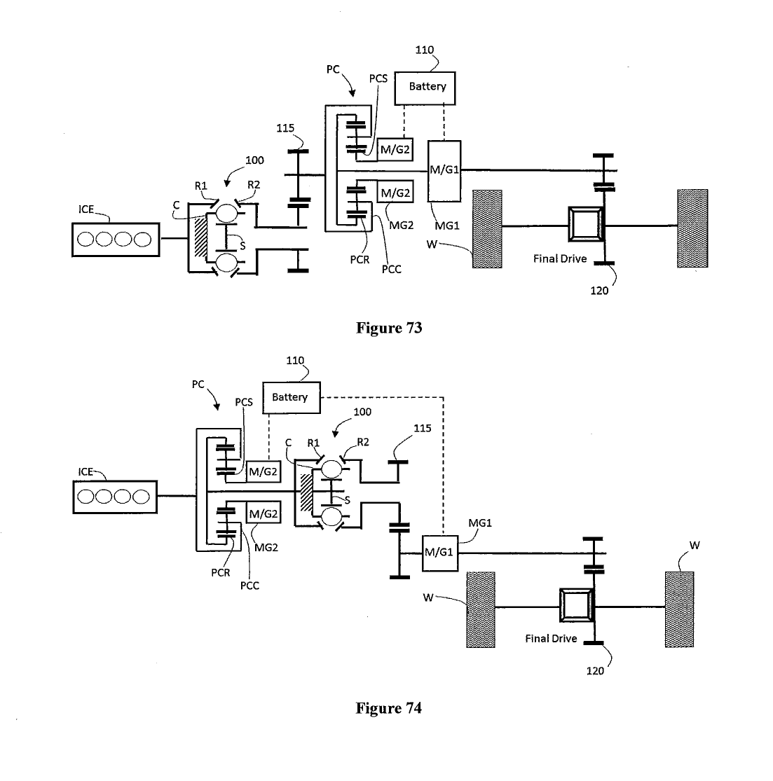

Referring now to FIG. 73, in some embodiments, the ICE is operably coupled to the first traction ring R1. The carrier node C is a grounded member. The second traction ring R2 is operably coupled to the planetary gearbox PC. The second motor/generator MG2 and the first motor/generator MG1 are operably coupled to the planetary gearbox PC. In some embodiments, the first motor/generator MG1 is coupled to the ring gear PCR, and the second motor/generator MG2 is coupled to the sun gear PCS. The first motor/generator MG1 is operably coupled to the final drive gear set 120. In some embodiments, the first transfer gear set 115 operably coupled the second traction ring R2 to the planet carrier PCC of the planetary gearbox PC.

Referring now to FIG. 74, in some embodiments, the ICE is operably coupled to the planetary gearbox PC. The second motor/generator MG2 is operably coupled to the planetary gearbox PC. The planetary gearbox PC is operably coupled to the first traction ring R1. In some embodiments, the first traction ring R1 is operably coupled to the ring gear PCR. The carrier node C is a grounded member. The first motor/generator MG1 is operably coupled to the second traction ring R2. The planetary gearbox PC is operably coupled to the sun S. In some embodiments, the second motor/generator MG2 is operably coupled to the sun gear PCS. The first motor/generator MG1 is operably coupled to the final drive gear set 120. In some embodiments, the first transfer gear 115 is operably coupled to the second traction ring R2 and the first motor/generator MG1.

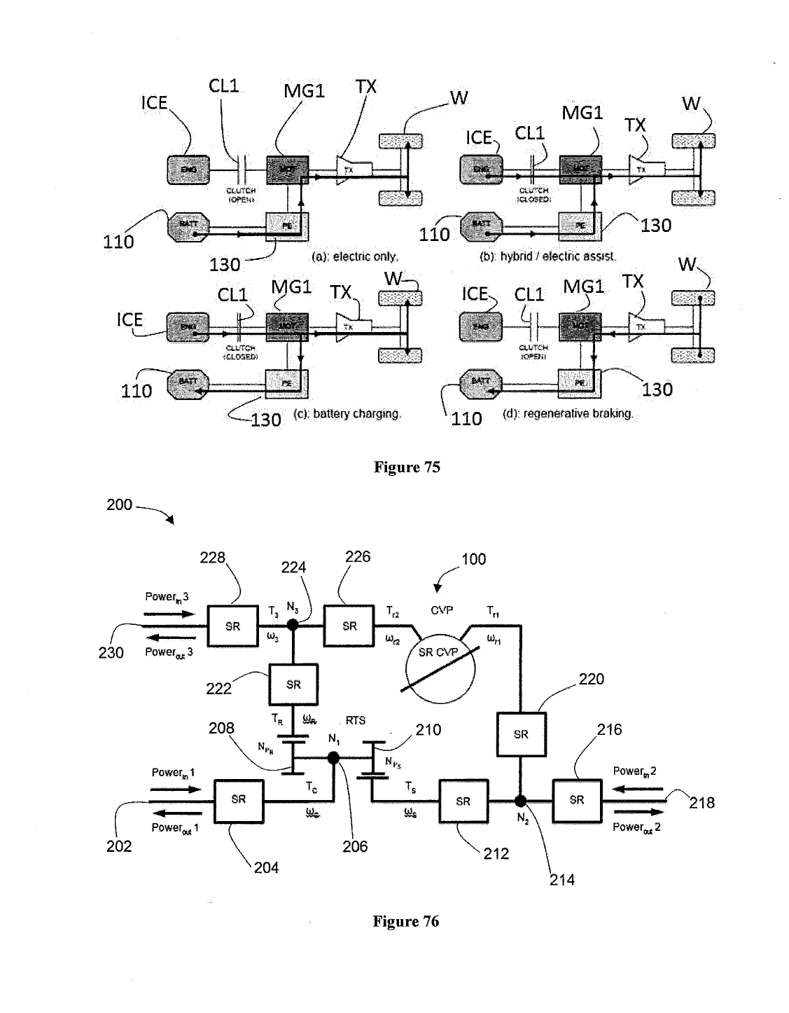

Referring now to FIGS. 75a-75d, in some embodiments, a hybrid architecture includes a CVP having a grounded carrier node C. The CVP is used in a multi speed gearbox, for example, a six (6) or seven (7) speed gearbox. It should be appreciated that the hybrid architectures disclosed herein are capable of also including additional clutches, brakes, and couplings to three nodes of the CVP. For example, the multi speed gearbox (labeled in FIGS. 27a-27d as “TX”) is optionally provided with a continuously variable transmission such as those disclosed in U.S. Provisional Patent Application No. 62/343,297, which is hereby incorporated by reference. It should be appreciated that the first motor/generator MG1 is optionally arranged between the multi speed gearbox TX and the driven wheels W. In some embodiments, the engine ICE is coupled to the first clutch CL1. The first clutch CL1 is operably coupled to the first motor/generator MG1. The first motor/generator MG1 is in electrical communication with the batter 110 through a power inverter system 130. In some embodiments, the multi speed gearbox TX is operably coupled to the first motor/generator and provides power to the vehicle wheels W.

Referring now to FIGS. 76-78, in some embodiments, a hybrid drivetrain is capable of being configured with the CVP 100 (denoted as “SR CVP” in FIGS. 76-78) and a number of fixed gear sets (denoted as “SR” in FIGS. 76-78). For description purposes, in reference to FIGS. 76-78, “SR CVP” refers to the CVP speed ratio, “SR” refers to optional speed ratio increase or decrease (for example, typical meshing gear, sprocket and chain, or a belt and pulley, among other common couplings), “RTS” refers to a planetary ring to sun gear ratio, “N1, N2, N3” refers to nodes 1, 2 & 3 respectively, “TO” refers to Torque, “ω₀” refers to speed in rpm, “NP_{R}” refers to the planet pinion gear in contact with the ring number or teeth, pitch radius, pitch diameter, and “NP_{S}” refers to the planet pinion gear in contact with the sun gear number or teeth, pitch radius, pitch diameter. In some embodiments, input power (denoted as “Power-In 1”, “Power-In 2” or “Power-In 3”) is from an engine, a motor, or a stored energy reclamation device (electric, hydraulic, kinetic), among others. In some embodiments, output power (denoted as “Power-Out 1”, “Power-Out 2”, or “Power-Out 3”) is delivered for primary work of the device, propulsion for a vehicle (car, boat, ATV, bicycle), operation of equipment (windmill, water turbine, mill, lathe, paper mill), or energy transfer to another branch (example Power-Out 1 runs an electric generator to create electricity needed to supplement a motor at Power-In 2), among others. In some embodiments, output power is used for energy storage (electric, hydraulic, kinetic), auxiliary power take-off (PTO) such as a generator/alternator (electric, hydraulic, pneumatic), fan, air conditioning equipment, among others.

Referring now to FIGS. 76, 77, and 78, in some embodiments, hybrid powertrains include stepped planet planetaries. If the planets (NP_{R} & NP_{S}) have the same pitch diameter, then the planetary is capable of being reduced to a simple planetary. The planetary in either FIG. 76, 77, or 78 could also be a compound planetary, a dual sun gear planetary, a dual ring planetary, or two interconnected simple planetaries.

The hybrid powertrain embodiments depicted in FIGS. 76, 77, and 78 show various hybrid CVP power paths with multiple inputs and outputs (Power-In 1, Power-In 2, Power-In 3, Power-Out 1, Power-Out 2, and Power-Out 3). As an example, if one input/output is designated as the primary power-in (Power-In 1), and one input/output is designated as the primary power-out (Power-Out 2), the third Power-In/Out 3 is capable of: 1) being a second power input (to reduce the power needed at Power-In 1 and/or increase the Power-Out 2 power); 2) generating power for storage; 3) generating power for an auxiliary application; 4) generating power that is supplemented back to the primary power-in; 5) generating power that is supplemented back to the primary power-out, or; 6) generating power that is supplemented back directly to the output.

The basic configurations, of any one of FIG. 76, 77, or 78, could also be coupled to other gearing and clutches to make multi-mode hybrid transmissions. Using the previous example, the previous primary power-in (Power-In 1) is capable of remaining the primary power-in, but the previous primary power-out (Power-Out 2) is capable of becoming the new input/output (Power-In/Out 2) and the previous third input/output (Power-In/Out 3) is capable of becoming the new power-out (Power-Out 3). Thus it is easily seen that there are a multitude of combinations that can be realized.

Referring now to FIG. 76, in some embodiments, a hybrid powertrain 200 is provided with a first rotatable shaft 202 configured to transfer power in or out of the hybrid powertrain 200. The first rotatable shaft 202 is operably coupled to a first fixed ratio coupling 204. The first fixed ratio coupling 204 is coupled to a first node 206 that is adapted to couple a first planetary 208 and a second planetary 210. In some embodiments, the second planetary 210 is coupled to a second fixed ratio coupling 212. The second fixed ratio coupling 212 is coupled to a second node 214. The second node 214 is configured to couple to a third fixed ratio coupling 216. A second rotatable shaft 218 is coupled to the third fixed ratio coupling 216 and configured to transfer power in or out of the hybrid powertrain 200. In some embodiments, the second node 214 is coupled to a fourth fixed ratio coupling 220. The fourth fixed ratio coupling 220 is coupled to the first traction ring of the CVP 100. In some embodiments, the first planetary 208 is operably coupled to a fifth fixed ratio coupling 222. The fifth fixed ratio coupling 222 is coupled to a third node 224. The third node 224 is coupled to a sixth fixed ratio coupling 226. The sixth fixed ratio coupling 226 is coupled to the second traction ring of the CVP 100. In some embodiments, the third node 224 is coupled to a seventh fixed ratio coupling 228. The seventh fixed ratio coupling 228 is operably coupled to a third rotatable shaft 230. The third rotatable shaft 230 is configured to transfer power in or out of the powertrain 200.

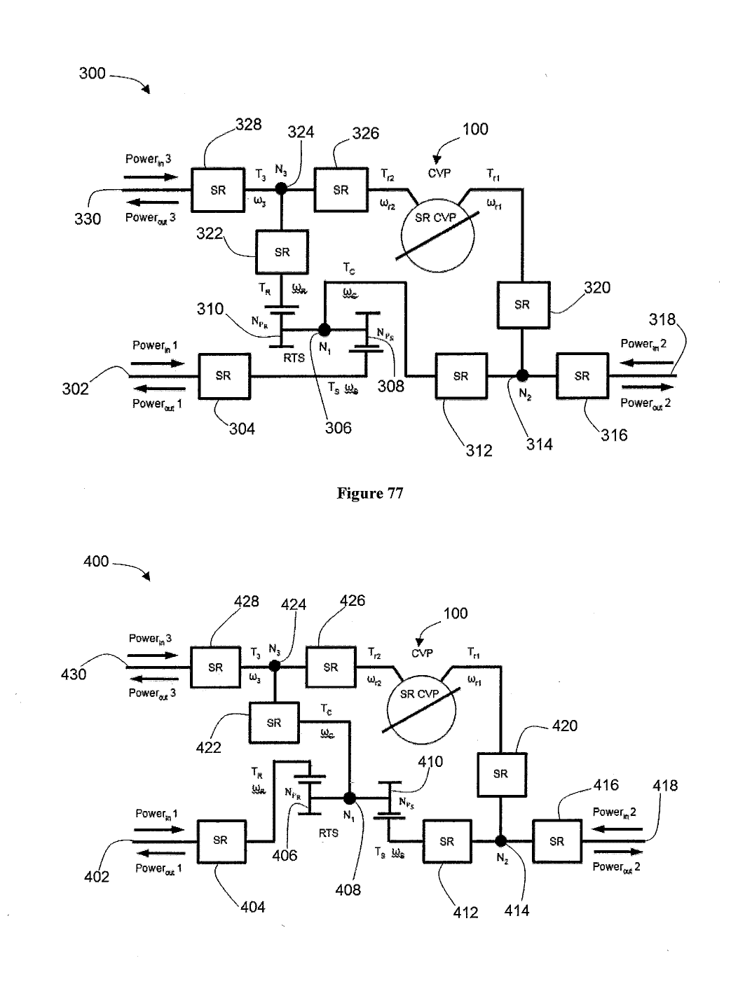

Referring now to FIG. 77, in some embodiments, a hybrid powertrain 300 provided with a first rotatable shaft 302 configured to transfer power in or out of the hybrid powertrain 300. The first rotatable shaft 302 is operably coupled to a first fixed ratio coupling 304. The first fixed ratio coupling 304 is coupled to a first node 306 through a first planetary 308. In some embodiments, the first node 306 is coupled to a second planetary 310. In some embodiments, the first node 306 is coupled to a second fixed ratio coupling 312. The second fixed ratio coupling 312 is coupled to a second node 314. The second node 314 is configured to couple to a third fixed ratio coupling 316. A second rotatable shaft 318 is coupled to the third fixed ratio coupling 316 and configured to transfer power in or out of the hybrid powertrain 300. In some embodiments, the second node 314 is coupled to a fourth fixed ratio coupling 320. The fourth fixed ratio coupling 320 is coupled to the first traction ring of the CVP 100. In some embodiments, the second planetary 310 is operably coupled to a fifth fixed ratio coupling 322. The fifth fixed ratio coupling 322 is coupled to a third node 324. The third node 324 is coupled to a sixth fixed ratio coupling 326. The sixth fixed ratio coupling 326 is coupled to the second traction ring of the CVP 100. In some embodiments, the third node 324 is coupled to a seventh fixed ratio coupling 328. The seventh fixed ratio coupling 328 is operably coupled to a third rotatable shaft 330. The third rotatable shaft 330 is configured to transfer power in or out of the powertrain 300.

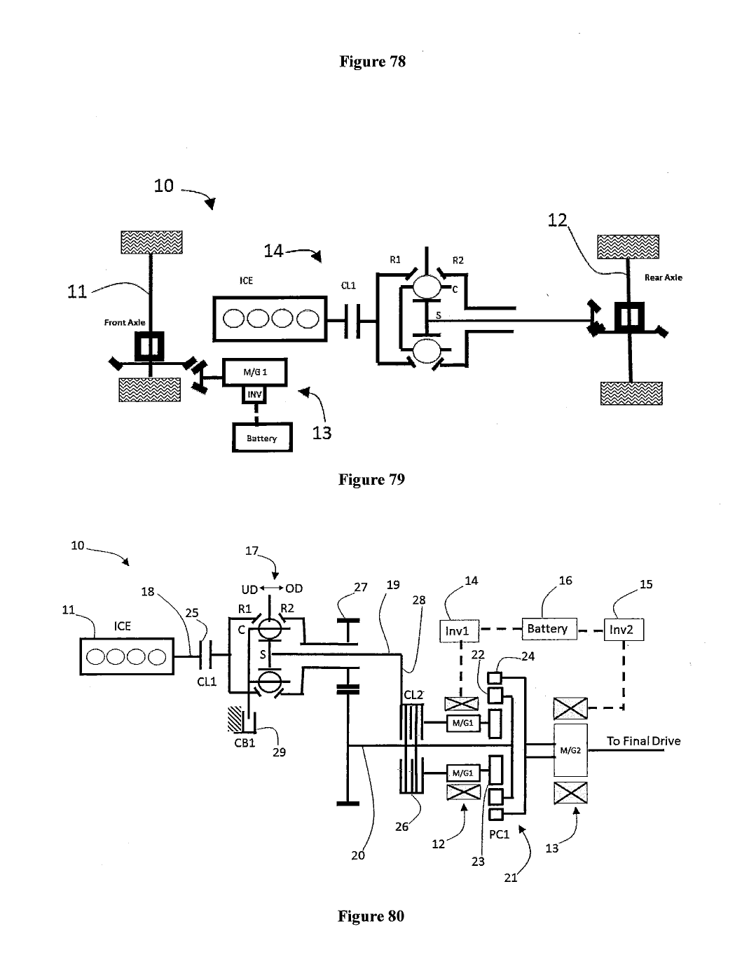

Referring now to FIG. 78, in some embodiments, a hybrid powertrain 400 provided with a first rotatable shaft 402 configured to transfer power in or out of the hybrid powertrain 400. The first rotatable shaft 402 is operably coupled to a first fixed ratio coupling 404. The first fixed ratio coupling 404 is coupled to a first planetary 406. The first planetary 406 is coupled to a first node 408. In some embodiments, the first node 408 is coupled to a second planetary 410. In some embodiments, the second planetary 410 is coupled to a second fixed ratio coupling 412. The second fixed ratio coupling 412 is coupled to a second node 414. The second node 414 is configured to couple to a third fixed ratio coupling 416. A second rotatable shaft 418 is coupled to the third fixed ratio coupling 416 and configured to transfer power in or out of the hybrid powertrain 400. In some embodiments, the second node 414 is coupled to a fourth fixed ratio coupling 420. The fourth fixed ratio coupling 420 is coupled to the first traction ring of the CVP 100. In some embodiments, the first node 408 is operably coupled to a fifth fixed ratio coupling 422. The fifth fixed ratio coupling 422 is coupled to a third node 424. The third node 424 is coupled to a sixth fixed ratio coupling 426. The sixth fixed ratio coupling 426 is coupled to the second traction ring of the CVP 100. In some embodiments, the third node 424 is coupled to a seventh fixed ratio coupling 428. The seventh fixed ratio coupling 428 is operably coupled to a third rotatable shaft 430. The third rotatable shaft 430 is configured to transfer power in or out of the powertrain 400. It should be noted that the term “node” used herein is in reference to any mechanical coupling of rotating components configured to transmit rotational power.

Passing now to FIG. 79, a vehicle 10 has a front axle 11 and a rear axle 12. The front axle 11 is operably coupled to an electric drive system 13 having at least one motor-generator. The rear axle 12 is operably coupled to a drivetrain 14 having a CVP. In some embodiments, the drivetrain 14 is optionally configured to have electric motor/generators or other devices such as the embodiments disclosed in FIGS. 55-79. In some embodiments, the CVP is optionally configured to be a multi-mode hybrid transmission as depicted in FIGS. 76-79, among others. In some embodiments, the electric drive system 13 is optionally configured to couple to the rear axle 12 and the drivetrain 14 is optionally configured to couple to the front axle 11.

Provided herein is a powertrain having one motor/generator MG1; an engine ICE; and a continuously variable planetary transmission (CVP) 100 including a plurality of balls, a first traction ring R1, a second traction ring R2, a sun S, and a carrier C, wherein each ball of the plurality of balls is provided with a tiltable axis of rotation, each ball is in contact with the first traction ring R1 and the second traction ring R2, each ball is in contact with a sun S wherein the sun S is located radially inward of each ball, and each ball is operably coupled to the carrier C which is operably coupled to a shift actuator, wherein the engine ICE is operably coupled to the first traction ring R1, and wherein the carrier C is grounded and non-rotating. In some embodiments, a first motor/generator MG1 is operably coupled to the sun S. In some embodiments, a second motor/generator MG2 is operably coupled to the second traction ring R2. In some embodiments, the powertrain includes a first clutch CL1 operably coupled to the second motor/generator MG2, wherein the first clutch CL1 is arranged to selectively engage the second traction ring R2. In some embodiments, the powertrain includes a first clutch CL1 operably coupled to the first motor/generator MG2, wherein the first clutch CL1 is adapted to selectively engage the sun S. In some embodiments, the powertrain includes a brake B1 operably coupled to the second traction ring R2. In some embodiments, the second motor/generator MG2 is operably coupled to a final drive gear. In some embodiments, the powertrain includes a powertrain supervisory controller, wherein the controller is configured to supply control signals to the powertrain or components thereof such that the said controller dynamically affects a plurality of operating modes of the powertrain.

Provided herein is a powertrain having at least one motor/generator MG1; an engine ICE; a first clutch CL1 coupled to the engine ICE; and a continuously variable planetary transmission including a plurality of balls, a first traction ring R1, a second traction ring R2, a sun S, and a carrier C, wherein each ball is provided with a tiltable axis of rotation, each ball is in contact with the first traction ring R1 and the second traction ring R2, each ball is in contact with the sun S, wherein the sun S is located radially inward of each ball, and each ball is operably coupled to the carrier C, wherein the carrier C is operably coupled to a shift actuator, wherein the engine ICE is selectively coupled to the first traction ring R1, and wherein the carrier C is grounded and non-rotating. In some embodiments, a first motor/generator MG1 is operably coupled to the sun S. In some embodiments, a second motor/generator MG2 is operably coupled to the second traction ring R2. In some embodiments, the powertrain includes a second clutch CL2 operably coupled to the second motor/generator MG2, wherein the second clutch CL2 is arranged to selectively engage the second traction ring R2. In some embodiments, the powertrain includes a second clutch CL2 operably coupled to the first motor/generator MG1, wherein the first clutch CL1 is adapted to selectively engage the sun S. In some embodiments, the powertrain includes a brake B1 operably coupled to the second traction ring R2. In some embodiments, the second motor/generator MG2 is operably coupled to a final drive gear. In some embodiments, the powertrain includes a powertrain supervisory controller, wherein the controller is configured to supply control signals to the powertrain or components thereof such that the said controller dynamically affects a plurality of operating modes of the powertrain.

Provided herein is a powertrain having at least one motor/generator MG1; an engine ICE; a first clutch CL1 coupled to the engine ICE; and a continuously variable planetary transmission (CVP) 100 including a plurality of balls, a first traction ring R1 in contact with each ball of the plurality of balls, a second traction ring R2 in contact with each ball of the plurality of balls, a sun S located radially inward of each ball of the plurality of balls and in contact with each ball of the plurality of balls, a carrier C operably coupled to each ball of the plurality of balls and operably coupled to a shift actuator, wherein each ball of the plurality of balls is provided with a tiltable axis of rotation, wherein the engine ICE is selectively coupled to the first traction ring R1, and wherein the carrier C is grounded and non-rotating. In some embodiments, a first motor/generator MG1 is operably coupled to the sun S. In some embodiments, a second motor/generator MG2 is operably coupled to the second traction ring R2. In some embodiments, the powertrain includes a second clutch CL2 operably coupled to the second motor/generator MG2, wherein the second clutch CL2 is arranged to selectively engage the second traction ring R2. In some embodiments, the powertrain includes a second clutch CL2 operably coupled to the first motor/generator MG1, wherein the first clutch CL1 is adapted to selectively engage the sun S. In some embodiments, the powertrain includes a brake B1 operably coupled to the second traction ring R2. In some embodiments, the second motor/generator MG2 is operably coupled to a final drive gear. In some embodiments, the powertrain includes a powertrain supervisory controller, wherein the controller is configured to supply control signals to the powertrain or components thereof such that the said controller dynamically affects a plurality of operating modes of the powertrain.

Provided herein is a powertrain having at least one motor/generator MG1; an engine ICE; a continuously variable planetary transmission (CVP) 100 including a plurality of balls, a first traction ring R1, a second traction ring R2, a sun S, and a carrier C; and a planetary gearbox PC operably coupled to the CVP 100 and the first motor/generator MG1; wherein each ball is provided with a tiltable axis of rotation, each ball is in contact with the first traction ring R1 and the second traction ring R2, each ball is in contact with a sun S, wherein the sun S is located radially inward of each ball, and each ball is operably coupled to the carrier C, wherein the carrier C is operably coupled to a shift actuator, and wherein the carrier C is grounded. In some embodiments, the planetary gearbox PC is operably coupled to a second motor/generator MG2. In some embodiments, the planetary gearbox PC is operably coupled to the engine ICE. In some embodiments, the engine ICE is operably coupled to the first traction ring R1, and the planetary gearbox PC is operably coupled to the second traction ring R2. In some embodiments, the planetary gearbox PC is operably coupled to the engine ICE, and a second motor/generator MG2 is operably coupled to the second traction ring R2. In some embodiments, the planetary gearbox PC is operably coupled to the first traction ring R1 and the sun S. In some embodiments, the powertrain includes a powertrain supervisory controller, wherein the controller is configured to supply control signals to the powertrain or components thereof such that the said controller dynamically affects a plurality of operating modes of the powertrain.

Provided herein is a powertrain having at least one motor/generator MG1; an engine ICE; a continuously variable planetary transmission (CVP) 100 including a plurality of balls, a first traction ring R1 in contact with each ball of the plurality of balls, a second traction ring R2 in contact with each ball of the plurality of balls, a sun S located radially inward of each ball of the plurality of balls and in contact with each ball of the plurality of balls, a carrier C operably coupled to each ball of the plurality of balls and operably coupled to a shift actuator, wherein each ball of the plurality of balls is provided with a tiltable axis of rotation, and wherein the carrier C is grounded. In some embodiments, the planetary gearbox PC is operably coupled to a second motor/generator MG2. In some embodiments, the planetary gearbox PC is operably coupled to the engine ICE. In some embodiments, the engine ICE is operably coupled to the first traction ring R1, and the planetary gearbox PC is operably coupled to the second traction ring R2. In some embodiments, the planetary gearbox PC is operably coupled to the engine ICE, and a second motor/generator MG2 is operably coupled to the second traction ring R2. In some embodiments, the planetary gearbox PC is operably coupled to the first traction ring R1 and the sun S. In some embodiments, the powertrain includes a powertrain supervisory controller, wherein the controller is configured to supply control signals to the powertrain or components thereof such that the said controller dynamically affects a plurality of operating modes of the powertrain.

Provided herein is a powertrain having at least one hydro-mechanical machine; an engine ICE; and a continuously variable planetary transmission (CVP) 100 including a plurality of balls, a first traction ring R1, a second traction ring R2, a sun S, and a carrier C, wherein each ball is provided with a tiltable axis of rotation, each ball is in contact with the first traction ring R1 and the second traction ring R2, each ball is in contact with the sun S, wherein the sun S is located radially inward of each ball, and each ball is operably coupled to a carrier C, wherein the carrier C is operably coupled to a shift actuator, wherein the engine ICE is operably coupled to the first traction ring R1, and wherein the carrier C is grounded and non-rotating. In some embodiments, a first hydro-mechanical machine is operably coupled to the sun S. In some embodiments, a second hydro-mechanical machine is operably coupled to the second traction ring R2. In some embodiments, the powertrain includes a first clutch CL1 operably coupled to the second hydro-mechanical machine, wherein the first clutch CL1 is arranged to selectively engage the second traction ring R2. In some embodiments, the powertrain includes a first clutch CL1 operably coupled to the first hydro-mechanical machine, wherein the first clutch CL1 is adapted to selectively engage the sun S. In some embodiments, the powertrain includes a brake B1 operably coupled to the second traction ring R2. In some embodiments, the second hydro-mechanical machine is operably coupled to a final drive gear. In some embodiments, the powertrain includes a powertrain supervisory controller, wherein the controller is configured to supply control signals to the powertrain or components thereof such that the said controller dynamically affects a plurality of operating modes of the powertrain.

Provided herein is a powertrain having at least one hydro-mechanical machine; an engine ICE; and a continuously variable planetary transmission (CVP) 100 including a plurality of balls, a first traction ring R1 in contact with each ball of the plurality of balls, a second traction ring R2 in contact with each ball of the plurality of balls, a sun S located radially inward of each ball of the plurality of balls and in contact with each ball of the plurality of balls, a carrier C operably coupled to each ball of the plurality of balls and operably coupled to a shift actuator, wherein each ball of the plurality of balls is provided with a tiltable axis of rotation, wherein the engine ICE is operably coupled to the first traction ring R1, and wherein the carrier C is grounded and non-rotating. In some embodiments, a first hydro-mechanical machine is operably coupled to the sun S. In some embodiments, a second hydro-mechanical machine is operably coupled to the second traction ring R2. In some embodiments, the powertrain includes a first clutch CL1 operably coupled to the second hydro-mechanical machine, wherein the first clutch CL1 is arranged to selectively engage the second traction ring R2. In some embodiments, the powertrain includes a first clutch CL1 operably coupled to the first hydro-mechanical machine, wherein the first clutch CL1 is adapted to selectively engage the sun S. In some embodiments, the powertrain includes a brake B1 operably coupled to the second traction ring R2. In some embodiments, the second hydro-mechanical machine is operably coupled to a final drive gear. In some embodiments, the powertrain includes a powertrain supervisory controller, wherein the controller is configured to supply control signals to the powertrain or components thereof such that the said controller dynamically affects a plurality of operating modes of the powertrain.

Provided herein is a vehicle having a first axle 11; a second axle 12; a drivetrain including a ball-planetary continuously variable transmission 14 operably coupled to the first axle 11; and an electric drive system 13 operably coupled to the second axle 12. In some embodiments, the ball-planetary continuously variable transmission 14 includes a plurality of balls, a first traction ring R1 in contact with each ball of the plurality of balls, a second traction ring R2 in contact with each ball of the plurality of balls, a sun S located radially inward of each ball of the plurality of balls and in contact with each ball of the plurality of balls, a carrier C operably coupled to each ball of the plurality of balls and operably coupled to a shift actuator, wherein each ball of the plurality of balls is provided with a tiltable axis of rotation. In some embodiments, the electric drive system 13 further includes at least one motor-generator MG1.

It should be noted that where an ICE is described, the ICE is capable of being an internal combustion engine (diesel, gasoline, hydrogen) or any powerplant such as a fuel cell system, or any hydraulic/pneumatic powerplant like an air-hybrid system. Along the same lines, the battery is capable of being not just a high voltage pack such as lithium ion or lead-acid batteries, but also ultracapacitors or other pneumatic/hydraulic systems such as accumulators, or other forms of energy storage systems. The first motor/generator MG1 and the second motor/generator MG2 are capable of representing hydromotors actuated by variable displacement pumps, electric machines, or any other form of rotary power such as pneumatic motors driven by pneumatic pumps. The eCVT architectures depicted in the figures and described in text is capable of being extended to create hydro-mechanical CVT architectures as well for hydraulic hybrid systems.

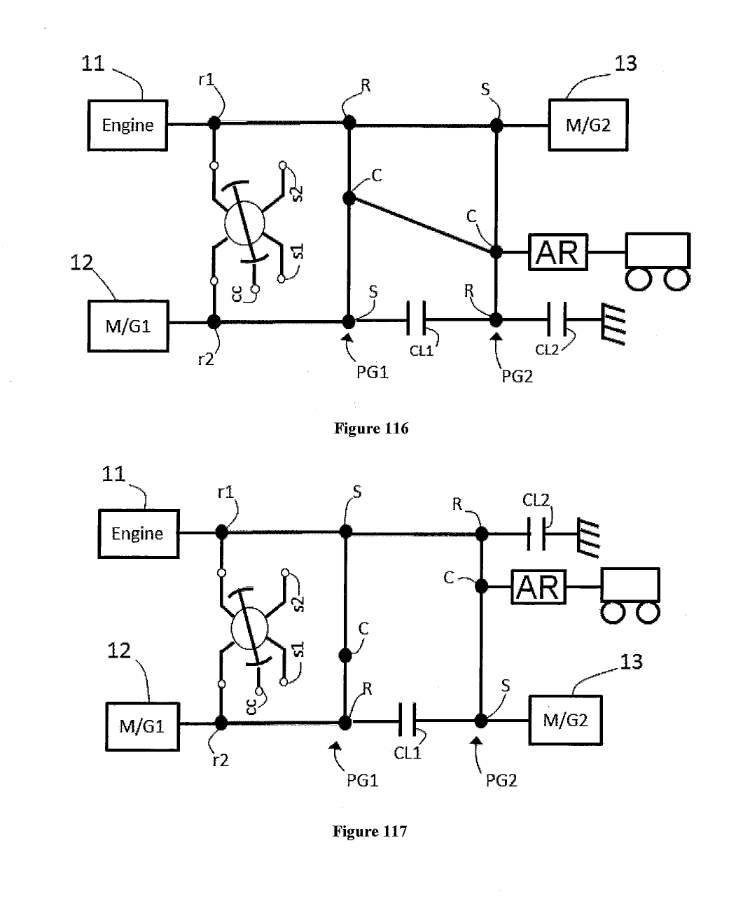

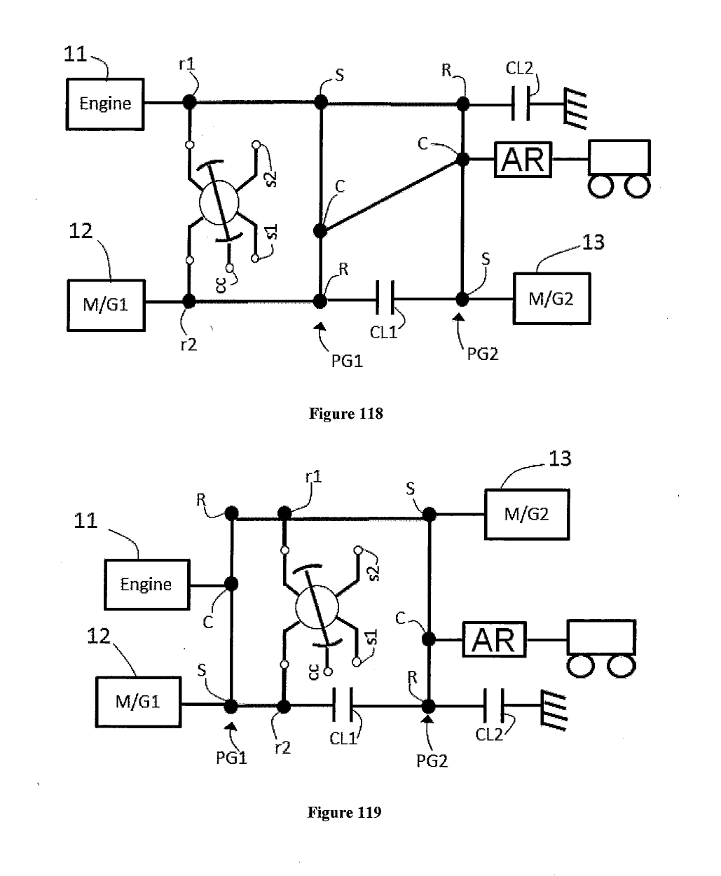

Passing now to FIGS. 80-122, embodiments of hybrid powertrains disclosed in U.S. Patent Application No. 62/254,544 filed Nov. 12, 2015 are described as optional configurations for the hybrid powertrain 1100.

Referring now to FIG. 80; in some embodiments a hybrid powertrain 10 includes a source of rotational power, for example an internal combustion engine (ICE) 11, a first motor-generator 12, and a second motor-generator 13. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16, for example. In some embodiments, the hybrid powertrain 10 includes a variator assembly 17. In some embodiments, the variator assembly 17 is substantially similar to the CVP depicted in FIGS. 1-3. The variator assembly 17 has a first traction ring (R1), a second traction ring (R2), a carrier assembly (C), and a sun assembly (S). For descriptive purposes and conciseness, common components depicted in FIGS. 7-20 have common labels.

Still referring to FIG. 80; in some embodiments, the hybrid powertrain 10 has a first rotatable shaft 18 configured to couple to the ICE 11. The hybrid powertrain 10 includes a second rotatable shaft 19 coaxial with the first rotatable shaft 18. The second rotatable shaft 19 is coupled to the sun assembly (S). The hybrid powertrain 10 includes a third rotatable shaft 20 configured to be substantially parallel to the second rotatable shaft 19. The first motor generator 12 and the second motor generator 13 are arranged coaxially on the third rotatable shaft 20. The second motor generator 13 is configured to couple to a final drive gear (not shown). In some embodiments, the hybrid powertrain 10 includes a planetary gear set 21 (PC1) arranged coaxially on the third rotatable shaft 20. In some embodiments, the planetary gear set 21 (PC1) is a simple planetary. In some embodiments, the planetary gear set 21 (PCI) is a compound planetary. The planetary gear set 21 (PC1) includes a planet carrier 22, a sun gear 23, and a ring gear 24. The sun gear 23 is operably coupled to the first motor-generator 12. The planet carrier 22 is coupled to the third rotatable shaft 20. The ring gear 24 is operably coupled to the second motor-generator 13. In some embodiments, the hybrid powertrain 10 includes a first clutch 25 (CL1) coupled to the first rotatable shaft 18. The first clutch 25 is coupled to the first traction ring (R1). The hybrid powertrain 10 includes a second clutch 26 (CL2) coupled to the third rotatable shaft 20. The second clutch 26 is coupled to the first motor-generator 12. In some embodiments, a gear set 27 is configured to couple the second traction ring (R2) to the third rotatable shaft 20. The second rotatable shaft 19 is coupled to the second clutch 26 with a coupling 28. In some embodiments, the coupling 28 is a belt coupling. In some embodiments, the coupling 28 is a chain coupling. In other embodiments, the coupling 28 is a step gear. The hybrid powertrain 10 is provided with a brake clutch 29 (CB1) coupled to the carrier assembly (C). In some embodiments, the brake clutch 29 is optionally provided to couple to the planetary gear set 21 (PC1) to facilitate the coupling of any element of the planetary gear set 21 (PC1) to a ground member or to couple two elements of the planetary gear set 21 (PC1) to each other.

During operation of the hybrid powertrain 10, power is transmitted in at least two modes of operation. A first mode of operation is established as the variator 17 is used as a differential element as is the planetary gear set 21 when the carrier assembly (C) is free to rotate. In other words, the first mode of operation corresponds to a disengaged position of the brake clutch 29. A second mode of operation is established as the variator 17 is used as a mechanical transmission when the brake clutch 29 is applied to ground the carrier assembly (C).

Provided herein is a hybrid powertrain including a first rotatable shaft operably coupleable to a source of rotational power; a second rotatable shaft aligned substantially coaxial to the first rotatable shaft, the first rotatable shaft and the second rotatable shaft forming a main axis; a third rotatable shaft aligned substantially parallel to the main axis; a variator assembly having a first traction ring and a second traction ring in contact with a plurality of traction planets, each traction planet having a tiltable axis of rotation, each traction planet supported in a carrier assembly, each traction planet in contact with a sun assembly; wherein the variator assembly is coaxial with the main axis; wherein the second traction ring is operably coupled to the third rotatable shaft; wherein the sun assembly is coupled to the second rotatable shaft; a planetary gearset having a planet carrier, a sun gear, and a ring gear, the planetary gearset coaxial with the third rotatable shaft, the third rotatable shaft coupled to the planet carrier; a first motor-generator positioned coaxially with the third rotatable shaft, the first motor/generator operably coupled to the sun gear; a second motor-generator positioned coaxially with the third rotatable shaft, the second motor-generator coupled to the ring gear; a first clutch operably coupled to the first rotatable shaft, the first clutch coupled to the first traction ring; a second clutch arranged coaxially with the third rotatable shaft, the second clutch coupled to the first motor-generator; and a brake clutch operably coupled to the carrier assembly.

In some embodiments of the hybrid powertrain, a gear set is configured to couple the second traction ring to the third rotatable shaft.

In some embodiments of the hybrid powertrain, a chain is configured to couple the second rotatable shaft to the second clutch.

In some embodiments of the hybrid powertrain, a first inverter is in electrical communication with the first motor-generator.

In some embodiments of the hybrid powertrain, a second inverter is in electrical communication with the second motor-generator.

In some embodiments of the hybrid powertrain, a battery is in electrical communication with the first inverter and the second inverter.

In some embodiments of the hybrid powertrain, a step gear connection is configured to couple the second rotatable shaft to the second clutch.

In some embodiments of the hybrid powertrain, the second clutch is configured to selectively engage the sun assembly and the second traction ring.

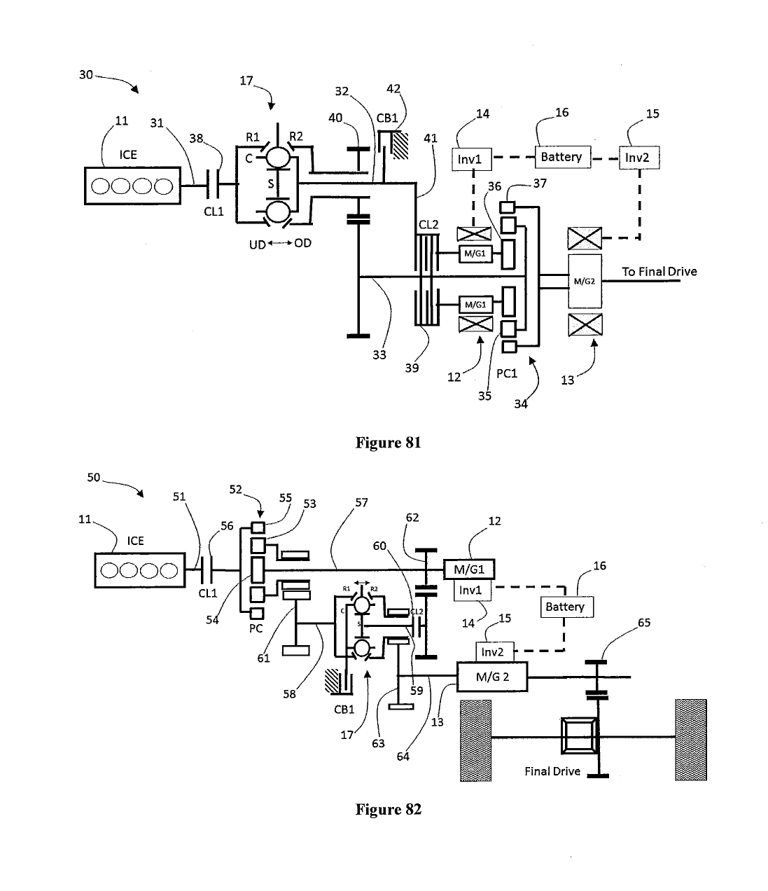

Referring now to FIG. 81; in some embodiments a hybrid powertrain 30 includes the ICE 11, the first motor-generator 12, the second motor generator 13, and the variator assembly 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 30 has a first rotatable shaft 31 configured to couple to the ICE 11. The hybrid powertrain 30 has a second rotatable shaft 32 arranged coaxially with the first rotatable shaft 31. The second rotatable shaft 32 is coupled to the carrier assembly (C). The hybrid powertrain 30 includes a third rotatable shaft 33 arranged substantially parallel to the second rotatable shaft 32. The first motor generator 12 and the second motor generator 13 are coaxial with the third rotatable shaft 33. In some embodiments, a planetary gear set 34 (PC1) is arranged coaxially with the third rotatable shaft 33. In some embodiments, the planetary gear set 34 (PC1) is a simple planetary. In some embodiments, the planetary gear set 34 (PCI) is a compound planetary. The planetary gear set 34 includes a planet carrier 35, a sun gear 36, and a ring gear 37. The first motor generator 12 is coupled to the sun gear 36. The second motor generator 13 is coupled to the ring gear 37. In some embodiments, the hybrid powertrain 30 is provided with a first clutch 38 (CL1) coupled to the first rotatable shaft 31. The first clutch 38 is coupled to the first traction ring (R1). The hybrid powertrain 30 is provided with a second clutch 39 (CL2) arranged coaxially with the third rotatable shaft 33. The second clutch 39 is operably coupled to the first motor-generator 12. In some embodiments, a gear set 40 couples the second rotatable shaft 32 to the third rotatable shaft 33. A coupling 41 is configured to connect the second rotatable shaft 32 to the second clutch 39. In some embodiments, the coupling 41 is a belt coupling. In some embodiments, the coupling 41 is a chain coupling. In other embodiments, the coupling 41 is a step gear. The hybrid powertrain 30 is provided with a brake clutch 42 (CB1) coupled to the sun assembly (S). In some embodiments, the brake clutch 42 is optionally provided to couple to the planetary gear set 34 (PC1) to facilitate the coupling of any element of the planetary gear set 34 (PC1) to a ground member or to couple two elements of the planetary gear set 34 (PC1) to each other.

During operation of the hybrid powertrain 30, power is transmitted in at least two modes of operation. A first mode of operation is established as the variator 17 is used as a differential element when the brake clutch 42 (CB1) is disengaged and the carrier assembly (C) is free to rotate. A second mode of operation is established as the variator 17 is used as a mechanical transmission when the brake clutch 42 (CB1) is applied to ground the carrier assembly (C).

Provided herein is a hybrid powertrain including a first rotatable shaft operably coupleable to a source of rotational power; a second rotatable shaft aligned substantially coaxial to the first rotatable shaft, the first rotatable shaft and the second rotatable shaft forming a main axis; a third rotatable shaft aligned substantially parallel to the main axis; a variator assembly having a first traction ring and a second traction ring in contact with a plurality of traction planets, each traction planet having a tiltable axis of rotation, each traction planet supported in a carrier assembly, each traction planet in contact with a sun assembly; wherein the variator assembly is coaxial with the main axis; wherein the second traction ring is operably coupled to the third rotatable shaft; wherein the carrier assembly is coupled to the second rotatable shaft; a planetary gearset having a planet carrier, a sun gear, and a ring gear, the planetary gearset coaxial with the third rotatable shaft, the third rotatable shaft coupled to the planet carrier; a first motor-generator positioned coaxially with the third rotatable shaft, the first motor/generator operably coupled to the sun gear; a second motor-generator positioned coaxially with the third rotatable shaft, the second motor-generator coupled to the ring gear; a first clutch operably coupled to the first rotatable shaft, the first clutch coupled to the first traction ring; a second clutch coupled to the third rotatable shaft, the second clutch coupled to the first motor-generator; and a brake clutch operably coupled to the second rotatable shaft.

In some embodiments of the hybrid powertrain, a gear set is configured to couple the second traction ring to the third rotatable shaft.

In some embodiments of the hybrid powertrain, a chain connection is configured to couple the second rotatable shaft to the second clutch.

In some embodiments of the hybrid powertrain, a step gear connection is configured to couple the second rotatable shaft to the second clutch.

In some embodiments of the hybrid powertrain, a first inverter is in electrical communication with the first motor-generator.

In some embodiments of the hybrid powertrain, a second inverter is in electrical communication with the second motor-generator.

In some embodiments of the hybrid powertrain, a battery is in electrical communication with the first inverter and the second inverter.

In some embodiments of the hybrid powertrain, the second clutch is configured to selectively engage the sun assembly and the second traction ring.

Turning now to FIG. 82; in some embodiments a hybrid powertrain 50 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 50 has a first rotatable shaft 51 operably coupled to the ICE 11. A plahetary gear set 52 (PC) is arranged coaxially with the first rotatable shaft 51. The planetary gear set 52 has a planetary carrier 53, a sun gear 54, and a ring gear 55. In some embodiments, a first clutch 56 (CL1) is configured to couple to the first rotatable shaft 51. The first clutch 56 is coupled to the ring gear 55. The hybrid powertrain 50 includes a second rotatable shaft 57 coupled to the sun gear 54. The second rotatable shaft 57 is coaxial with the first rotatable shaft 51. The first motor-generator 12 is coupled to the second rotatable shaft 57.

In some embodiments, the hybrid powertrain 50 is provided with a third rotatable shaft 58 coaxial with a fourth rotatable shaft 59. The third rotatable shaft 58 and the fourth rotatable shaft 59 are substantially parallel to the second rotatable shaft 57. The variator 17 is coaxial with the third rotatable shaft 58 and the fourth rotatable shaft 59. The third rotatable shaft 58 is coupled to the first traction ring (R1). The fourth rotatable shaft 59 is coupled to the sun assembly (S). A second clutch 60 (CL2) is arranged coaxially on the fourth rotatable shaft 59. In some embodiments, a first gear set 61 is configured to couple the planet carrier 53 to the third rotatable shaft 58. The hybrid powertrain 50 has a second gear set 62. The second gear set 62 is coupled to the second rotatable shaft 57 and the second clutch 60. A third gear set 63 is operably coupled to the second traction ring (R2). The third gear set 63 is coupled to a fifth rotatable shaft 64. The fifth rotatable shaft 64 is aligned substantially parallel to the fourth rotatable shaft 59. The second motor-generator 13 is coupled to the fifth rotatable shaft 64. The second motor-generator 13 is operably coupled to a final drive gear 65. A brake clutch 66 (CB1) is coupled to the carrier assembly (C).

During operation of the hybrid powertrain 50, power is transmitted in at least two modes of operation. A first mode of operation is established when the second clutch 60 is engaged and the brake clutch 66 is not applied, in other words, the carrier assembly (C) is free to rotate. In the first mode of operation the variator 17 functions as a differential element. Disengagement of the first clutch 56 and the second clutch 60 in unison with the application of the brake clutch 66 to ground the carrier assembly (C) provides a transition to a second mode of operation. In the second mode of operation, the first clutch 56 is engaged and the variator 17 functions as a mechanical transmission.

Provided herein is a hybrid powertrain including a first rotatable shaft operably coupleable to a source of rotational power; a second rotatable shaft aligned substantially coaxial to the first rotatable shaft, the first rotatable shaft and the second rotatable shaft forming a main axis; a third rotatable shaft aligned substantially parallel to the main axis; a fourth rotatable shaft aligned coaxially with the third rotatable shaft; a fifth rotatable shaft aligned substantially parallel to the main axis; a variator assembly having a first traction ring and a second traction ring in contact with a plurality of traction planets, each traction planet having a tiltable axis of rotation, each traction planet supported in a carrier assembly, each traction planet in contact with a sun assembly; wherein the variator assembly is coaxial with the third rotatable shaft; wherein the first traction ring is operably coupled to the third rotatable shaft; wherein the sun assembly is coupled to the fourth rotatable shaft; a planetary gearset having a planet carrier, a sun gear, and a ring gear, the planetary gearset coaxial with the second rotatable shaft, the second rotatable shaft coupled to the sun gear; a first motor-generator positioned coaxially with the second rotatable shaft; a second motor-generator positioned coaxially with the fifth rotatable shaft, the second motor-generator operably coupled to the second traction ring; a first clutch operably coupled to the first rotatable shaft, the first clutch coupled to the ring gear; a second clutch coupled to the fourth rotatable shaft, the second clutch operably coupled to the first motor-generator; and a brake clutch operably coupled to the carrier assembly. In some embodiments of the hybrid powertrain, a first gear set is configured to couple the planet carrier to the third rotatable shaft. In some embodiments of the hybrid powertrain, a second gear set is configured to couple the first motor-generator to the second clutch. In some embodiments of the hybrid powertrain, a third gear set is configured to couple the second traction ring to the fifth rotatable shaft. In some embodiments of the hybrid powertrain, a first inverter is in electrical communication with the first motor-generator. In some embodiments of the hybrid powertrain, a second inverter is in electrical communication with the second motor-generator. In some embodiments of the hybrid powertrain, a battery is in electrical communication with the first inverter and the second inverter. In some embodiments of the hybrid powertrain, a final drive gear is operably coupled to the second motor-generator.

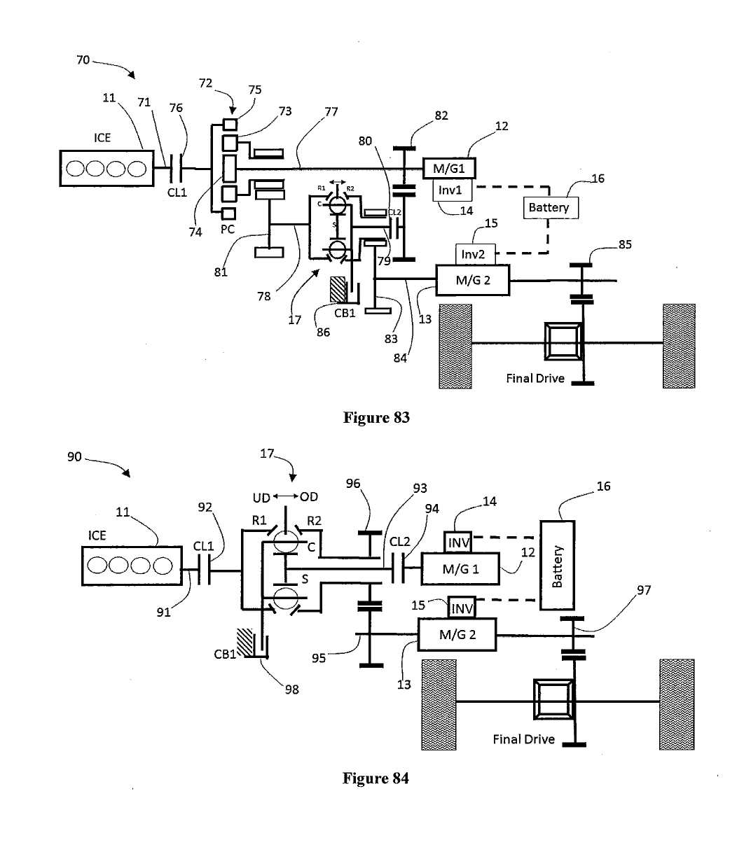

Referring now to FIG. 83; in some embodiments, a hybrid powertrain 70 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 70 has a first rotatable shaft 71 operably coupled to the ICE 11. A planetary gear set 72 is arranged coaxially with the first rotatable shaft 71. The planetary gear set 72 has a planetary carrier 73, a sun gear 74, and a ring gear 75. In some embodiments, a first clutch 76 (CL1) is configured to couple to the first rotatable shaft 71. The first clutch 76 is coupled to the ring gear 75. The hybrid powertrain 70 includes a second rotatable shaft 77 coupled to the sun gear 74. The second rotatable shaft 77 is coaxial with the first rotatable shaft 71. The first motor-generator 12 is coupled to the second rotatable shaft 77.

In some embodiments, the hybrid powertrain 70 is provided with a third rotatable shaft 78 coaxial with a fourth rotatable shaft 79. The third rotatable shaft 78 and the fourth rotatable shaft 79 are substantially parallel to the second rotatable shaft 77. The variator 17 is coaxial with the third rotatable shaft 78 and the fourth rotatable shaft 79. The third rotatable shaft 78 is coupled to the first traction ring (R1). The fourth rotatable shaft 79 is coupled to the carrier assembly (C). A second clutch 80 (CL2) is arranged coaxially on the fourth rotatable shaft 79. In some embodiments, a first gear set 81 is configured to couple the planet carrier 73 to the third rotatable shaft 78. The hybrid powertrain 70 has a second gear set 82. The second gear set 82 is coupled to the second rotatable shaft 77 and the second clutch 80. A third gear set 83 is operably coupled to the second traction ring (R2). The third gear set 83 is coupled to a fifth rotatable shaft 84. The fifth rotatable shaft 84 is aligned substantially parallel to the fourth rotatable shaft 79. The second motor-generator 13 is coupled to the fifth rotatable shaft 84. The second motor-generator 13 is operably coupled to a final drive gear 85. A brake clutch 86 (CB1) is coupled to the carrier assembly (C).

During operation of the hybrid powertrain 70, power is transmitted in at least two modes of operation. A first mode of operation is established when the brake clutch 86 is not applied, in other words, the carrier assembly (C) is free to rotate. In the first mode of operation the variator 17 functions as a differential element. Disengagement of the first clutch 76 and the second clutch 80 in unison with the application of the brake clutch 86 to ground the carrier assembly (C) provides a transition to a second mode of operation. In the second mode of operation, the first clutch 76 is engaged, the brake clutch 86 is applied, and the variator 17 functions as a mechanical transmission.

Provided herein is a hybrid powertrain including a first rotatable shaft operably coupleable to a source of rotational power; a second rotatable shaft aligned substantially coaxial to the first rotatable shaft, the first rotatable shaft and the second rotatable shaft forming a main axis; a third rotatable shaft aligned substantially parallel to the main axis; a fourth rotatable shaft aligned coaxially with the third rotatable shaft; a fifth rotatable shaft aligned substantially parallel to the main axis; a variator assembly having a first traction ring and a second traction ring in contact with a plurality of traction planets, each traction planet having a tiltable axis of rotation, each traction planet supported in a carrier assembly, each traction planet in contact with a sun assembly; wherein the variator assembly is coaxial with the third rotatable shaft; wherein the first traction ring is operably coupled to the third rotatable shaft; wherein the carrier assembly is coupled to the fourth rotatable shaft; a planetary gearset having a planet carrier, a sun gear, and a ring gear, the planetary gearset coaxial with the second rotatable shaft, the second rotatable shaft coupled to the sun gear; a first motor-generator positioned coaxially with the second rotatable shaft; a second motor-generator positioned coaxially with the fifth rotatable shaft, the second motor-generator operably coupled to the second traction ring; a first clutch operably coupled to the first rotatable shaft, the first clutch coupled to the ring gear; a second clutch coupled to the fourth rotatable shaft, the second clutch operably coupled to the first motor-generator; and a brake clutch operably coupled to the carrier assembly. In some embodiments of the hybrid powertrain, a first gear set is configured to couple the planet carrier to the third rotatable shaft. In some embodiments of the hybrid powertrain, a second gear set is configured to couple the second rotatable shaft to the second clutch. In some embodiments of the hybrid powertrain, a third gear set is configured to couple the second traction ring to the fifth rotatable shaft. In some embodiments of the hybrid powertrain, a first inverter is in electrical communication with the first motor-generator. In some embodiments of the hybrid powertrain, a second inverter is in electrical communication with the second motor-generator. In some embodiments of the hybrid powertrain, a battery is in electrical communication with the first inverter and the second inverter. In some embodiments of the hybrid powertrain, a final drive gear is operably coupled to the second motor-generator.

Turning now to FIG. 84; in some embodiments, a hybrid powertrain 90 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 90 has a first rotatable shaft 91 operably coupled to the ICE 11. A first clutch 92 (CL1) is coupled to the first rotatable shaft 91. The first clutch 92 is coupled to the first traction ring (R1). The variator 17 is arranged coaxially with the first rotatable shaft 91. The hybrid powertrain 90 includes a second rotatable shaft 93 coupled to the sun assembly (S). The second rotatable shaft 93 is coaxial with the first rotatable shaft 91. A second clutch 94 (CL2) is coupled to the second rotatable shaft 93. The second clutch 94 is operably coupled to the first motor-generator 12. In some embodiments, the hybrid powertrain 90 includes a third rotatable shaft 95 arranged substantially parallel to the second rotatable shaft 93. A gear set 96 couples the second rotatable shaft 93 to the third rotatable shaft 95. The third rotatable shaft 95 is coupled to the second motor-generator 13. The second motor-generator 13 is coupled to a final drive gear 97. A first brake clutch 98 (CB1) is provided to selectively couple the carrier assembly (C) to ground.

During operation of the hybrid powertrain 90, power is transmitted in at least two modes of operation. A first mode of operation is established when the second clutch 94 is engaged and the brake 98 is not applied, in other words, the carrier assembly (C) is free to rotate. In the first mode of operation the variator 17 functions as a differential element. Disengagement of the first clutch 92 and the second clutch 94 in unison with the application of the first brake clutch 98, to thereby ground the carrier assembly (C), provides a transition to a second mode of operation. In the second mode of operation, the first clutch 92 is engaged, the brake clutch 98 (CB1) is applied to the carrier assembly (C), and the variator 17 functions as a mechanical transmission.

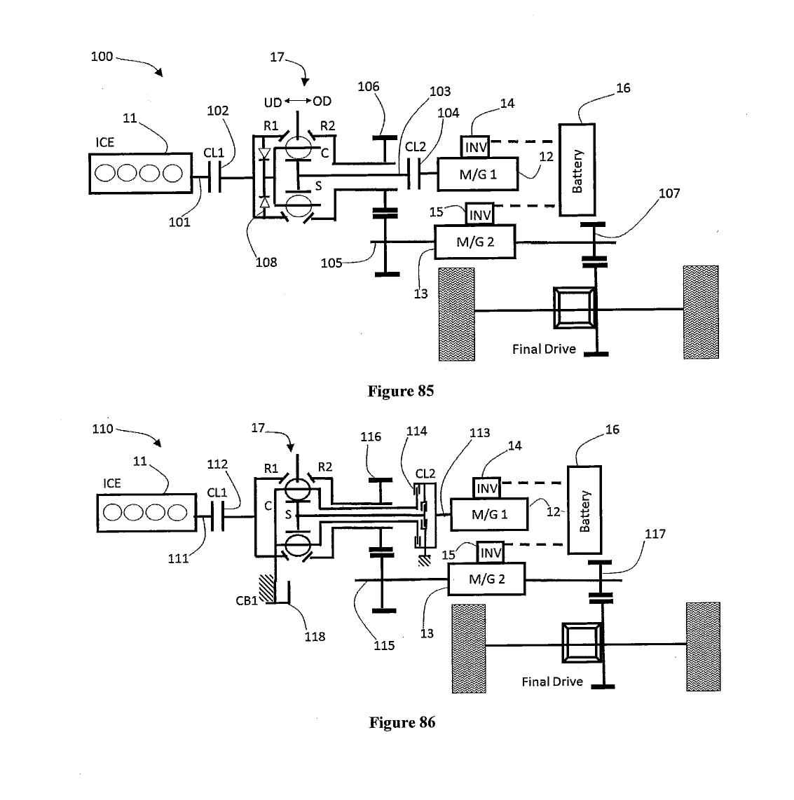

Referring now to FIG. 85; in some embodiments, a hybrid powertrain 100 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 100 has a first rotatable shaft 101 operably coupled to the ICE 11. A first clutch 102 (CL1) is coupled to the first rotatable shaft 101. The first clutch 102 is coupled to the first traction ring (R1). The variator 17 is arranged coaxially with the first rotatable shaft 101. The hybrid powertrain 100 includes a second rotatable shaft 103 coupled to the sun assembly (S). The second rotatable shaft 103 is coaxial with the first rotatable shaft 101. A second clutch 104 (CL2) is coupled to the second rotatable shaft 103. The second clutch 104 is operably coupled to the first motor-generator 12. In some embodiments, the hybrid powertrain 100 includes a third rotatable shaft 105 arranged substantially parallel to the second rotatable shaft 103. A gear set 106 couples the second traction ring (R2) to the third rotatable shaft 105. The third rotatable shaft 105 is coupled to the second motor-generator 13. The second motor-generator 13 is coupled to a final drive gear 107. A one-way clutch 108 is provided to couple the first traction ring (R1) to the carrier assembly (C).

During operation of the hybrid powertrain 100, power is transmitted in at least two modes of operation. A first mode of operation is established when the first clutch 102 and the second clutch 104 are engaged. In the first mode of operation the variator 17 functions as a differential element. In the second mode of operation, the first clutch 102 is engaged and the variator 17 functions as a mechanical transmission. The one-way clutch 108 is configured to maintain a speed relationship between the first traction ring (R1) and the carrier assembly (C). In some embodiments, the one-way clutch 108 is configured so that the speed of the first traction ring (R1) is always greater than or equal to the speed of the carrier assembly (C). In some embodiments, the one-way clutch 108 is configured so that the speed of the first traction ring (R1) is always less than or equal to the speed of the carrier assembly (C).

Passing now to FIG. 86; in some embodiments a hybrid powertrain 110 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 110 has a first rotatable shaft 111 operably coupled to the ICE 11. A first clutch 112 (CL1) is coupled to the first rotatable shaft 111. The first clutch 112 is coupled to the first traction ring (R1). The variator 17 is arranged coaxially with the first rotatable shaft 111. The hybrid powertrain 110 includes a second rotatable shaft 113 coupled to the first motor-generator 12. The second rotatable shaft 113 is coaxial with the first rotatable shaft 111. A second clutch 114 (CL2) is coupled to the second rotatable shaft 113. The second clutch 114 is configured to selectively engage the carrier assembly (C) and the sun assembly (S). In some embodiments, the second clutch 114 is configured to provide a brake to the disengaged element. For example, when the sun assembly (S) is engaged by the second clutch 114, the carrier assembly (C) is grounded. When the carrier assembly (C) is engaged by the second clutch 114, the sun assembly (S) is grounded. In some embodiments, the hybrid powertrain 110 includes a third rotatable shaft 115 arranged substantially parallel to the second rotatable shaft 113. A gear set 116 couples the second traction ring (R2) to the third rotatable shaft 115. The third rotatable shaft 115 is coupled to the second motor-generator 13. The second motor-generator 13 is coupled to a final drive gear 117. A first brake clutch 118 (CB1) is provided to selectively ground the carrier assembly (C).

During operation of the hybrid powertrain 110, power is transmitted in at least two modes of operation. A first mode of operation is established when the first brake clutch 118 is not applied, in other words, the carrier assembly (C) is free to rotate. In the first mode of operation the variator 17 functions as a differential element. Disengagement of the first clutch 112 and the second clutch 114 in unison with the application of the brake 118, to thereby ground the carrier assembly (C), provides a transition to a second mode of operation. In the second mode of operation, the first brake clutch 118 is applied, and the variator 17 functions as a mechanical transmission. The second clutch 114 can be controlled to modulate the selectively coupled carrier assembly (C) and the sun assembly (S) to provide the desired operating conditions for the first motor-generator 12.

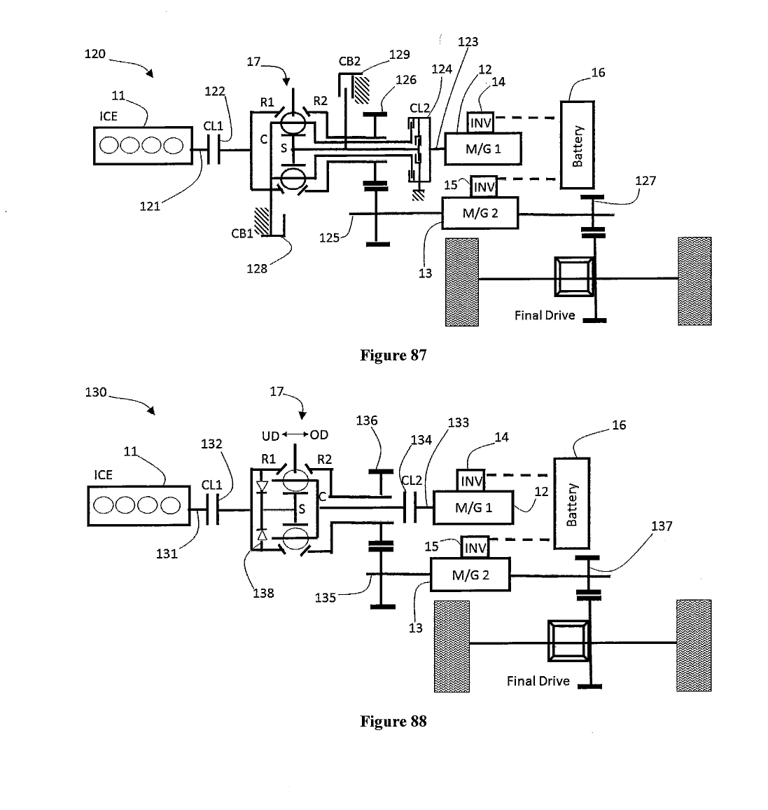

Referring now to FIG. 87; in some embodiments a hybrid powertrain 120 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 120 has a first rotatable shaft 121 operably coupled to the ICE 11. A first clutch 122 (CL1) is coupled to the first rotatable shaft 121. The first clutch 122 is coupled to the first traction ring (R1). The variator 17 is arranged coaxially with the first rotatable shaft 121. The hybrid powertrain 120 includes a second rotatable shaft 123 coupled to the first motor-generator 12. The second rotatable shaft 123 is coaxial with the first rotatable shaft 121. A second clutch 124 (CL2) is coupled to the second rotatable shaft 123. The second clutch 124 is configured to selectively engage the carrier assembly (C) and the sun assembly (S).). In some embodiments, the second clutch 124 is configured to provide a brake to the disengaged element. For example, when the sun assembly (S) is engaged by the second clutch 124, the carrier assembly (C) is grounded. When the carrier assembly (C) is engaged by the second clutch 124, the sun assembly (S) is grounded. In some embodiments, the hybrid powertrain 120 includes a third rotatable shaft 125 arranged substantially parallel to the second rotatable shaft 123. A gear set 126 couples the second traction ring (R2) to the third rotatable shaft 125. The third rotatable shaft 125 is coupled to the second motor-generator 13. The second motor-generator 13 is coupled to a final drive gear 127. A first brake clutch 128 (CB1) is provided to selectively ground the carrier assembly (C). A second brake clutch 129 (CB2) is provided to selectively ground the sun assembly (S).

During operation of the hybrid powertrain 120, power is transmitted in at least two modes of operation. A first mode of operation is established when the first brake clutch 128 is not applied, in other words, the carrier assembly (C) is free to rotate, and the second brake clutch 129 is applied to the sun assembly (S). In the first mode of operation the variator 17 functions as a differential element. Disengagement of the first clutch 122 and the second clutch 124 in unison with the application of the first brake clutch 128, to thereby ground the carrier assembly (C), and the release of the second brake clutch 129, provides a transition to a second mode of operation. In the second mode of operation, the first clutch 122 is engaged, the second clutch 124 is engaged to the sun assembly (S), the first brake clutch 128 is applied, and the variator 17 functions as a mechanical transmission.

Referring now to FIG. 88; in some embodiments, a hybrid powertrain 130 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 130 has a first rotatable shaft 131 operably coupled to the ICE 11. A first clutch 132 is coupled to the first rotatable shaft 131. The first clutch 132 (CL1) is coupled to the first traction ring (R1). The variator 17 is arranged coaxially with the first rotatable shaft 131. The hybrid powertrain 130 includes a second rotatable shaft 133 coupled to a second clutch 134 (CL2). The second rotatable shaft 133 is coaxial with the first rotatable shaft 131. The second clutch 134 is configured to selectively engage the carrier assembly (C). The second clutch 134 is operably coupled to the first motor-generator 12. In some embodiments, the hybrid powertrain 130 includes a third rotatable shaft 135 arranged substantially parallel to the second rotatable shaft 133. A gear set 136 couples the second traction ring (R2) to the third rotatable shaft 135. The third rotatable shaft 135 is coupled to the second motor-generator 13. The second motor-generator 13 is coupled to a final drive gear 137. A one-way clutch 138 is provided to couple the first traction ring (R1) to the sun assembly (S).

During operation of the hybrid powertrain 130, power is transmitted in at least two modes of operation. A first mode of operation is established when the first clutch 132 and the second clutch 134 are engaged. In the first mode of operation the variator 17 functions as a differential element. In the second mode of operation, the first clutch 132 is engaged and the variator 17 functions as a mechanical transmission. The one-way clutch 138 is configured to maintain a speed relationship between the first traction ring (R1) and the sun assembly (S). In some embodiments, the one-way clutch 138 is configured so that the speed of the first traction ring (R1) is always greater than or equal to the speed of the sun assembly (S). In some embodiments, the one-way clutch 138 is configured so that the speed of the first traction ring (R2) is always less than or equal to the speed of the sun assembly (S).

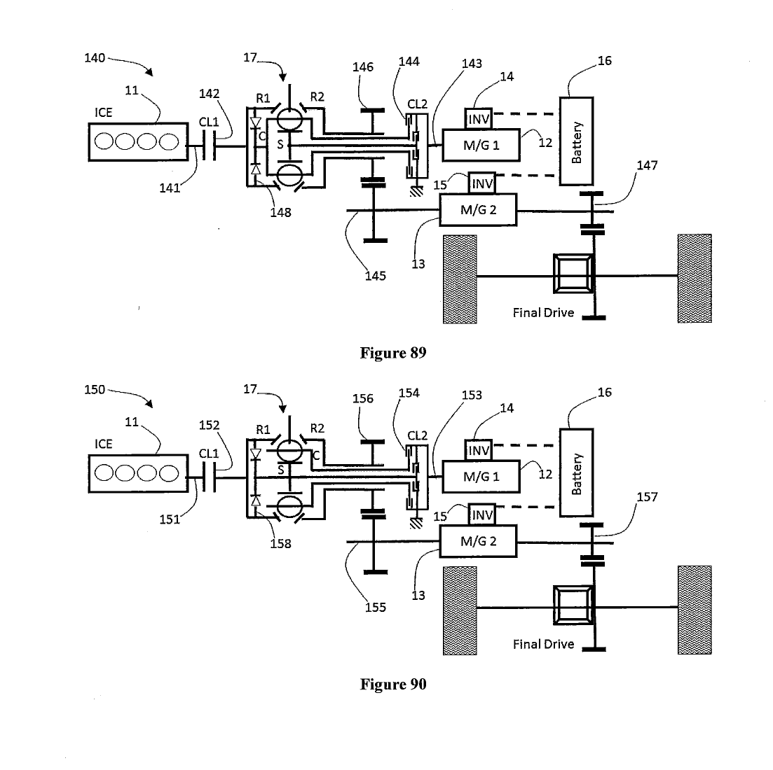

Referring now to FIG. 89; in some embodiments, a hybrid powertrain 140 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 140 has a first rotatable shaft 141 operably coupled to the ICE 11. A first clutch 142 is coupled to the first rotatable shaft 141. The first clutch 142 (CL1) is coupled to the first traction ring (R1). The variator 17 is arranged coaxially with the first rotatable shaft 141. The hybrid powertrain 140 includes a second rotatable shaft 143 coupled to a second clutch 144 (CL2). The second rotatable shaft 143 is coaxial with the first rotatable shaft 141. The second clutch 144 is configured to selectively engage the carrier assembly (C) and the sun assembly (S). The second clutch 144 is operably coupled to the first motor-generator 12. In some embodiments, the second clutch 144 is configured to provide a brake to the disengaged element. For example, when the sun assembly (S) is engaged by the second clutch 144, the carrier assembly (C) is grounded. When the carrier assembly (C) is engaged by the second clutch 144, the sun assembly (S) is grounded. In some embodiments, the hybrid powertrain 140 includes a third rotatable shaft 145 arranged substantially parallel to the second rotatable shaft 143. A gear set 146 couples the second traction ring (R2) to the third rotatable shaft 145. The third rotatable shaft 145 is coupled to the second motor-generator 13. The second motor-generator 13 is coupled to a final drive gear 147. A one-way clutch 148 is provided to couple the first traction ring (R1) to the carrier assembly (C).

During operation of the hybrid powertrain 140, power is transmitted in at least two modes of operation. A first mode of operation is established when the first clutch 142 and the second clutch 144 are engaged. In the first mode of operation the variator 17 functions as a differential element. In the second mode of operation, the first clutch 142 is engaged and the variator 17 functions as a mechanical transmission. The one-way clutch 148 is configured to maintain a speed relationship between the first traction ring (R1) and the carrier assembly (C). In some embodiments, the one-way clutch 148 is configured so that the speed of the first traction ring (R1) is always greater than or equal to the speed of the carrier assembly (C). In some embodiments, the one-way clutch 148 is configured so that the speed of the first traction ring (R2) is always less than or equal to the speed of the carrier assembly (C).

Referring now to FIG. 90; in some embodiments, a hybrid powertrain 150 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 150 has a first rotatable shaft 151 operably coupled to the ICE 11. A first clutch 152 is coupled to the first rotatable shaft 151. The first clutch 152 (CL1) is coupled to the first traction ring (R1). The variator 17 is arranged coaxially with the first rotatable shaft 151. The hybrid powertrain 150 includes a second rotatable shaft 153 coupled to a second clutch 154 (CL2). The second rotatable shaft 153 is coaxial with the first rotatable shaft 151. The second clutch 154 is configured to selectively engage the carrier assembly (C) and the sun assembly (S). The second clutch 154 is operably coupled to the first motor-generator 12. In some embodiments, the second clutch 154 is configured to provide a brake to the disengaged element. For example, when the sun assembly (S) is engaged by the second clutch 154, the carrier assembly (C) is grounded. When the carrier assembly (C) is engaged by the second clutch 154, the sun assembly (S) is grounded. In some embodiments, the hybrid powertrain 150 includes a third rotatable shaft 155 arranged substantially parallel to the second rotatable shaft 153. A gear set 156 couples the second traction ring (R2) to the third rotatable shaft 155. The third rotatable shaft 155 is coupled to the second motor-generator 13. The second motor-generator 13 is coupled to a final drive gear 157. A one-way clutch 158 is provided to couple the first traction ring (R1) to the sun assembly (S).

During operation of the hybrid powertrain 150, power is transmitted in at least two modes of operation. A first mode of operation is established when the first clutch 152 and the second clutch 154 is engaged. In the first mode of operation the variator 17 functions as a differential element. In the second mode of operation, the first clutch 152 is engaged and the variator 17 functions as a mechanical transmission. The one-way clutch 158 is configured to maintain a speed relationship between the first traction ring (R1) and the carrier assembly (C). In some embodiments, the one-way clutch 158 is configured so that the speed of the first traction ring (R1) is always greater than or equal to the speed of the sun assembly (S). In some embodiments, the one-way clutch 158 is configured so that the speed of the first traction ring (R2) is always less than or equal to the speed of the sun assembly (S).

Provided herein is a hybrid powertrain including a first rotatable shaft operably coupleable to a source of rotational power; a second rotatable shaft aligned substantially coaxial to the first rotatable shaft, the first rotatable shaft and the second rotatable shaft forming a main axis; a third rotatable shaft aligned substantially parallel to the main axis; a variator assembly having a first traction ring and a second traction ring in contact with a plurality of traction planets, each traction planet having a tiltable axis of rotation, each traction planet supported in a carrier assembly, each traction planet in contact with a sun assembly; wherein the variator assembly is coaxial with the main axis; wherein the second traction ring is operably coupled to the third rotatable shaft; wherein the sun assembly is coupled to the second rotatable shaft; a first motor-generator positioned coaxially with the second rotatable shaft; a second motor-generator positioned coaxially with the third rotatable shaft; a first clutch operably coupled to the first rotatable shaft, the first clutch coupled to the first traction ring; a second clutch coupled to the second rotatable shaft, the second clutch coupled to the first motor-generator; and a first brake clutch operably coupled to the carrier assembly. In some embodiments of the hybrid powertrain, a gear set configured is to couple the second traction ring to the third rotatable shaft. In some embodiments of the hybrid powertrain, a first inverter is in electrical communication with the first motor-generator. In some embodiments of the hybrid powertrain, a second inverter is in electrical communication with the second motor-generator. In some embodiments of the hybrid powertrain, a battery is in electrical communication with the first inverter and the second inverter. In some embodiments of the hybrid powertrain, a final drive gear is operably coupled to the second motor-generator. In some embodiments of the hybrid powertrain, a one-way clutch is configured to couple the first traction ring and the carrier assembly. In some embodiments of the hybrid powertrain, the second clutch is a two position clutch configured to selectively couple to the carrier assembly and the sun assembly to the second rotatable shaft. In some embodiments of the hybrid powertrain, a second brake operably coupled to the second rotatable shaft. In some embodiments of the hybrid powertrain, a one-way clutch configured to couple the first traction ring to the sun assembly. In some embodiments of the hybrid powertrain, a one-way clutch is configured to couple the first traction ring to the carrier assembly. In some embodiments of the hybrid powertrain, a one-way clutch is a one-way clutch configured to couple the first traction ring to the sun assembly.

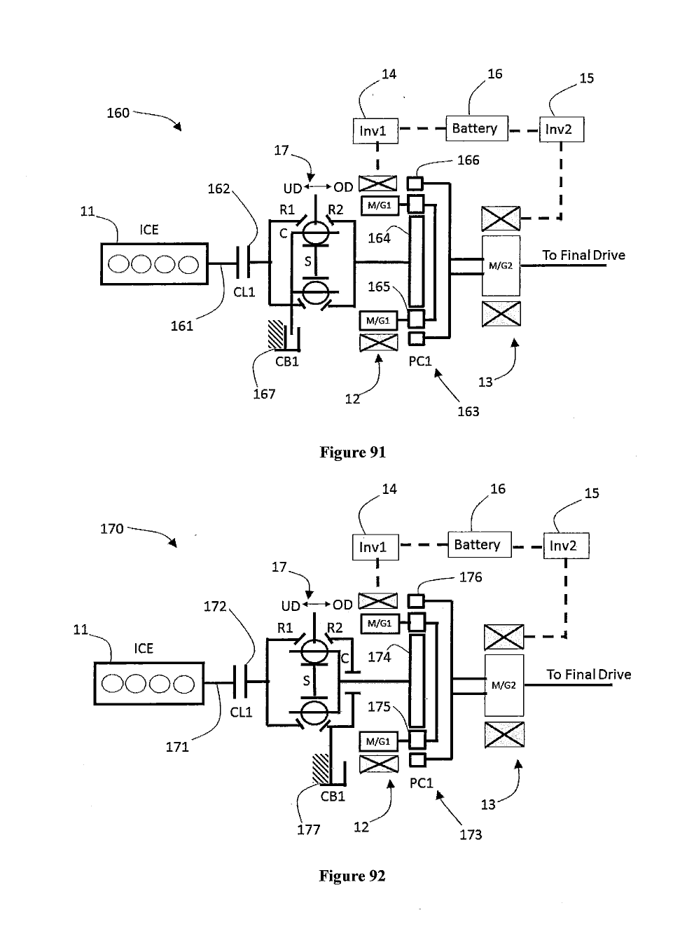

Turning now to FIG. 91; in some embodiments a hybrid powertrain 160 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 160 has a first rotatable shaft 161 operably coupled to the ICE 11. A first clutch 162 is coupled to the first rotatable shaft 161. The first clutch 162 (CL1) is coupled to the first traction ring (R1). The variator 17 is arranged coaxially with the first rotatable shaft 161. In some embodiments, the hybrid powertrain 160 includes a planetary gear set 163 (PC1) arranged coaxially with the first rotatable shaft 161. In some embodiments, the planetary gear set 163 (PC1) is a simple planetary. In some embodiments, the planetary gear set 163 (PCI) is a compound planetary. The planetary gear set 163 includes a sun gear 164, a planet carrier 165, and a ring gear 166. The sun gear 164 is operably coupled to the second traction ring (R2). The planet carrier 165 is operably coupled to the first motor-generator 12. The ring gear 166 is operably coupled to the second motor-generator 13. In some embodiments, the hybrid powertrain 160 is provided with a brake clutch 167 (CB1) operably coupled to the carrier assembly (C). In some embodiments, the brake clutch 167 is optionally provided to couple to the planetary gear set 163 (PC1) to facilitate the coupling of any element of the planetary gear set 163 (PC1) to a ground member or to couple two elements of the planetary gear set 163 (PC1) to each other. In some embodiments, the sun assembly (S) is configured to rotate freely without transferring power. In other embodiments, the sun assembly (S) is configured to transfer rotational power to component of the hybrid powertrain 160.

During operation of the hybrid powertrain 160, power is transmitted in at least two modes of operation. A first mode of operation is established as the variator 17 is used as a differential element as is the planetary gear set 163 (PC1) when the carrier assembly (C) is free to rotate. In other words, the first mode of operation corresponds to a disengaged position of the brake clutch 167. A second mode of operation is established as the variator 17 is used as a mechanical transmission when the brake clutch 167 is applied to ground the carrier assembly (C).

Provided herein is a hybrid powertrain including: a first rotatable shaft operably coupleable to a source of rotational power, the first rotatable shaft forming a main axis; a variator assembly having a first traction ring and a second traction ring in contact with a plurality of traction planets, each traction planet having a tiltable axis of rotation, each traction planet supported in a carrier assembly, each traction planet in contact with a sun assembly; wherein the variator assembly is coaxial with the main axis; a planetary gearset having a planet carrier, a sun gear, and a ring gear, the planetary gearset coaxial with the main axis; wherein the second traction ring is operably coupled to the sun gear; a first motor-generator positioned coaxially with the main axis, the first motor/generator operably coupled to the planet carrier; a second motor-generator positioned coaxially with the main axis, the second motor-generator coupled to the ring gear; a first clutch operably coupled to the first rotatable shaft, the first clutch coupled to the first traction ring; and a brake clutch operably coupled to the carrier assembly. In some embodiments of the hybrid powertrain, the brake clutch is configured to selectively couple the carrier assembly to a grounded member. In some embodiments of the hybrid powertrain, a first mode of operation corresponds to a disengaged position of the brake clutch. In some embodiments of the hybrid powertrain, a second mode of operation corresponds to an engaged position of the brake clutch.

Referring now to FIG. 92; in some embodiments a hybrid powertrain 170 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 170 has a first rotatable shaft 171 operably coupled to the ICE 11. A first clutch 172 is coupled to the first rotatable shaft 171. The first clutch 172 (CL1) is coupled to the first traction ring (R1). The variator 17 is arranged coaxially with the first rotatable shaft 171. In some embodiments, the hybrid powertrain 170 includes a planetary gear set 173 (PC1) arranged coaxially with the first rotatable shaft 171. In some embodiments, the planetary gear set 173 (PC1) is a simple planetary. In some embodiments, the planetary gear set 173 (PCI) is a compound planetary. The planetary gear set 173 (PC1) includes a sun gear 174, a planet carrier 175, and a ring gear 176. The sun gear 174 is operably coupled to the carrier assembly (C). The planet carrier 175 is operably coupled to the first motor-generator 12. The ring gear 176 is operably coupled to the second motor-generator 13. In some embodiments, the hybrid powertrain 170 is provided with a brake clutch 177 (CB1) operably coupled to the second traction ring (R2). In some embodiments, the brake clutch 177 is optionally provided to couple to the planetary gear set 173 (PC1) to facilitate the coupling of any element of the planetary gear set 173 (PC1) to a ground member or to couple two elements of the planetary gear set 173 (PC1) to each other. In some embodiments, the sun assembly (S) is configured to rotate freely without transferring power. In other embodiments, the sun assembly (S) is configured to transfer rotational power to component of the hybrid powertrain 170.

During operation of the hybrid powertrain 170, power is transmitted in at least two modes of operation. A first mode of operation is established as the variator 17 is used as a differential element as is the planetary gear set 173 when the carrier assembly (C) is free to rotate. In other words, the first mode of operation corresponds to a disengaged position of the brake clutch 177. A second mode of operation is established as the variator 17 is used as a mechanical transmission when the brake clutch 177 is applied to ground the carrier assembly (C).

Provided herein is a hybrid powertrain including: a first rotatable shaft operably coupleable to a source of rotational power, the first rotatable shaft forming a main axis; a variator assembly having a first traction ring and a second traction ring in contact with a plurality of traction planets, each traction planet having a tiltable axis of rotation, each traction planet supported in a carrier assembly, each traction planet in contact with a sun assembly; wherein the variator assembly is coaxial with the main axis; a planetary gearset having a planet carrier, a sun gear, and a ring gear, the planetary gearset coaxial with the main axis; wherein the carrier assembly is operably coupled to the sun gear; a first motor-generator positioned coaxially with the main axis, the first motor/generator operably coupled to the planet carrier; a second motor-generator positioned coaxially with the main axis, the second motor-generator coupled to the ring gear; a first clutch operably coupled to the first rotatable shaft, the first clutch coupled to the first traction ring; and a brake clutch operably coupled to the second traction ring. In some embodiments of the hybrid powertrain, the brake clutch is configured to selectively couple the carrier assembly to a grounded member. In some embodiments of the hybrid powertrain, a first mode of operation corresponds to a disengaged position of the brake clutch. In some embodiments of the hybrid powertrain, a second mode of operation corresponds to an engaged position of the brake clutch.

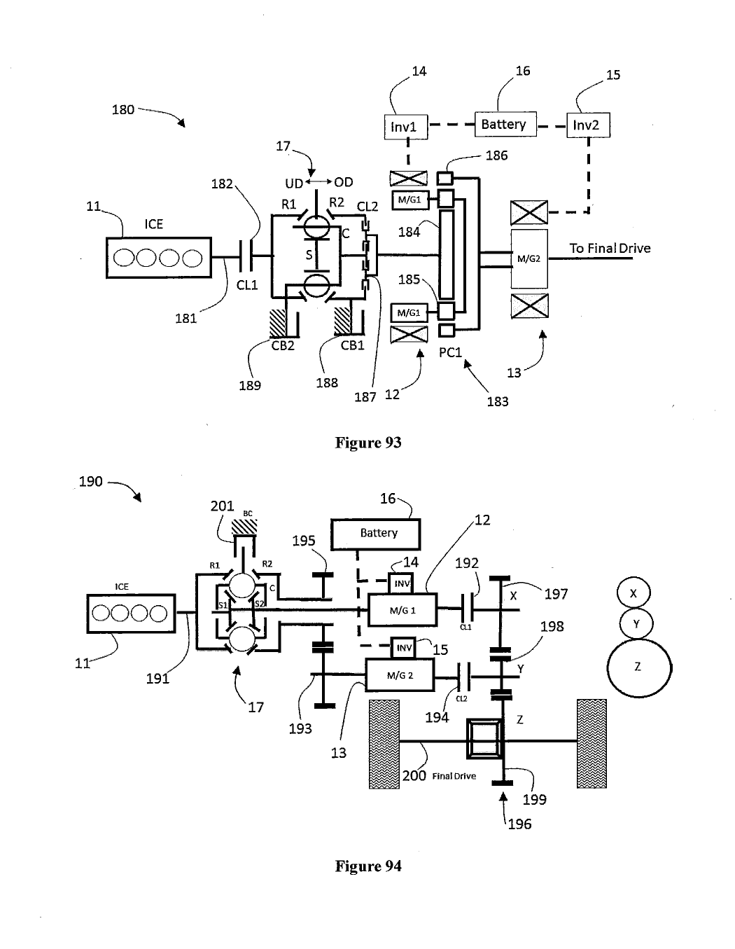

Referring now to FIG. 93; in some embodiments a hybrid powertrain 180 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 180 has a first rotatable shaft 181 operably coupled to the ICE 11. A first clutch 182 is coupled to the first rotatable shaft 181. The first clutch 182 (CL1) is coupled to the first traction ring (R1). The variator 17 is arranged coaxially with the first rotatable shaft 181. In some embodiments, the hybrid powertrain 180 includes a planetary gear set 183 (PC1) arranged coaxially with the first rotatable shaft 181. In some embodiments, the planetary gear set 183 (PC1) is a simple planetary. In some embodiments, the planetary gear set 183 (PCI) is a compound planetary. The planetary gear set 183 (PC1) includes a sun gear 184, a planet carrier 185, and a ring gear 186. The sun gear 184 is operably coupled to a second clutch 187 (CL2). In some embodiments, the second clutch 187 is configured to selectively engage the carrier assembly (C) and the second traction ring (R2). The planet carrier 185 is operably coupled to the first motor-generator 12. The ring gear 186 is operably coupled to the second motor-generator 13. In some embodiments, the hybrid powertrain 180 is provided with a first brake clutch 188 (CB1) operably coupled to the second traction ring (R2). A second brake clutch 189 (CB2) is operably coupled to the carrier assembly (C). In some embodiments, the first brake clutch 188 is optionally provided to couple to the planetary gear set 183 (PC1) to facilitate the coupling of any element of the planetary gear set 183 (PC1) to a ground member or to couple two elements of the planetary gear set 183 (PC1) to each other. In some embodiments, the sun assembly (S) is configured to rotate freely without transferring power. In other embodiments, the sun assembly (S) is configured to transfer rotational power to component of the hybrid powertrain 180.

During operation of the hybrid powertrain 180, power is transmitted in at least two modes of operation. A first mode of operation is established as the variator 17 is used as a differential element as is the planetary gear set 183. In the first mode of operation, the second clutch 187 (CL2) is engaged to the second traction ring, the first brake clutch 188 (CB1) is not applied, the second brake clutch 189 (CB2) is applied to the carrier assembly (C). A second mode of operation is established when the second brake clutch 189 (CB2) is not applied, the first brake clutch 188 (CB1) is applied to ground the second traction ring (R2), and the second clutch 187 is engaged to the carrier assembly (C).

Provided herein is a hybrid powertrain including: a first rotatable shaft operably coupleable to a source of rotational power, the first rotatable shaft forming a main axis; a variator assembly having a first traction ring and a second traction ring in contact with a plurality of traction planets, each traction planet having a tiltable axis of rotation, each traction planet supported in a carrier assembly, each traction planet in contact with a sun assembly; wherein the variator assembly is coaxial with the main axis; a planetary gearset having a planet carrier, a sun gear, and a ring gear, the planetary gearset coaxial with the main axis; wherein the carrier assembly is operably coupled to the sun gear; a first motor-generator positioned coaxially with the main axis, the first motor/generator operably coupled to the planet carrier; a second motor-generator positioned coaxially with the main axis, the second motor-generator coupled to the ring gear; a first clutch operably coupled to the first rotatable shaft, the first clutch coupled to the first traction ring; a second clutch operably coupled to the sun gear; a first brake clutch operably coupled to the second traction ring; and a second brake clutch operably coupled to the carrier assembly. In some embodiments of the hybrid powertrain, the second clutch is configured to selectively engage the second traction ring and the carrier assembly.

Provided herein is any configuration of hybrid powertrain described herein, wherein the variator includes a traction fluid.

Provided herein is a vehicle including any configuration of hybrid powertrain described herein.

Provided herein is a method including providing a hybrid powertrain of any of the configurations described herein.

Provided herein is a method of providing a vehicle including any configuration of hybrid powertrain described herein.

Referring now to FIG. 94; in some embodiments a hybrid powertrain 190 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 190 has a first rotatable shaft 191 operably coupled to the ICE 11. The first rotatable shaft 191 forms a main axis of the hybrid powertrain 190. The variator 17 and the first motor-generator 12 are arranged along the main axis and are coaxial with the first rotatable shaft 191. The ICE 11 is operably coupled to the first traction ring (R1). A first clutch 192 is coupled to the first motor-generator 12. The hybrid powertrain 190 includes a second rotatable shaft 193 arranged substantially parallel to the first rotatable shaft 191. The second rotatable shaft 193 forms a counter axis of the hybrid powertrain 190. The second motor-generator 13 is positioned on the second rotatable shaft 193. The hybrid powertrain 190 includes a second clutch 194. The second clutch 194 is coupled to the second motor-generator 13. A first gear set 195 is configured to operably couple the second rotatable shaft 193 to the second traction ring (R2). A final drive gear set 196 is configured to operably couple to the main axis and the counter axis. The final drive gear 196 includes a first gear 197 (X), a second gear 198 (Y), and a third gear 199 (Z). The first gear 197 (X) is operably coupled to the first clutch 192. The second gear 198 (Y) is operably coupled to the second clutch 198 (Y). The third gear 199 (Z) is operably coupled to a drive axle 200. In some embodiments, the first gear 197 (X) is coupled to the second gear 198 (Y), and the second gear 198 (Y) is coupled to the third gear 199 (Z). The hybrid powertrain 190 includes a brake 201 operably coupled to the carrier assembly (C).

During operation of the hybrid powertrain 190, power is transmitted in at least two modes of operation. A first mode of operation is established as the variator 17 is used as a differential element when the carrier assembly (C) is free to rotate. In other words, the first mode of operation corresponds to a disengaged position of the brake 201. A second mode of operation is established as the variator 17 is used as a mechanical transmission when the brake 201 is applied to ground the carrier assembly (C).

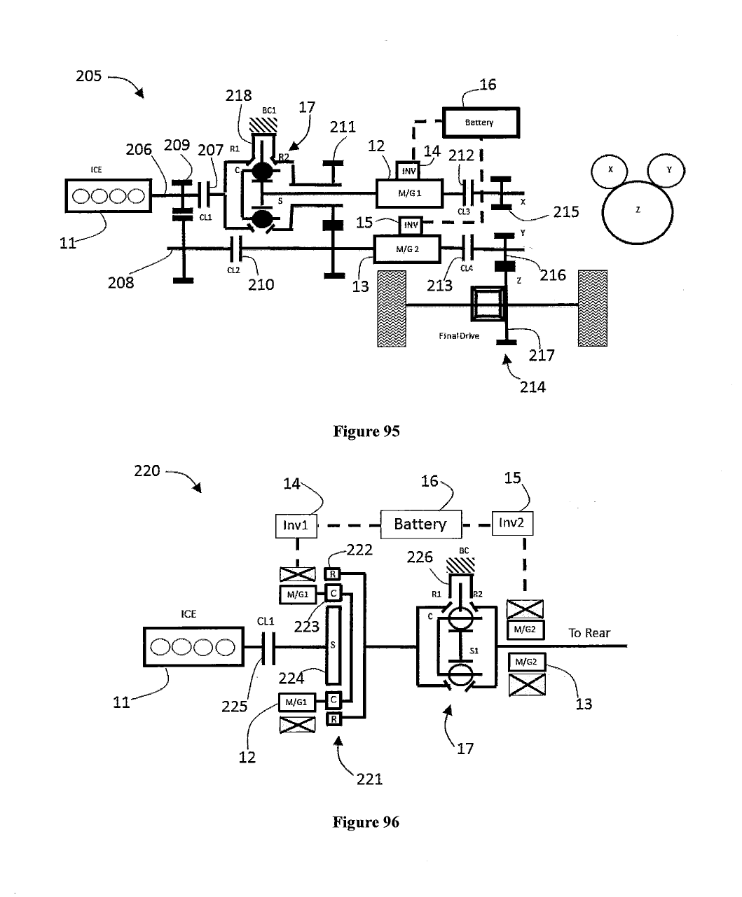

Referring now to FIG. 95; in some embodiments, a hybrid powertrain 205 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 205 has a first rotatable shaft 206 operably coupled to the ICE 11. The first rotatable shaft 206 forms a main axis of the hybrid powertrain 205. The variator 17 and the first motor-generator 12 are arranged along the main axis and are coaxial with the first rotatable shaft 206. The hybrid powertrain 205 includes a first clutch 207 (CL1) arranged on the first rotatable shaft 206. The first clutch 207 is coupled to the first traction ring (R1). The hybrid powertrain 205 includes a second rotatable shaft 208 arranged substantially parallel to the main axis. The second rotatable shaft 208 forms a counter axis of the hybrid powertrain 205. The second motor-generator 13 is arranged coaxial with the second rotatable shaft 208 along the counter axis. A first gear set 209 couples the first rotatable shaft 206 to the second rotatable shaft 208. The hybrid powertrain 205 includes a second clutch 210 coaxial with and coupled to the second rotatable shaft 208. A second gear set 211 is operably coupled to the counter axis and the second traction ring (R2). In some embodiments, the hybrid powertrain 205 includes a third clutch 212 arranged along the main axis. The third clutch 212 is operably coupled to the first motor-generator 12. The hybrid powertrain 205 includes a fourth clutch 213 arranged along the counter axis. The fourth clutch 213 is operably coupled to the second motor-generator 12. In some embodiments, the hybrid powertrain 205 includes a final gear set 214. The final gear set 214 includes a first gear 215, a second gear 216, and third gear 217. The first gear 215 is arranged along the main axis. The first gear 215 is operably coupled to the third clutch 212. The second gear 216 is arranged along the counter axis. The second gear 216 is operably coupled to the fourth clutch 213. The third gear 217 is operably coupled to a final drive shaft. In some embodiments, the first gear 215 is coupled to the third gear 217. The second gear 216 is coupled to the third gear 217. The hybrid powertrain 2015 is provided with a brake 218 operably coupled to the carrier assembly (C).

During operation of the hybrid powertrain 205, power is transmitted in at least two modes of operation. A first mode of operation is established as the variator 17 is used as a differential element when the carrier assembly (C) is free to rotate. In other words, the first mode of operation corresponds to a disengaged position of the brake. A second mode of operation is established as the variator 17 is used as a mechanical transmission when the brake is applied to ground the carrier assembly (C). The second clutch 210, the third clutch 212, and the fourth clutch 213 are selectively engaged to provide extended speed range to the driven devices and wheels. In some embodiments, selective engagement of the second clutch 210, the third clutch 212, and the fourth clutch 213 are optionally controlled to provide independent control of engine speed and motor/generator speed from vehicle speed.

Turning now to FIG. 96; in some embodiments, a hybrid powertrain 220 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 220 include a planetary gear set 221 arranged coaxially with the ICE 11. The planetary gear set 221 includes a ring gear 222, a planet carrier 223, and a sun gear 224. In some embodiments, the hybrid powertrain 220 includes a first clutch 225 operably coupled to the ICE 11 and the sun gear 224. The first motor-generator 12 is operably coupled to the planet carrier 223. The ring gear 222 is coupled to the first traction ring (R1). The second motor-generator 13 is coupled to the second traction (R2). In some embodiments, the hybrid powertrain 220 includes a brake 226 operably coupled to the carrier assembly (C).

During operation of the hybrid powertrain 220, power is transmitted in at least two modes of operation. A first mode of operation is established as the variator 17 is used as a differential element as is the planetary gear set 221 when the carrier assembly (C) is free to rotate. In other words, the first mode of operation corresponds to a disengaged position of the brake 226. A second mode of operation is established as the variator 17 is used as a mechanical transmission when the brake 226 is applied to ground the carrier assembly (C).

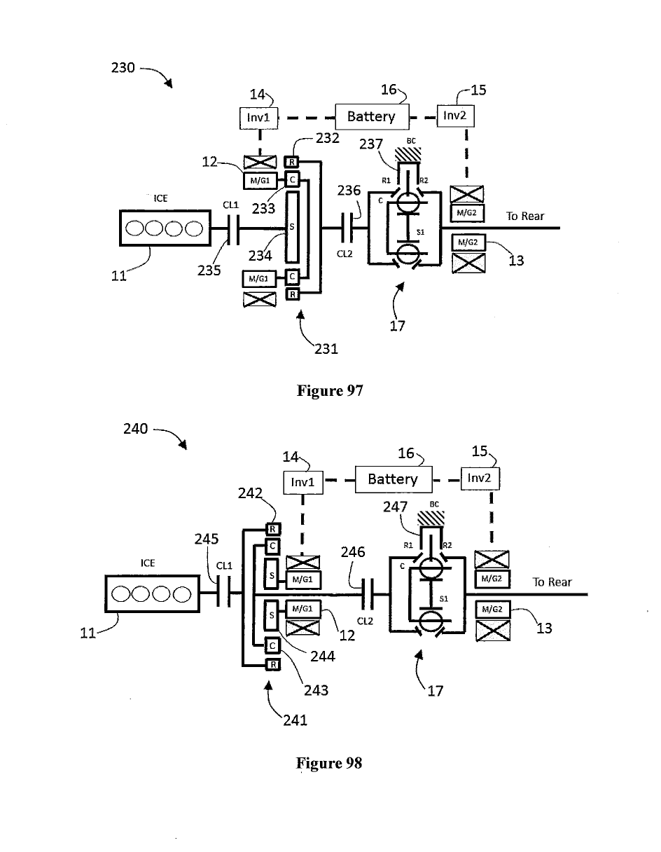

Referring now to FIG. 97; in some embodiments, a hybrid powertrain 230 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 230 include a planetary gear set 231 arranged coaxially with the ICE 11. The planetary gear set 231 includes a ring gear 232, a planet carrier 233, and a sun gear 234. In some embodiments, the hybrid powertrain 230 includes a first clutch 235 operably coupled to the ICE 11 and the sun gear 234. The first motor-generator 12 is operably coupled to the planet carrier 233. The ring gear 232 is coupled to a second clutch 236. The second clutch 236 is coupled to the first traction ring (R1). The second motor-generator 13 is coupled to the second traction (R2). In some embodiments, the hybrid powertrain 230 includes a brake 237 operably coupled to the carrier assembly (C).

During operation of the hybrid powertrain 230, power is transmitted in at least two modes of operation. A first mode of operation is established as the variator 17 is used as a differential element as is the planetary gear set 231 when the carrier assembly (C) is free to rotate. In other words, the first mode of operation corresponds to a disengaged position of the brake 237. A second mode of operation is established as the variator 17 is used as a mechanical transmission when the brake 237 is applied to ground the carrier assembly (C).

Passing now to FIG. 98; in some embodiments, a hybrid powertrain 240 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 240 include a planetary gear set 241 arranged coaxially with the ICE 11. The planetary gear set 241 includes a ring gear 242, a planet carrier 243, and a sun gear 244. In some embodiments, the hybrid powertrain 240 includes a first clutch 245 operably coupled to the ICE 11 and the ring gear 242. The first motor-generator 12 is operably coupled to the sun gear 244. The planet carrier 243 is coupled to a second clutch 246. The second clutch 246 is coupled to the first traction ring (R1). The second motor-generator 13 is coupled to the second traction (R2). In some embodiments, the hybrid powertrain 240 includes a brake 247 operably coupled to the carrier assembly (C).

During operation of the hybrid powertrain 240, power is transmitted in at least two modes of operation. A first mode of operation is established as the variator 17 is used as a differential element as is the planetary gear set 241 when the carrier assembly (C) is free to rotate. In other words, the first mode of operation corresponds to a disengaged position of the brake 247. A second mode of operation is established as the variator 17 is used as a mechanical transmission when the brake 247 is applied to ground the carrier assembly (C).

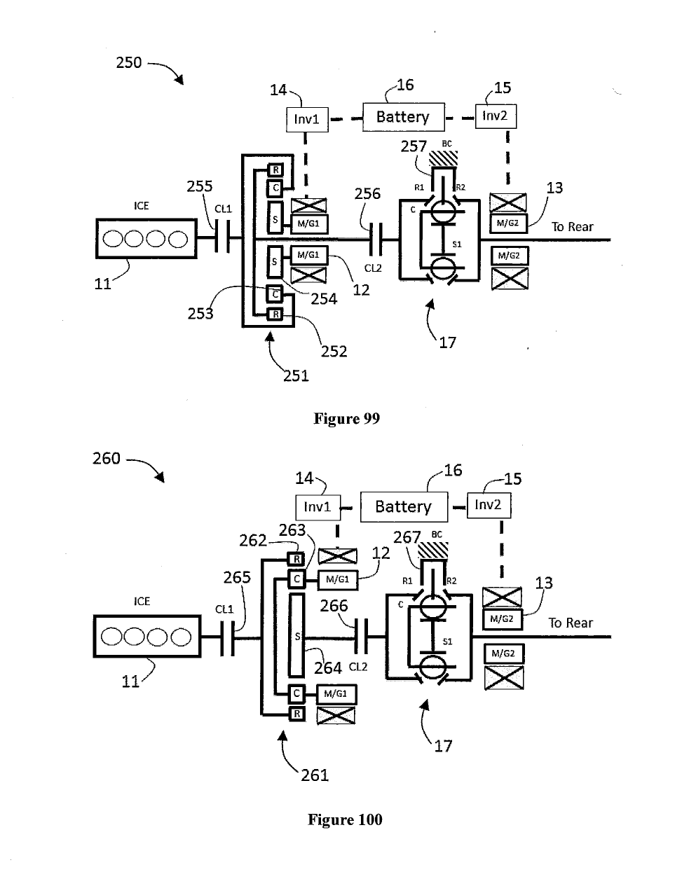

Referring now to FIG. 99; in some embodiments, a hybrid powertrain 250 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 250 include a planetary gear set 251 arranged coaxially with the ICE 11. The planetary gear set 251 includes a ring gear 252, a planet carrier 253, and a sun gear 254. In some embodiments, the hybrid powertrain 250 includes a first clutch 255 operably coupled to the ICE 11 and the planet carrier 253. The first motor-generator 12 is operably coupled to the sun gear 254. The ring gear 252 is coupled to a second clutch 256. The second clutch 256 is coupled to the first traction ring (R1). The second motor-generator 13 is coupled to the second traction (R2). In some embodiments, the hybrid powertrain 250 includes a brake 257 operably coupled to the carrier assembly (C).

During operation of the hybrid powertrain 250, power is transmitted in at least two modes of operation. A first mode of operation is established as the variator 17 is used as a differential element as is the planetary gear set 251 when the carrier assembly (C) is free to rotate. In other words, the first mode of operation corresponds to a disengaged position of the brake 257. A second mode of operation is established as the variator 17 is used as a mechanical transmission when the brake 257 is applied to ground the carrier assembly (C).

Turning now to FIG. 100; in some embodiments, a hybrid powertrain 260 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 260 include a planetary gear set 261 arranged coaxially with the ICE 11. The planetary gear set 261 includes a ring gear 262, a planet carrier 263, and a sun gear 264. In some embodiments, the hybrid powertrain 260 includes a first clutch 265 operably coupled to the ICE 11 and the ring gear 262. The first motor-generator 12 is operably coupled to the planet carrier 263. The sun gear 264 is coupled to a second clutch 266. The second clutch 266 is coupled to the first traction ring (R1). The second motor-generator 13 is coupled to the second traction (R2). In some embodiments, the hybrid powertrain 260 includes a brake 267 operably coupled to the carrier assembly (C).

During operation of the hybrid powertrain 260, power is transmitted in at least two modes of operation. A first mode of operation is established as the variator 17 is used as a differential element as is the planetary gear set 261 when the carrier assembly (C) is free to rotate. In other words, the first mode of operation corresponds to a disengaged position of the brake 267. A second mode of operation is established as the variator 17 is used as a mechanical transmission when the brake 267 is applied to ground the carrier assembly (C).

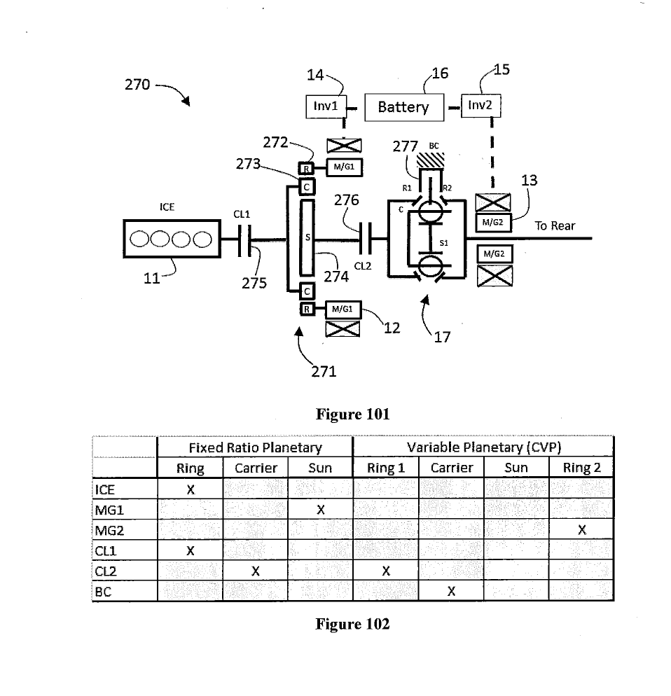

Passing now to FIG. 101; in some embodiments, a hybrid powertrain 270 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 270 include a planetary gear set 271 arranged coaxially with the ICE 11. The planetary gear set 271 includes a ring gear 272, a planet carrier 273, and a sun gear 274. In some embodiments, the hybrid powertrain 270 includes a first clutch 275 operably coupled to the ICE 11 and the planet carrier 273. The first motor-generator 12 is operably coupled to the ring gear 272. The sun gear 274 is coupled to a second clutch 276. The second clutch 276 is coupled to the first traction ring (R1). The second motor-generator 13 is coupled to the second traction (R2). In some embodiments, the hybrid powertrain 270 includes a brake 277 operably coupled to the carrier assembly (C).

During operation of the hybrid powertrain 270, power is transmitted in at least two modes of operation. A first mode of operation is established as the variator 17 is used as a differential element as is the planetary gear set 271 when the carrier assembly (C) is free to rotate. In other words, the first mode of operation corresponds to a disengaged position of the brake 277. A second mode of operation is established as the variator 17 is used as a mechanical transmission when the brake 277 is applied to ground the carrier assembly (C).

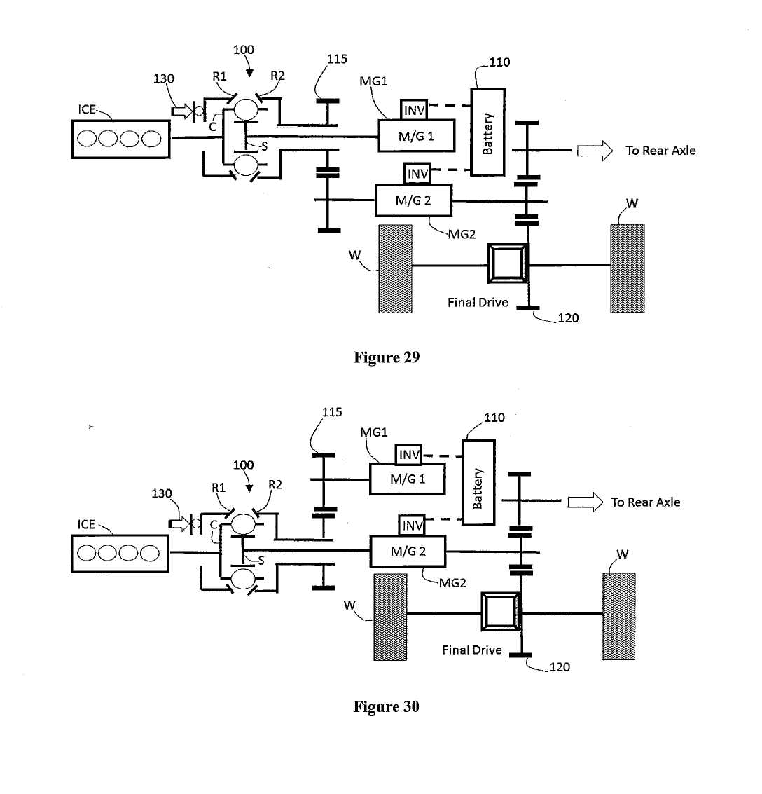

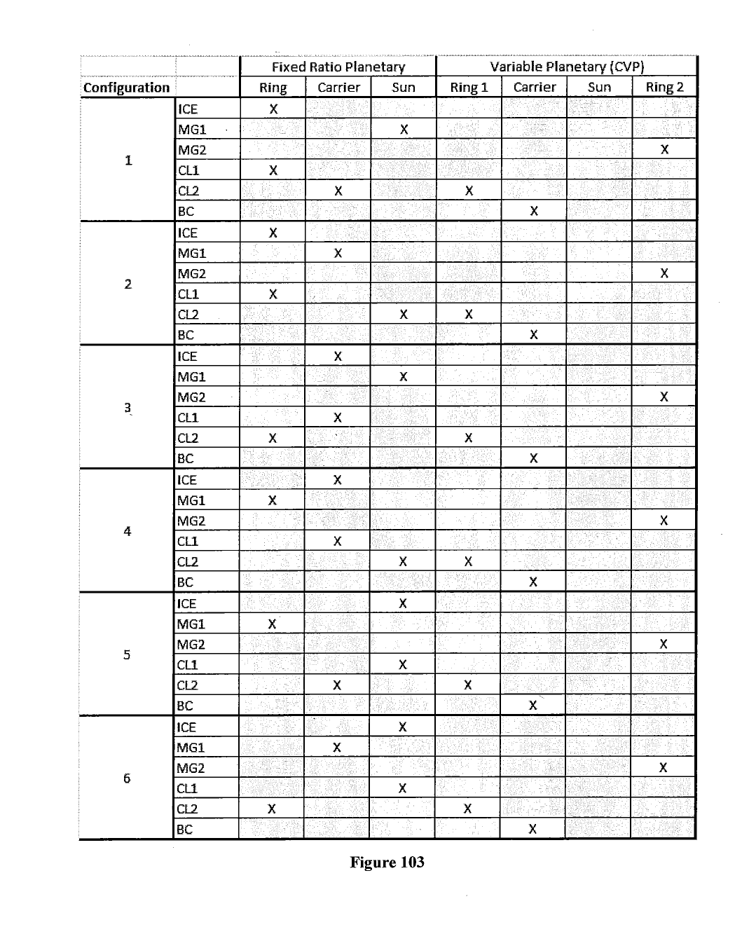

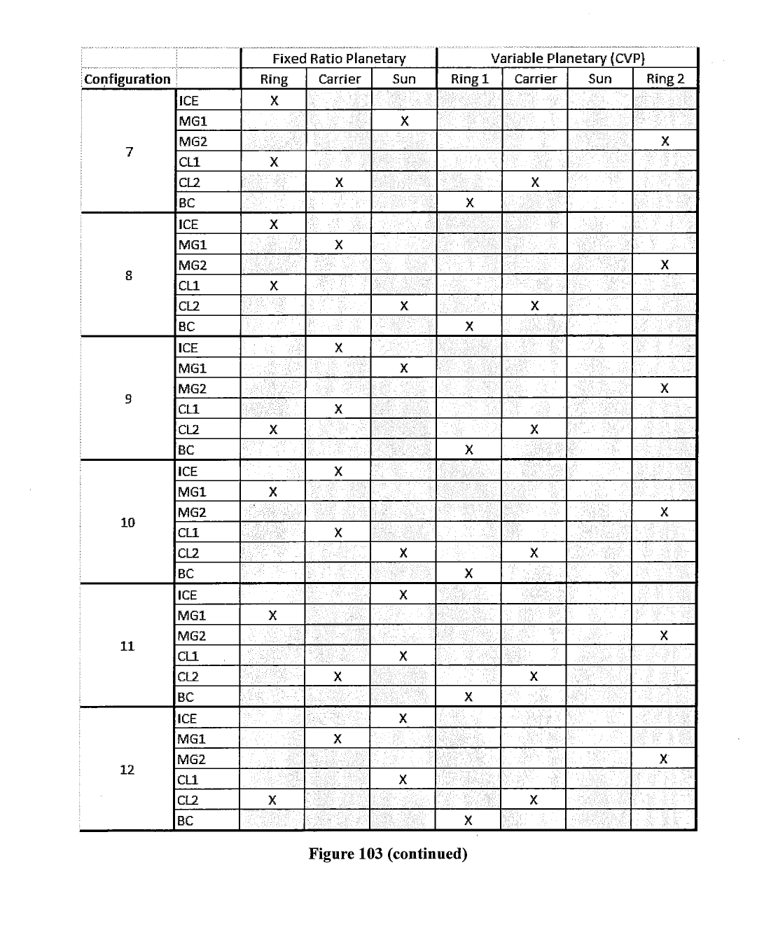

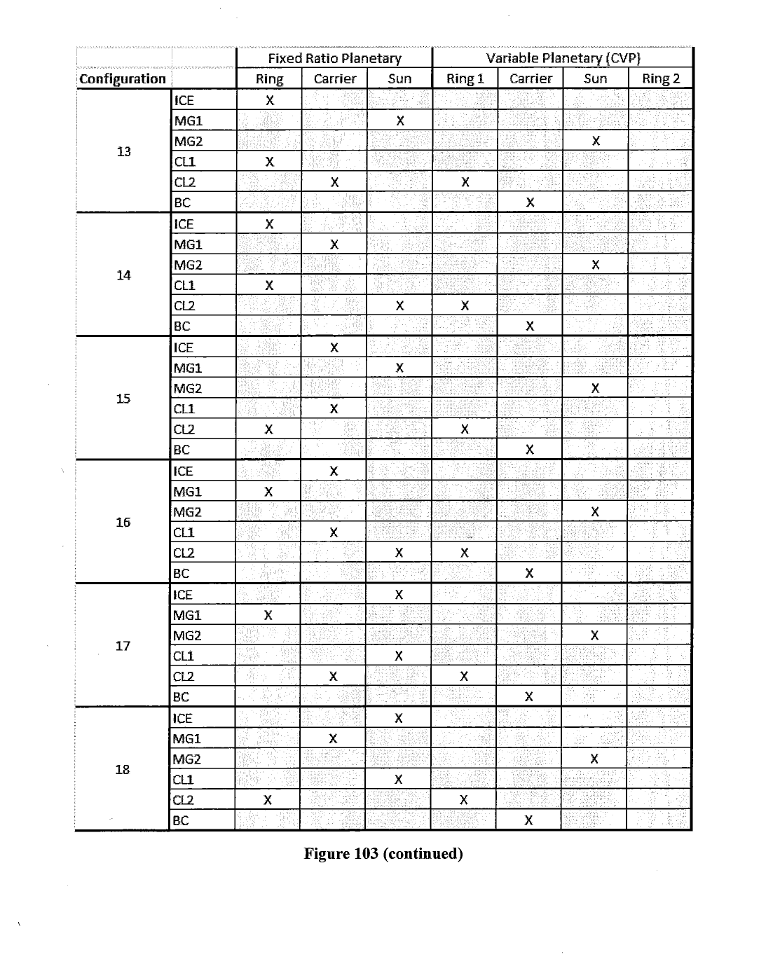

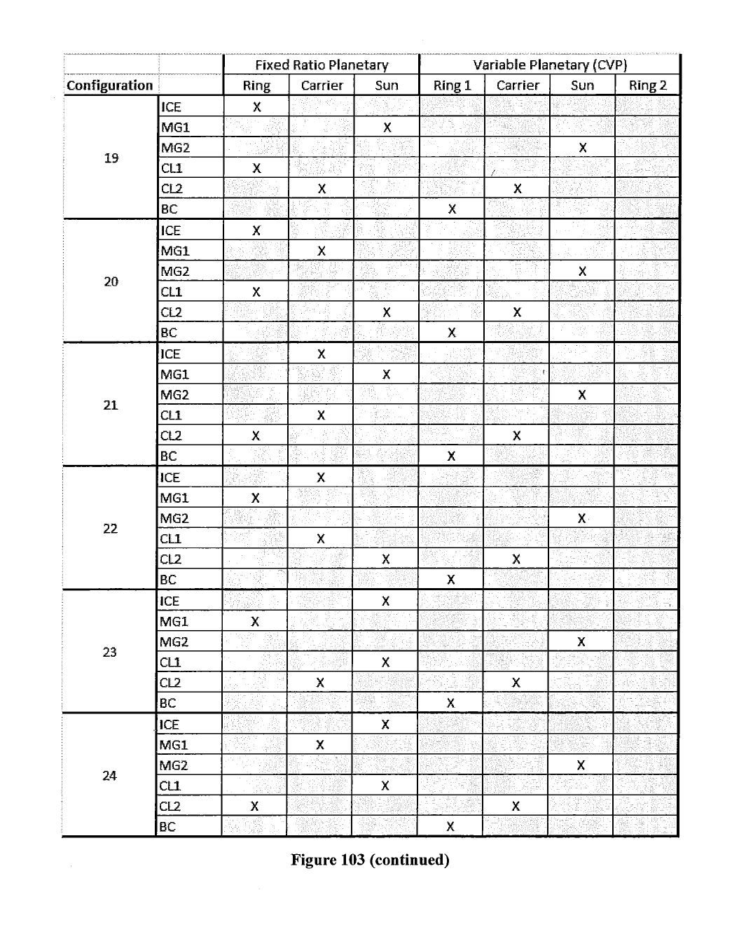

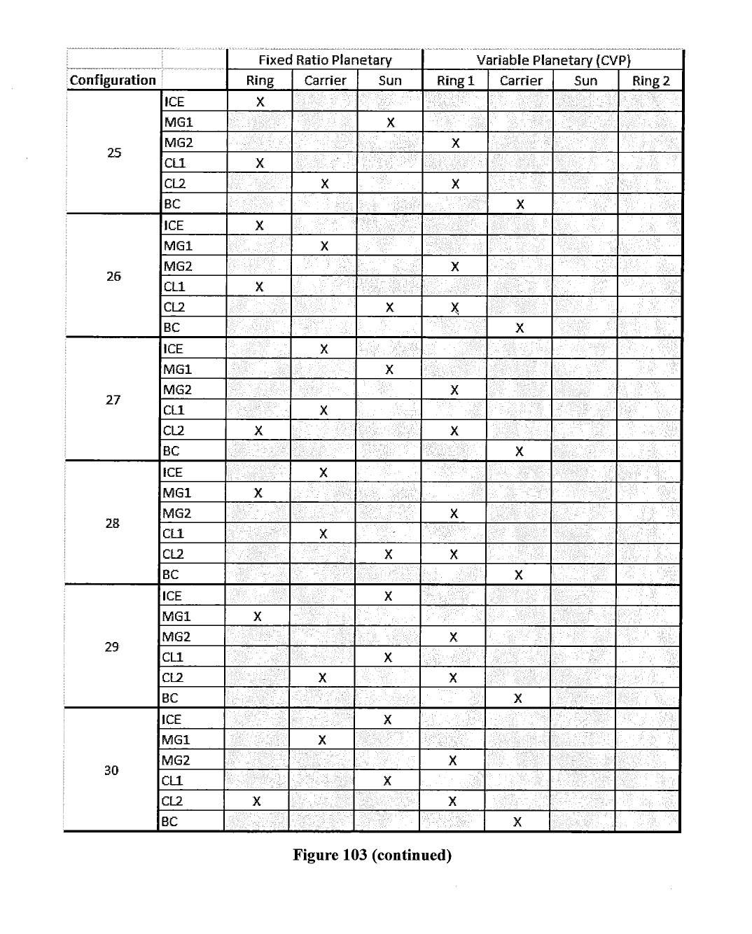

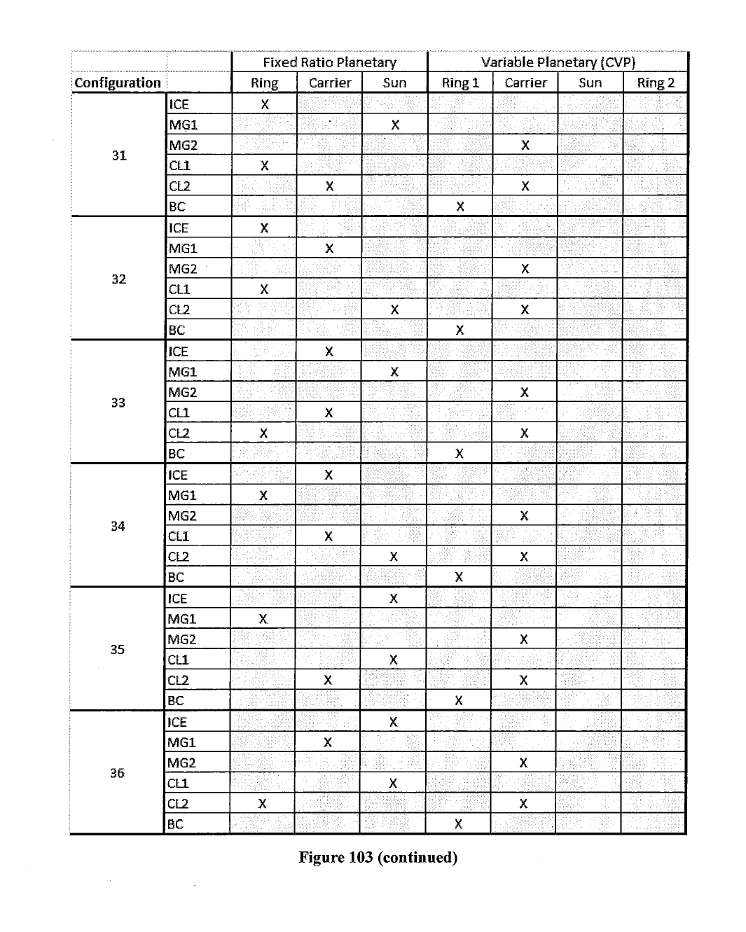

Turning now to FIGS. 102 and 103, and still referring to FIG. 25; the hybrid powertrain 240 can be described in a table as depicted in FIG. 29. The rows of the table include the ICE 11 (“ICE”), the first motor-generator 12 (“MG1”), the second motor-generator 13 (“MG2”), the first clutch 245 (“CL1”), the second clutch 246 (“CL2”), and the brake 247 (“BC”). The columns of the table include components of the planetary gear set 241 and the variator 17. The “X” denotes a coupling between the row component and the column component. For clarity and conciseness, the hybrid powertrain 240 is provided as an illustrative example. It should be appreciated that a number of hybrid powertrain configurations can be configured by coupling the components as indicated in the table provided in FIG. 103.

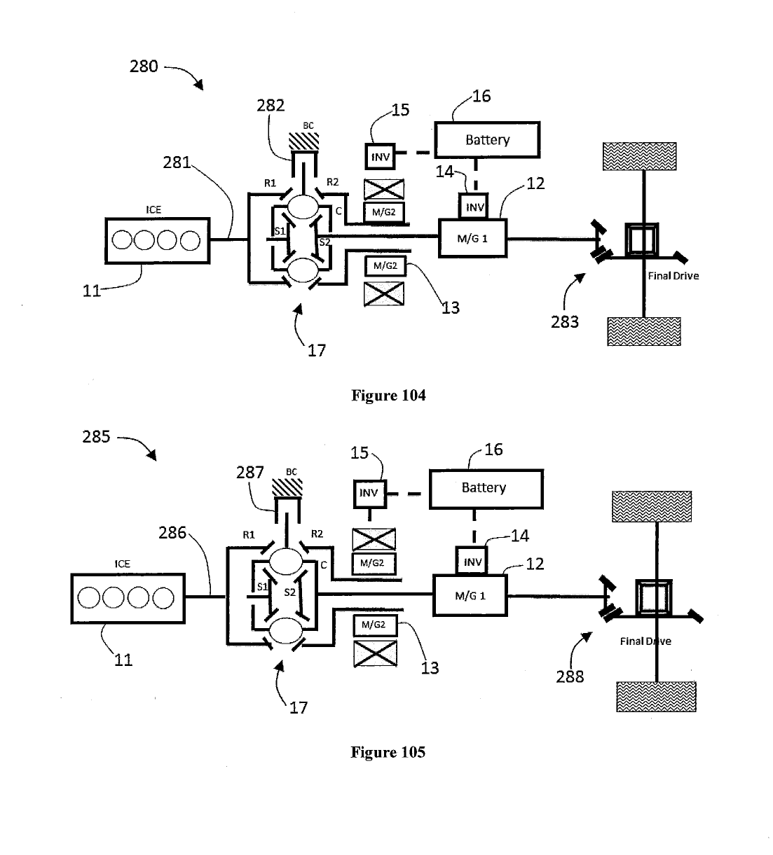

Referring now to FIG. 104; in some embodiments, a hybrid powertrain 280 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 280 has a first rotatable shaft 281 coupled to the ICE 11. The first rotatable shaft 281 forms a main axis of the hybrid powertrain 280. The first rotatable shaft 281 is coupled to the first traction ring (R1). The first motor-generator 12 is operably coupled to the sun assembly (S2) of the variator 17. The second motor-generator 13 is operably coupled to the second traction ring (R2). A brake 282 is coupled to the carrier assembly (C). The first motor-generator 12 is operably coupled to a final drive assembly 283.

Turning now to FIG. 105; in some embodiments, a hybrid powertrain 285 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 285 has a first rotatable shaft 286 coupled to the ICE 11. The first rotatable shaft 286 forms a main axis of the hybrid powertrain 285. The first rotatable shaft 286 is coupled to the first traction ring (R1). The first motor-generator 12 is operably coupled to the sun assembly (S2) of the variator 17. The second motor-generator 13 is operably coupled to the second traction ring (R2). A brake 287 is coupled to the carrier assembly (C). The first motor-generator 12 is operably coupled to a final drive assembly 288.

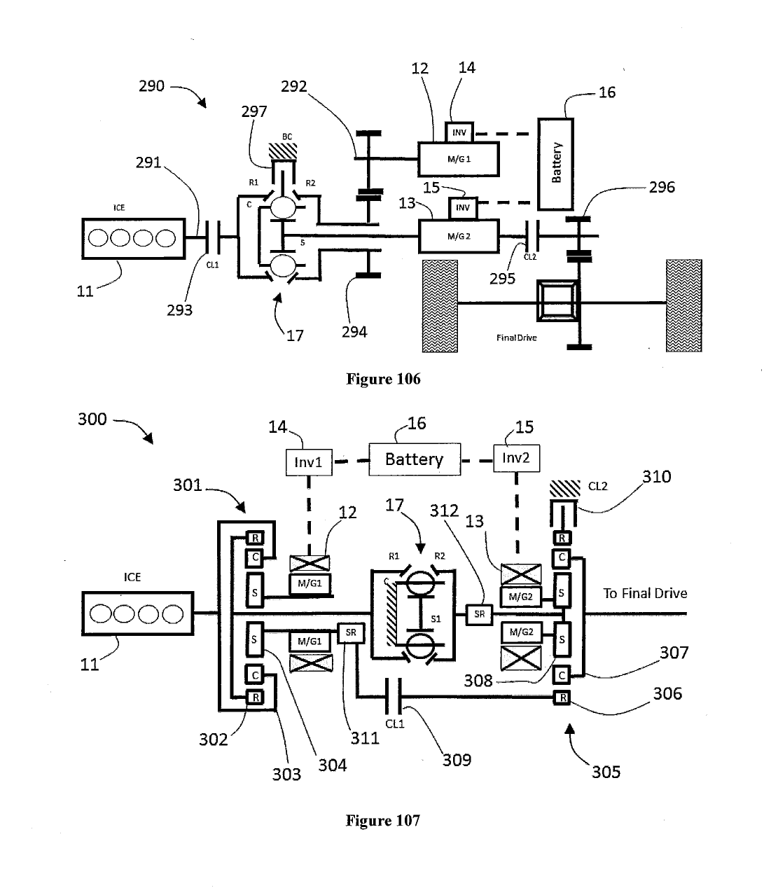

Turning to FIG. 106; in some embodiments, a hybrid powertrain 290 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 290 includes a first rotatable shaft 291 coupled to the ICE 11. The first rotatable shaft 291 forms a main axis of the hybrid powertrain 290. The hybrid powertrain 290 includes a second rotatable shaft 292 aligned substantially parallel to the main axis, the second rotatable shaft 292 forms a counter axis. The hybrid powertrain 290 includes a first clutch (CL1) 293 coupled to the ICE 11 and the first traction ring (R1). The hybrid powertrain 290 has a first gear set 294 operably coupled to the second traction ring (R2) and the second rotatable shaft 292. The first motor-generator 12 is coaxial with the second rotatable shaft 292 and is operably coupled to the first gear set 294. The second motor-generator 13 is coupled to the sun (S). The second motor-generator 13 is aligned coaxially with the main axis. The hybrid powertrain 290 includes a second clutch (CL2) 295 operably coupled to the second motor-generator 13. The second clutch 295 is configured to couple to a final drive gear set 296. The hybrid powertrain 290 includes a brake 297 coupled to the carrier assembly.

Referring to FIG. 107, in some embodiments, a hybrid powertrain 300 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. In some embodiments, the hybrid powertrain includes a first planetary gear set 301 having a first ring gear 302, a first planet carrier 303, and a first sun gear 304. In some embodiments, the first sun gear 304 is coupled to the first motor-generator 12. The first planet carrier 303 is operably coupled to the ICE 11. The first ring gear 302 is operably coupled to the first traction ring assembly of the variator 17. In some embodiments, the hybrid powertrain 300 includes a second planetary gear set 305 having a second ring gear 306, a second planet carrier 307, and a second sun gear 308. In some embodiments, the second sun gear 308 is operably coupled to the second motor-generator 13. The second planet carrier 307 is configured to operably couple to a final drive gear (not shown). The second sun gear 308 is operably coupled to the second traction ring assembly of the variator 17. In some embodiments, the hybrid powertrain 300 is provided with a first clutch 309 coupled to the first sun gear 302 and the second ring gear 306. The hybrid powertrain 300 includes a second clutch 310 operably coupled to the second ring gear 307. The second clutch 310 selectively couples the second ring gear 307 to ground. In some embodiments, the second clutch 310 is configured as a brake. In some embodiments, the hybrid powertrain 300 is optionally configured with a first step gear 311 arranged to operably couple first sun gear 302 to the first clutch 309. In some embodiments, the hybrid powertrain 300 is optionally configured with a second step gear 312 arranged to operably couple the second sun gear 308 to the second traction ring assembly of the variator 17. It should be appreciated that a designer has within his means to configure and adapt the first step gear 311 and second step gear 312 as needed to implement couplings of shafts and devices.

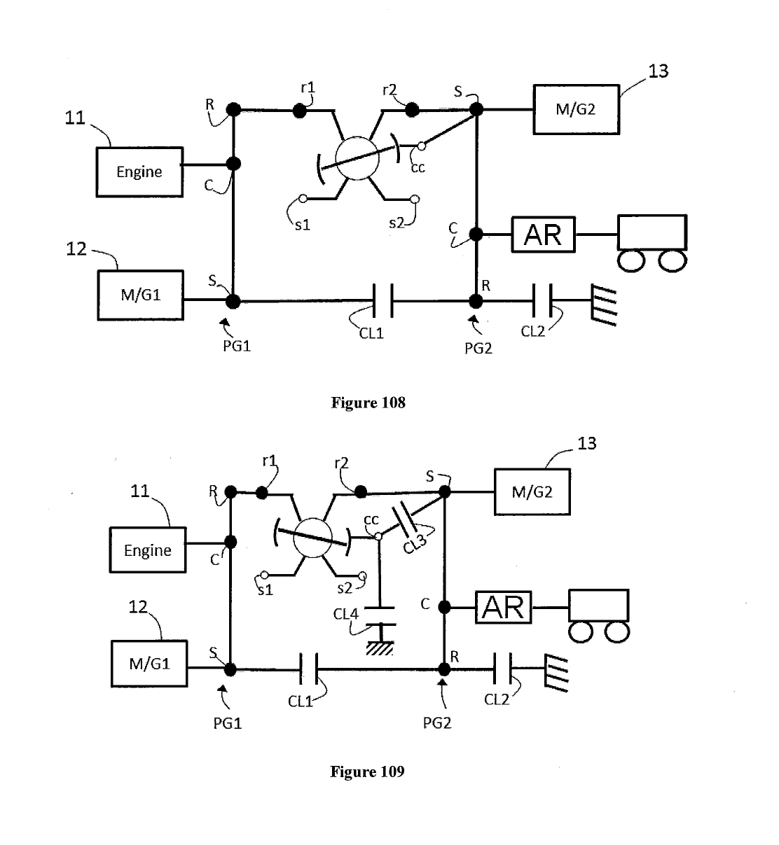

Passing now to FIGS. 108-122; a number of embodiments of hybrid powertrains incorporating two planetary gear sets and a variator (CVP) will be described. For purposes of description, schematics referred to as lever diagrams are used herein. A lever diagram, also known as a lever analogy diagram, is a translational-system representation of rotating parts for a planetary gear system. In certain embodiments, a lever diagram is provided as a visual aid in describing the functions of the transmission. In a lever diagram, a compound planetary gear set is often represented by a single vertical line (“lever”). The input, output, and reaction torques are represented by horizontal forces on the lever. The lever motion, relative to the reaction point, represents direction of rotational velocities.

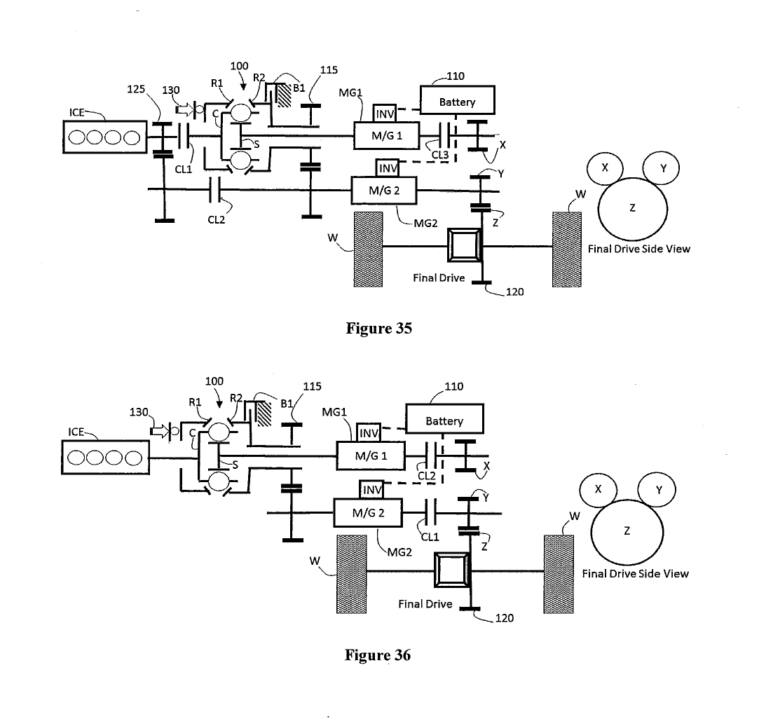

Referring now to FIG. 108; a lever diagram representing the hybrid powertrain 300 is depicted. As used herein, the label “Engine” refers to an ICE such as the ICE 11; the label “M/G1” refers to a first motor-generator such as the first motor-generator 12; the label “M/G2” refers to a second motor-generator such as the second motor-generator 13. A first vertical line labeled “PG1” refers to a first planetary gear set such as the first planetary gear set 301. Solid dots arranged on the vertical line are labeled “R”, “C”, and “S” to indicate a ring node, a carrier node, and a sun node of the first planetary gear set. A second vertical line labeled “PG2” refers to a second planetary gear set such as the second planetary gear set 302. Solid dots arranged on the vertical line are labeled “R”, “C”, and “S” to indicate a ring node, a carrier node, and a sun node of the second planetary gear set. The label “AR” refers to a final drive ratio to the wheels of a vehicle equipped with the hybrid powertrain. A variator device is represented schematically in the lever diagram having nodes labeled “r1”, “r2”, “cc”, “s1”, and “s2” representing the first traction ring assembly, the second traction ring assembly, the carrier assembly, the first sun member, and the second sun member, respectively. It should be noted that the variator depicted in the lever diagrams of FIG. 35-49 is substantially similar to the variator 17. The label “CL1” refers to a first clutch device such as a first clutch 309. The label “CL2” refers to a second clutch device such as a second clutch 310.

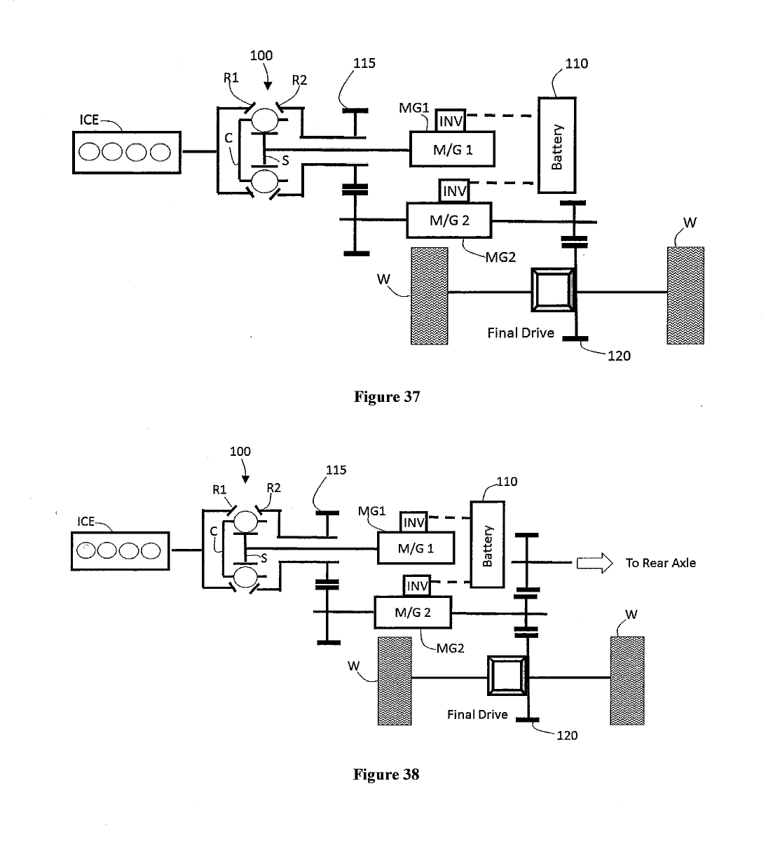

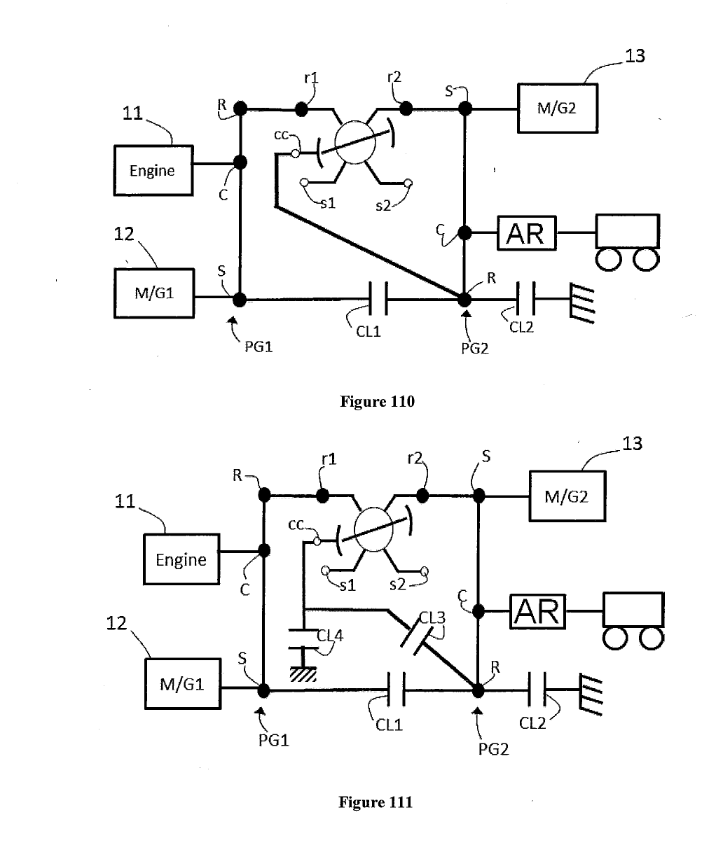

Referring now to FIGS. 109 and 110; in some embodiments, a hybrid powertrain is provided with a third clutch (CL3) configured to couple the carrier assembly of the variator to the sun gear of the second planetary gear set. Additionally, the hybrid powertrain is provided with a fourth clutch (CL4) configured to selectively ground the carrier assembly of the variator. Multiple operating modes of the hybrid powertrain are achieved through the selective engagement of the clutch devices. For example, the lever diagram depicted in FIG. 37 represents an operating mode corresponding to engagement of the third clutch (CL3) and the disengagement of the fourth clutch (CL4) to thereby couple the carrier assembly of the variator to the sun gear of the second planetary gear set. When the third clutch (CL3) is disengaged, and the fourth clutch (CL4) is engaged to ground the carrier assembly of the variator, the hybrid powertrain operates in a mode depicted in the lever diagram of FIG. 35.

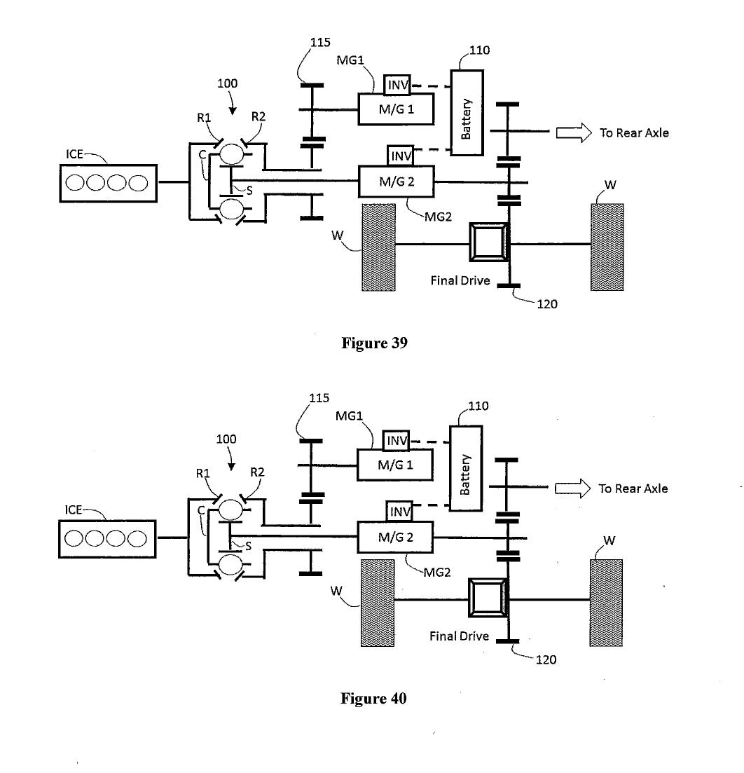

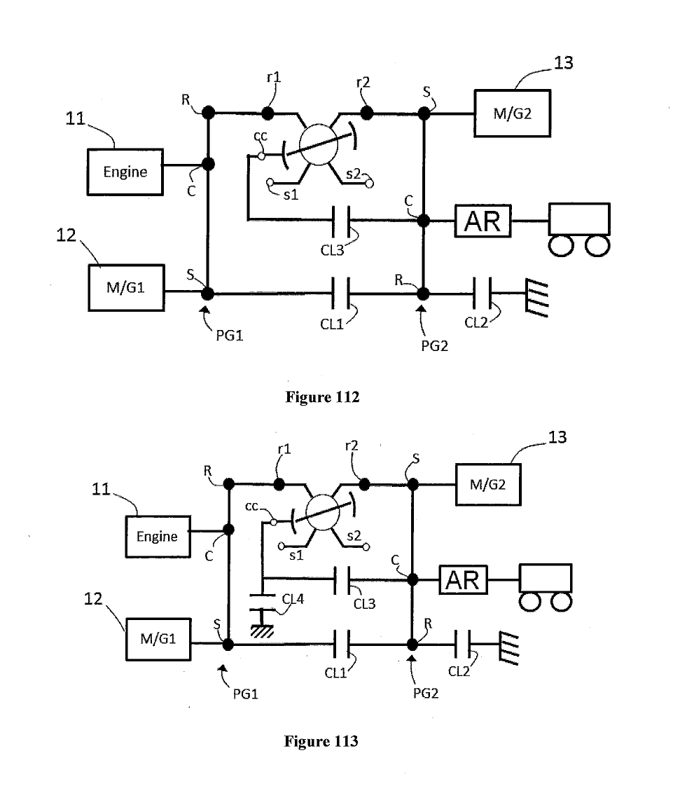

Referring now to FIGS. 111 and 112; in some embodiments, a hybrid powertrain is provided with a third clutch (CL3) configured to couple the carrier assembly of the variator to the ring gear of the second planetary gear set. Additionally, the hybrid powertrain is provided with a fourth clutch (CL4) configured to selectively ground the carrier assembly of the variator. Multiple operating modes of the hybrid powertrain are achieved through the selective engagement of the clutch devices. For example, the lever diagram depicted in FIG. 39 represents an operating mode corresponding to engagement of the third clutch (CL3) and the disengagement of the fourth clutch (CL4) to thereby couple the carrier assembly of the variator to the ring gear of the second planetary gear set. When the third clutch (CL3) is disengaged, and the fourth clutch (CL4) is engaged to ground the carrier assembly of the variator, the hybrid powertrain operates in a mode depicted in the lever diagram of FIG. 35.

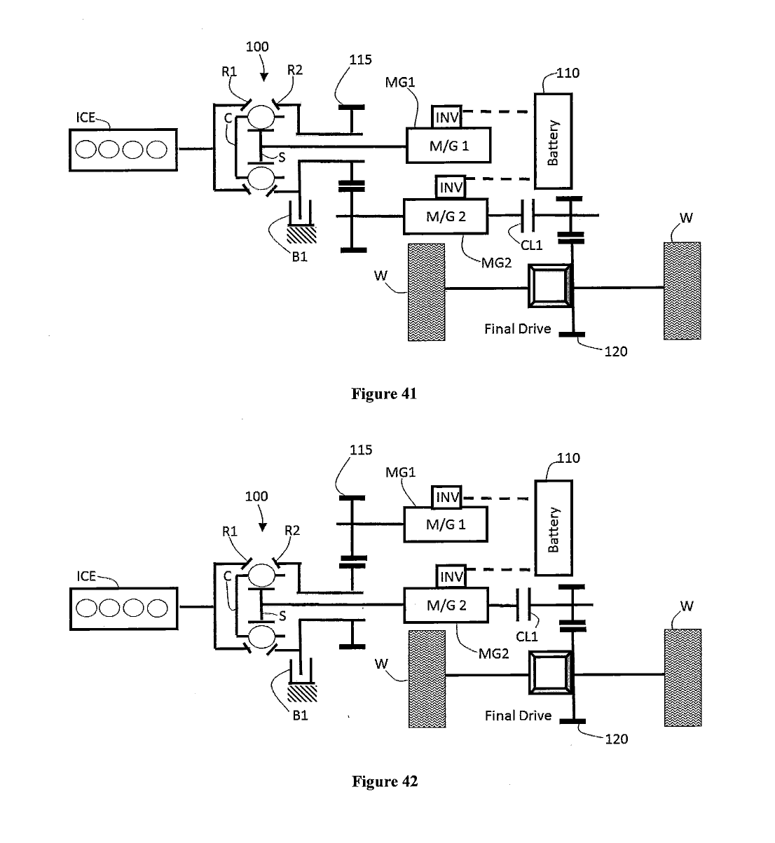

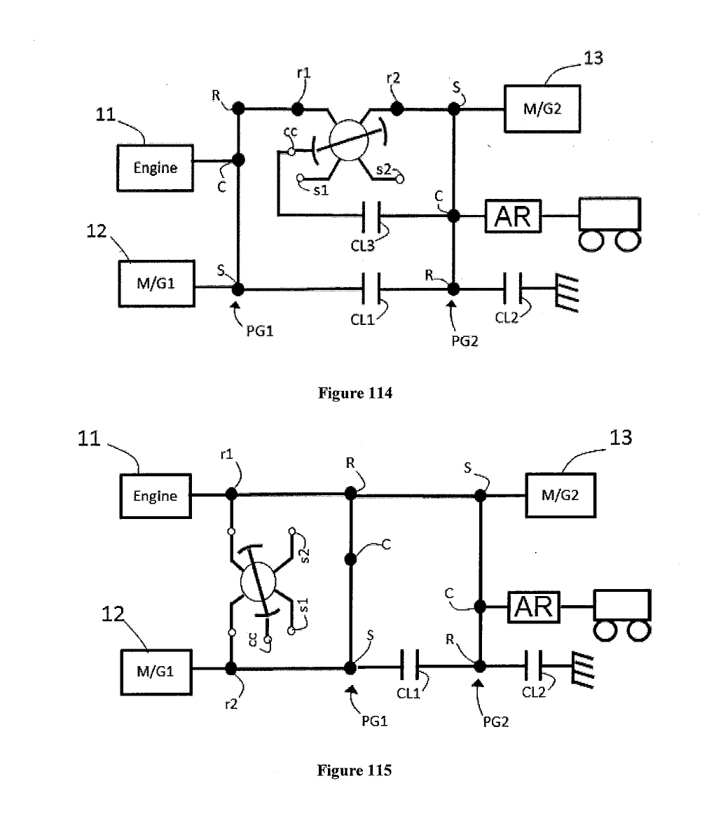

Referring now to FIGS. 113 and 114; in some embodiments, a hybrid powertrain is provided with a third clutch (CL3) configured to couple the carrier assembly of the variator to the planet carrier of the second planetary gear set. Additionally, the hybrid powertrain is provided with a fourth clutch (CL4) configured to selectively ground the carrier assembly of the variator. Multiple operating modes of the hybrid powertrain are achieved through the selective engagement of the clutch devices. For example, the lever diagram depicted in FIG. 41 represents an operating mode corresponding to engagement of the third clutch (CL3) and the disengagement of the fourth clutch (CL4) to thereby couple the carrier assembly of the variator to the planet carrier of the second planetary gear set. When the third clutch (CL3) is disengaged, and the fourth clutch (CL4) is engaged to ground the carrier assembly of the variator, the hybrid powertrain operates in a mode depicted in the lever diagram of FIG. 35.

Referring now to FIGS. 115-118; a number of lever diagrams depicting hybrid powertrain configurations having two planetary gear sets and a variator are depicted. The configurations depicted in FIGS. 115-118 are arranged in such a way as to route all power from the engine to the variator.

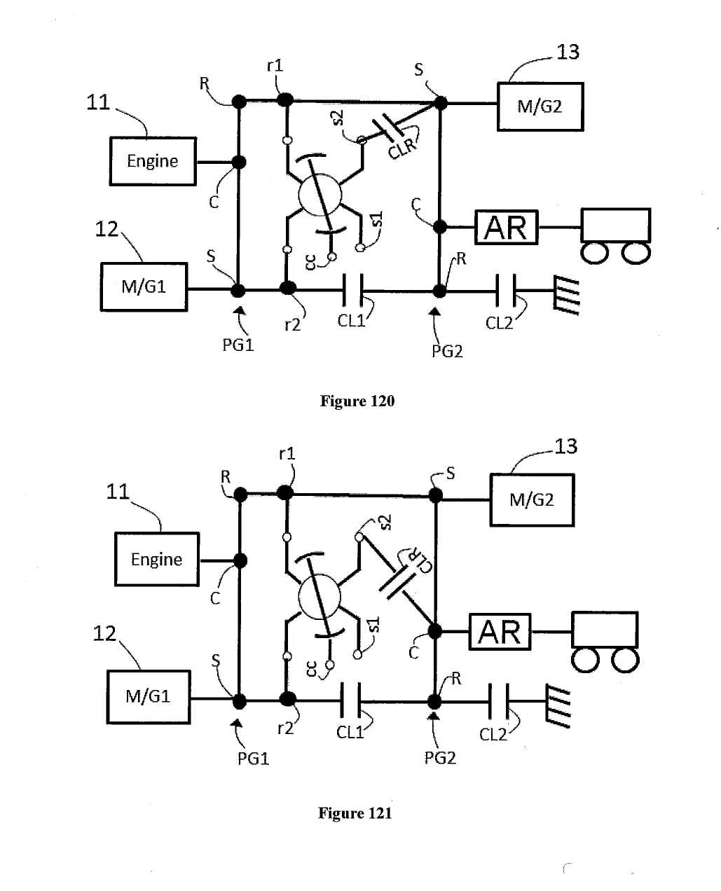

Referring now to FIGS. 119-121; a number of lever diagrams depicting hybrid powertrain configurations having two planetary gear sets and a variator are depicted. The configurations depicted in FIGS. 46-48 are arranged in such a way as to split power from the engine between the variator and the planetary gear sets. A reverse clutch (CLR) is depicted in FIGS. 120 and 121. In some embodiments, the reverse clutch is operably coupled to a sun node of the variator and the sun gear of the second planetary gear set. In some embodiments, the reverse clutch is operably coupled to the sun node of the variator and the planet carrier of the second planetary gear set.

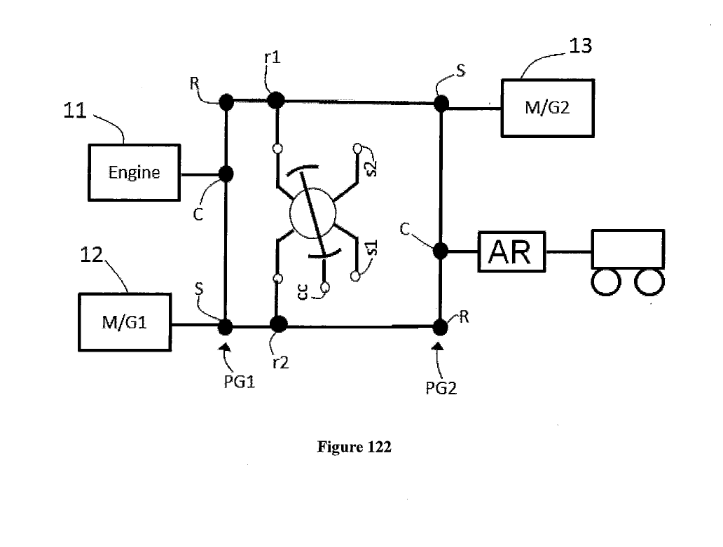

Referring now to FIG. 122; a lever diagram of a hybrid powertrain configuration having two planetary gear sets and a variator is depicted. The first planetary gear set is labeled “PG1” and includes a first ring node (R), a first carrier node (C), and a first sun node (S). In some embodiments, the hybrid powertrain includes an engine coupled to a first carrier node (C). A first motor-generator is coupled to the first sun node (S). The variator includes a first traction ring node (r1), a second traction ring node (r2), a variator carrier node (c), and variator sun nodes (s1 and s2). The first traction ring node r1 is operably coupled to the first sun node. The second traction ring node r2 is operably coupled to the first ring node R. In some embodiments, the hybrid powertrain includes a second planetary gear set labeled “PG2”. The second planetary gear set (PG2) includes a second ring node (R), a second carrier node (C), and a second sun node (S). In some embodiments, an output power is transmitting from the second carrier node to an axle of a vehicle. The second ring node is operably coupled to the first traction ring node. In some embodiments, the second sun node is operably coupled to a second motor-generator. In some embodiments, the variator carrier node and one of the variator sun nodes are optionally coupled to nodes of the first planetary gear set or the second planetary gear set. For example, one of the variator sun nodes (for example, “s1”) is optionally coupled to the second planet carrier. In some embodiments, the s1 node is optionally coupled to the second sun gear.

It should be noted that in any of the embodiments presented herein, the first motor-generator (MG1) or the second motor-generator (MG2) are optionally coupled to any of the variator nodes or planetary gear set nodes. It should be appreciated that the first planetary gear set (PG1) and the second planetary gear set (PG2) are optionally configured as any epicyclic gear set such as, but not limited to, a simple planetary, compound, or compound split. It should be further noted that the addition of clutches or brakes to any of the embodiments disclosed herein is within a designer's means to provide additional modes of operation to the hybrid powertrains. Likewise, the addition of stepped gears, belt-and-pulley devices, or chain drive devices to route power to the engine, motor-generators, or other devices incorporated into the hybrid powertrain are within the designer's choice.

Embodiments of hybrid powertrains disclosed herein are optionally configured as compound split systems with a variator such as the ones described having nodes connected in any combination to the planetary gear sets, or the epicyclic gears, to create a compound split system such that the combined lever (involving variator and two epicyclic gears) has a variable total number of nodes (depending on how the system is connected) to which one or more powerplant devices such as the ICE, or other powerplant, and two or more electric machines can be tied to. It should be appreciated that the use of variator in such combinations to create a compound split multi-node with all permutations of connections with or without additional clutches and speed ratios are disclosed herein.

It should be noted that the description above has provided dimensions for certain components or subassemblies. The mentioned dimensions, or ranges of dimensions, are provided in order to comply as best as possible with certain legal requirements, such as best mode. However, the scope of the preferred embodiments described herein are to be determined solely by the language of the claims, and consequently, none of the mentioned dimensions is to be considered limiting on the inventive embodiments, except in so far as any one claim makes a specified dimension, or range of thereof, a feature of the claim.

While preferred embodiments of the present embodiments have been shown and described herein, it will be obvious to those skilled in the art that such embodiments are provided by way of example only. Numerous variations, changes, and substitutions will now occur to those skilled in the art without departing from the preferred embodiments. It should be understood that various alternatives to the embodiments described herein are optionally employed in practicing the preferred embodiments. It is intended that the following claims define the scope of the preferred embodiments and that methods and structures within the scope of these claims and their equivalents be covered thereby.

1. A computer-implemented system for a vehicle having an engine, a battery system, a first motor/generator, and a second motor/generator, each motor/generator operably coupled to a ball-planetary variator (CVP), the computer-implemented system comprising:
a digital processing device comprising an operating system configured to perform executable instructions and a memory device;
a computer program including instructions executable by the digital processing device, the computer program comprising a software module configured to manage a plurality of vehicle driving conditions;
a hybrid supervisory controller; and
a plurality of sensors configured to monitor vehicle parameters including at least one of CVP input speed, engine torque, accelerator pedal position, CVP speed ratio, and battery charge,
wherein the software module includes a plurality of software sub-modules configured to optimize the CVP ratio based at least in part on one of the vehicle parameters monitored by the plurality of sensors.

2. The computer-implemented system of claim 1, wherein the software module further comprises a power management control module adapted to receive a plurality of signals indicative of a driver's command.

3. The computer-implemented system of claim 2, wherein the software module further comprises an engine IOL module adapted to receive signals from the power management control module.

4. The computer-implemented system of claim 2, wherein the software module further comprises a maximum overall efficiency module adapted to receive signals from the power management control module.

5. The computer-implemented system of claim 2, wherein the software module further comprises a maximum overall performance control module adapted to receive signals from the power management control module.

6. The computer-implemented system of claim 2, wherein the software module further comprises a CVP ratio control module.

7. The computer-implemented system of claim 6, wherein the software module further comprises a CVP control sub-module adapted to communicate a commanded set point signal to a CVP actuator.

8. The computer-implemented system of claim 7, wherein the software module further comprises a generator control sub-module, a motor control sub-module, an engine control sub-module, an accessory control sub-module, and a clutch control sub-module.

9. The computer-implemented system of claim 3, wherein the engine IOL module is adapted to execute an optimization algorithm to determine the engine operating points corresponding to ideal operating lines.

10. The computer-implemented system of claim 4, wherein the maximum overall efficiency module is adapted to execute a learning algorithm to determine operating points for the engine, the motor, and the CVP corresponding to optimum efficiency.

11. The computer-implemented system of claim 5, wherein the maximum overall performance module is adapted to execute an optimization algorithm to determine operating points for the engine, the motor, and the CVP that are within maximum performance limits for each.

12. The computer-implemented system of claim 9, wherein the optimization algorithm includes a dynamic programming process.

13. The computer-implemented system of claim 6, wherein the CVP ratio control sub-module is configured to execute a dynamic programming process to determine a commanded CVP speed ratio.

14. A method for controlling a drivetrain having an engine operably coupled to a ball-planetary variator (CVP), a battery system, a first motor/generator, and a second motor/generator, each motor/generator operably coupled to the CVP, the method comprising the steps of:
receiving a plurality of operating condition signals including at least one of CVP input speed, engine torque, accelerator pedal position, CVP ratio, and battery charge; and
optimizing the CVP ratio based at least in part on one of the operating condition signals,
wherein optimizing the CVP ratio is optimized based on the overall efficiency of the drivetrain.

15. The method of claim 14, further comprising commanding a set point signal to a CVP actuator, wherein the CVP actuator is operably connected to the CVP.

16. The method of claim 15, wherein the set point signal is determined using dynamic programming.

17. The method of claim 14, further comprising:
determining an optimal powersplit between a mechanical powerpath and an electrical powerpath based at least in part on one of the operating conditions signals, wherein the mechanical powerpath includes the engine and the CVP and the electrical powerpath includes the first motor/generator, the second motor/generator and the CVP; and
commanding a variable distribution of power between the first motor/generator and second motor/generator and the internal combustion engine based on the determined optimal powersplit.

18. The method of claim 17, further comprising retrieving a number of stored optimized variables for the powersplit between the mechanical powerpath and the electrical powerpath from memory.

19. The method of claim 18, wherein the stored optimized variables for the powersplit are determined by dynamic programming methods.

20. The method of claim 18, wherein the stored optimized variables for the powersplit are determined by collecting data from the operating condition signals.
